(19) United States
(12) Patent Application Publication
(10) Pub. No.: US 2013/0028329 A1
(43) Pub. Date: Jan. 31, 2013

(54) DEVICE AND METHODS FOR SCANNING RECTANGULAR-SHAPED TRANSFORMS IN VIDEO CODING

(71) Applicants: Jian Lou, San Diego, CA (US); Jae Hoon Kim, Santa Clara, CA (US); Limin Wang, San Diego, CA (US)

(72) Inventors: Jian Lou, San Diego, CA (US); Jae Hoon Kim, Santa Clara, CA (US); Limin Wang, San Diego, CA (US)

(73) Assignee: GENERAL INSTRUMENT CORPORATION, Horsham, PA (US)

(21) Appl. No.: 13/556,044

(22) Filed: Jul. 23, 2012

Related U.S. Application Data
(60) Provisional application No. 61/511,014, filed on Jul. 22, 2011.

(51) Int. Cl. H04N 7/30

(52) U.S. Cl. 375/240.18; 375/E07.226

(57) ABSTRACT

Devices and methods that allow for applying a wavefront scan to rectangular transform blocks are described herein. Such devices and methods may allow greater efficiencies for entropy coding by enabling parallel processing of transform coefficients. In some embodiments, a method for coding a digital video sequence having a plurality of pictures includes dividing at least one of the plurality of pictures into blocks, performing a rectangular transform on at least one of said blocks to produce one or more transform coefficients, performing quantization on the one or more transform coefficients, and encoding the one or more transform coefficients, one at a time, along a coding scan order, to generate a compressed bitstream. The coding scan order may include a forward wavefront scan order or a reverse wavefront scan order and the quantization may result in producing quantized transform coefficients.

### CROSS-REFERENCE TO RELATED APPLICATIONS

The present application claims the benefit of U.S. provisional patent application No. 61/511,014, entitled “Wavefront Scan for Rectangular Transform” filed Jul. 22, 2011, which is incorporated herein by reference in its entirety.

### FIELD

The disclosure relates generally to the field of video coding, and more specifically to systems, devices and methods for scanning rectangular-shaped transforms in entropy coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (e.g., intra-picture) prediction and/or temporal (e.g., inter-picture) prediction to reduce or remove redundancy inherent in video sequences. For block-based video coding, a video slice (e.g., a video frame or a portion of a video frame) may be partitioned into video blocks, which may also be referred to as tree blocks, coding units (CUs) and/or coding nodes. Video blocks in an intra-coded (I) slice of a picture may be encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction may result in a predictive block for a block to be coded. Residual data may represent pixel differences between the original block to be coded and the predictive block. An inter-coded block may be encoded according to a motion vector that points to a block of reference samples forming the predictive block, and the residual data indicating the difference between the coded block and the predictive block. An intra-coded block may be encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

The present disclosure contemplates new devices and methods that provide efficiencies for entropy coding.

### BRIEF SUMMARY

Accordingly, there is provided herein devices and methods that allow for applying a wavefront scan to rectangular transform blocks. Such devices and methods may allow greater efficiencies for entropy coding by enabling parallel processing of transform coefficients.

In some embodiments, a method for coding a digital video sequence having a plurality of pictures includes dividing at least one of the plurality of pictures into blocks, performing a rectangular transform on at least one of said blocks to produce one or more transform coefficients, performing quantization on the one or more transform coefficients, and encoding the one or more transform coefficients, one at a time, along a coding scan order, to generate a compressed bitstream. The coding scan order may include a forward wavefront scan order or a reverse wavefront scan order and the quantization may result in producing quantized transform coefficients.

In some embodiments, an apparatus for coding a digital video sequence having a plurality of pictures includes a video coder configured to divide at least one of the plurality of pictures into blocks, perform a rectangular transform on at least one of the blocks to produce one or more transform coefficients, perform quantization on the one or more transform coefficients, and encode the one or more transform coefficients, one at a time, along a coding scan order, to generate a compressed bitstream. The coding scan order may include a forward wavefront scan order or a reverse wavefront scan order and the quantization may result in producing quantized transform coefficients.

In other embodiments, a method for processing a compressed bitstream includes receiving a compressed bitstream and processing the compressed bitstream to generate one or more transform coefficients of a rectangular transform. The one or more transform coefficients may be generated, one at a time, along a coding scan order of the rectangular transform and the coding scan order may include a forward wavefront scan order or a reverse wavefront scan order.

In still other embodiments, an apparatus for processing a compressed bitstream includes a video decoder configured to receive a compressed bitstream and process the compressed bitstream to generate one or more transform coefficients of a rectangular transform. The one or more transform coefficients may be generated, one at a time, along a coding scan order of the rectangular transform, and the coding scan order may include a forward wavefront scan order or a reverse wavefront scan order.

### BRIEF DESCRIPTION OF THE DRAWINGS

The details of the present disclosure, both as to its structure and operation, may be understood in part by study of the accompanying drawings, in which like reference numerals refer to like parts. The drawings are not necessarily to scale, emphasis instead being placed upon illustrating the principles of the invention.

FIG. 1 is a block diagram illustrating spatial and temporal sampling of images.

FIG. 2 is a block diagram illustrating an example of a video encoding and decoding system that may implement techniques for efficiently performing scanning of a rectangular block of video data in accordance with an embodiment.

FIG. 3 is a one example of a picture is divided into blocks (LCU) in accordance with an embodiment.

FIG. 4 is one example of an LCU divided into CUs in accordance with an embodiment.

FIG. 5 is a quad tree representation of LCU partition in FIG. 4 in accordance with an embodiment.

FIG. 6 shows four possible partitions per CU into PUs in accordance with an embodiment.

FIG. 7 is an example of a CU partition and associated set of TUs in accordance with an embodiment.

FIG. 8 is a quad tree representation of TUs within CU in the example of FIG. 7 in accordance with an embodiment.

FIGS. 9A-C are conceptual diagrams illustrating an example of a block of video data and corresponding significant coefficient position information and last significant coefficient position information.

FIG. 10 is a conceptual diagram illustrating an example of blocks of video data scanned using a zig-zag scanning order.

FIG. 11 is a conceptual diagram illustrating an additional example of blocks of video data scanned using a zig-zag scanning order.

FIG. 12 is an example of square wavefront scan.

FIGS. 13A-D are examples of wavefront scan directions in accordance with an embodiment.

FIG. 14 is one example of Whole Forward Rectangular-Shaped Wavefront Scan (45° from bottom-left to top-right) in accordance with an embodiment.

FIG. 15 is one example of Whole Reverse Rectangular-Shaped Wavefront Scan (45° from bottom-left to top-right) in accordance with an embodiment.

FIG. 16 is one example of Whole Forward Rectangular-Shaped Wavefront Scan (−135° from top-right to bottom-left) in accordance with an embodiment.

FIG. 17 is one example of Whole Reverse Rectangular-Shaped Wavefront Scan (−135° from top-right to bottom-left) in accordance with an embodiment.

FIG. 18 is one example of Partial Forward Rectangular-Shaped Wavefront Scan until the Last Non-zero Quantized Transform Coefficient (45° from bottom-left to top-right) in accordance with an embodiment.

FIG. 19 is one example of Partial Reverse Rectangular-Shaped Wavefront Scan Starting from the Last Non-zero Quantized Transform Coefficient (45° from bottom-left to top-right) in accordance with an embodiment.

FIG. 20 is one example of Partial Forward Rectangular-Shaped Wavefront Scan until the Last Non-zero Quantized Transform Coefficient (−135° from top-right to bottom-left) in accordance with an embodiment.

FIG. 21 is one example of Partial Reverse Rectangular-Shaped Wavefront Scan Starting From the Last Non-zero Quantized Transform Coefficient (−135° from top-right to bottom-left) in accordance with an embodiment.

FIG. 22 is a block diagram illustrating an example of a video encoder that may implement techniques for efficiently performing scanning of a rectangular block of video data in accordance with an embodiment.

FIG. 23 is a block diagram illustrating an example of a video decoder that may implement techniques for efficiently decoding encoded scanned information for a rectangular block of video data in accordance with an embodiment.

### DETAILED DESCRIPTION

The techniques of this disclosure may, in some examples, be used with any context adaptive entropy coding methodology, including context adaptive entropy coding (CABAC), probability interval partitioning entropy coding (PIPE), or another context adaptive entropy coding methodology. CABAC is described in this disclosure for purposes of illustration, but without limitation as to the techniques broadly described in this disclosure. Also, the techniques may be applied to coding of other types of data generally, e.g., in addition to video data.

In this disclosure, the term “coding” refers to encoding that occurs at the encoder or decoding that occurs at the decoder. Similarly, the term coder refers to an encoder, a decoder, or a combined encoder/decoder (CODEC). The terms coder, encoder, decoder and CODEC all refer to specific machines designed for the coding (encoding and/or decoding) of video data consistent with this disclosure.

The present discussion begins with a very brief overview of some terms and techniques known in the art of digital image compression. This overview is not meant to teach the known art in any detail. Those skilled in the art know how to find greater details in textbooks and in the relevant standards.

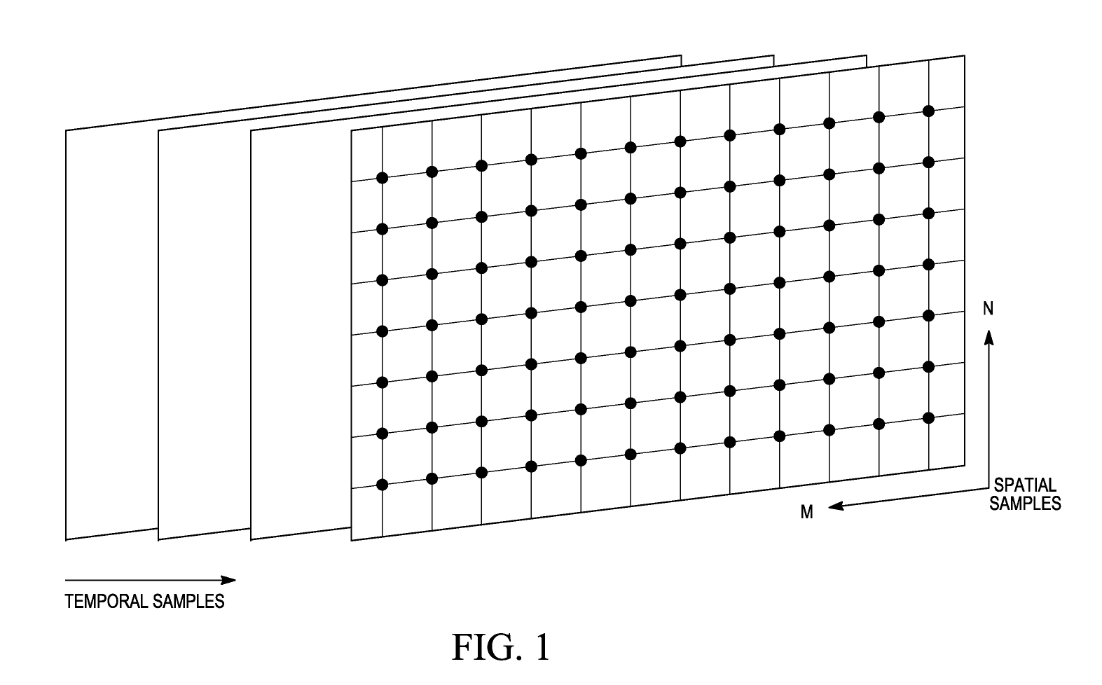

A real-life visual scene is composed of multiple objects laid out in a three-dimensional space that varies temporally. Object characteristics such as color, texture, illumination, and position change in a continuous manner. Digital video is a spatially and temporally sampled representation of the real-life scene. It is acquired by capturing a two-dimensional projection of the scene onto a sensor at periodic time intervals. Spatial sampling occurs by taking the points which coincide with a sampling grid that is superimposed upon the sensor output. Each point, called pixel or sample, represents the features of the corresponding sensor location by a set of values from a color space domain that describes the luminance and the color. A two-dimensional array of pixels at a given time index is called a frame. FIG. 1 illustrates spatio-temporal sampling of a visual scene.

Video encoding systems achieve compression by removing redundancy in the video data, e.g., by removing those elements that can be discarded without adversely affecting reproduction fidelity. Because video signals take place in time and space, most video encoding systems exploit both temporal and spatial redundancy present in these signals. Typically, there is high temporal correlation between successive frames. This is also true in the spatial domain for pixels which are close to each other. Thus, high compression gains are achieved by carefully exploiting these spatio-temporal correlations.

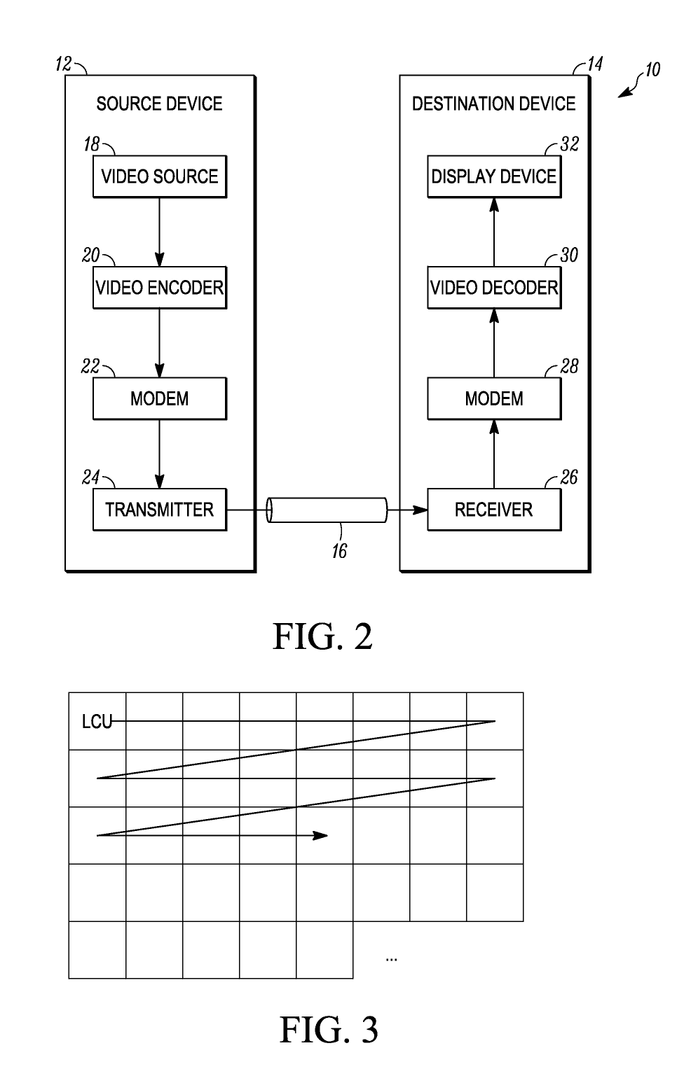

FIG. 2 is a block diagram that illustrates an example of a video encoding and decoding system 10 that may implement techniques for efficiently performing wavefront scanning of a rectangular block of video data, consistent with the techniques of this disclosure. As shown in FIG. 2, system 10 includes a source device 12 that transmits encoded video to a destination device 14 via a communication channel 16. Source device 12 and destination device 14 may comprise any of a wide range of devices. In some cases, source device 12 and destination device 14 may comprise wireless communication devices, such as wireless handsets, so-called cellular or satellite radiotelephones, or any wireless devices that can communicate video information over a communication channel 16, in which case communication channel 16 is wireless.

It should be appreciated that the techniques of this disclosure are not necessarily limited to wireless applications or settings. These techniques may generally apply to any scenario where encoding or decoding is performed, including over-the-air television broadcasts, cable television transmissions, satellite television transmissions, streaming Internet video transmissions, encoded digital video that is encoded onto a storage medium or retrieved and decoded from a storage medium, or other scenarios. Accordingly, communication channel 16 is not required and the techniques of this disclosure may apply to settings where encoding is applied or where decoding is applied, e.g., without any data communication between encoding and decoding devices.

In the example of FIG. 2, source device 12 includes a video source 18, video encoder 20, a modulator/demodulator (modem) 22 and a transmitter 24. Destination device 14 includes a receiver 26, a modem 28, a video decoder 30, and a display device 32. In accordance with this disclosure, video encoder 20 of source device 12 and/or video decoder 30 of destination device 14 may be configured to apply the techniques for performing wavefront scanning of a rectangular block of video data. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 2 is merely one example. Techniques for efficiently performing wavefront scanning of a rectangular block of video data may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 includes video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be modulated by modem 22 according to a communication standard, and transmitted to destination device 14 via transmitter 24. Modem 22 may include various mixers, filters, amplifiers or other components designed for signal modulation. Transmitter 24 may include circuits designed for transmitting data, including amplifiers, filters, and one or more antennas.

Receiver 26 of destination device 14 e.g., a decoder, receives information over channel 16, and modem 28 demodulates the information. Again, the video encoding process described above may implement one or more of the techniques described herein to efficiently perform wavefront scanning of a rectangular block of video data. The information communicated over channel 16 may include syntax information defined by video encoder 20, which is also used by video decoder 30, that includes syntax elements that describe characteristics and/or processing of blocks of video data (e.g., macroblocks, or coding units), e.g., scanning order information for the blocks, and other information. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

In the example of FIG. 2, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14. In other examples, encoding or decoding devices may implement techniques of this disclosure without any communication between such devices. For example, an encoding device may encode and store an encoded bitstream consistent with the techniques of this disclosure. Alternatively, a decoding device may receive or retrieve an encoded bitstream, and decode the bitstream consistent with the techniques of this disclosure.

Video encoder 20 and video decoder 30 may operate according to a video compression standard, such as the ITU-T H.264 standard, alternatively referred to as MPEG-4, Part 10, Advanced Video Coding (AVC). The techniques of this disclosure, however, are not limited to any particular coding standard. Other examples include MPEG-2, ITU-T H.263, and the High Efficiency Video Coding (HEVC) standard presently under development. In general, the techniques of this disclosure are described with respect to HEVC, but it should be understood that these techniques may be used in conjunction with other video coding standards as well. Although not shown in FIG. 2, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder and decoder circuitry, such as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 30 may be included in one or more encoders or decoders, either of which may be integrated as part of a combined encoder/decoder (CODEC) in a respective camera, computer, mobile device, subscriber device, broadcast device, set-top box, server, or the like.

A video sequence typically includes a series of video frames. A group of pictures (GOP) generally comprises a series of one or more video frames. A GOP may include syntax data in a header of the GOP, a header of one or more frames of the GOP, or elsewhere, that describes a number of frames included in the GOP. Each frame may include frame syntax data that describes an encoding mode for the respective frame. A video encoder, e.g., video encoder 20, typically operates on video blocks within individual video frames in order to encode the video data. According to the ITU-T H.264 standard, a video block may correspond to a macroblock or a partition of a macroblock. According to other standards, e.g., HEVC described in greater detail below, a video block may correspond to a coding unit (e.g., a largest coding unit (LCU)), or a partition of a coding unit, as shown in FIG. 3. The video blocks may have fixed or varying sizes, and may differ in size according to a specified coding standard, e.g., 128×128 or 64×64 or 32×32 or 16×16 pixels for HEVC (depending on the LCU size). Each video frame may include a plurality of slices, e.g., portions of the video frame. Each slice may include a plurality of video blocks, which may be arranged into partitions, also referred to as sub-blocks.

Depending on the specified coding standard, video blocks may be partitioned into various “N×N” sub-block sizes, such as 16×16, 8×8, 4×4, 2×2, and so forth. Sub-blocking may be used for regularity in processing. In this disclosure, “N×N” and “N by N” may be used interchangeably to refer to the pixel dimensions of the block in terms of vertical and horizontal dimensions, e.g., 16×16 pixels or 16 by 16 pixels. In general, a 16×16 block will have sixteen pixels in a vertical direction (y=16) and sixteen pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N. As one example, in the ITU-T H.264 standard, blocks that are 16 by 16 pixels in size may be referred to as macroblocks, and blocks that are less than 16 by 16 pixels may be referred to as partitions of a 16 by 16 macroblock. In other standards, such as HEVC, blocks may be defined more generally with respect to their size, for example, as coding units and partitions thereof, each having a varying, rather than a fixed size.

Video blocks may comprise blocks of pixel data in the pixel domain, or blocks of transform coefficients in the transform domain, e.g., following application of a transform, such as a discrete cosine transform (DCT), an integer transform, a wavelet transform, or a conceptually similar transform to residual data for a given video block, wherein the residual data represents pixel differences between video data for the block and predictive data generated for the block. In some cases, video blocks may comprise blocks of quantized transform coefficients in the transform domain, wherein, following application of a transform to residual data for a given video block, the resulting transform coefficients are also quantized.

Quantization reduces the range of values a signal can take, so that it is possible to represent the signal with fewer bits. In some embodiments, external boundary conditions are used to produce modified one or more transform coefficients. For example, a lower range or value may be used in determining if a transform coefficient is given a nonzero value or just zeroed out. In video encoding, quantization is the step that introduces loss, so that a balance between bitrate and reconstruction quality can be established.

Block partitioning serves an important purpose in block-based video coding techniques. Using smaller blocks to code video data may result in better prediction of the data for locations of a video frame that include high levels of detail, and may therefore reduce the resulting error (e.g., deviation of the prediction data from source video data), represented as residual data. In general, prediction exploits the spatial or temporal redundancy in a video sequence by modeling the correlation between sample blocks of various dimensions, such that only a small difference between the actual and the predicted signal needs to be encoded. A prediction for the current block is created from the samples which have already been encoded. While potentially reducing the residual data, such techniques may, however, require additional syntax information to indicate how the smaller blocks are partitioned relative to a video frame, and may result in an increased coded video bitrate. Accordingly, in some techniques, block partitioning may depend on balancing the desirable reduction in residual data against the resulting increase in bitrate of the coded video data due to the additional syntax information.

In general, blocks and the various partitions thereof (e.g., sub-blocks) may be considered video blocks. In addition, a slice may be considered to be a plurality of video blocks (e.g., macroblocks, or coding units), and/or sub-blocks (partitions of marcoblocks, or sub-coding units). Each slice may be an independently decodable unit of a video frame. Alternatively, frames themselves may be decodable units, or other portions of a frame may be defined as decodable units. Furthermore, a GOP, also referred to as a sequence, may be defined as a decodable unit.

As stated above, efforts are currently in progress to develop a new video coding standard, currently referred to as High Efficiency Video Coding (HEVC). The emerging HEVC standard may also be referred to as H.265. The standardization efforts are based on a model of a video coding device referred to as the HEVC Test Model (HM). The HM presumes several capabilities of video coding devices over devices according to, e.g., ITU-T H.264/AVC. For example, whereas H.264 provides nine intra-prediction encoding modes, HM provides as many as thirty-five intra-prediction encoding modes, e.g., based on the size of a block being intra-prediction coded.

In general, in intra-prediction encoding, a high level of spatial correlation is present between neighboring blocks in a frame. Consequently, a block can be predicted from the nearby encoded and reconstructed blocks, giving rise to the intra prediction. In some embodiments, the prediction can be formed by a weighted average of the previously encoded samples, located above and to the left of the current block. The encoder may select the mode that minimizes the difference between the original and the prediction and signals this selection in the control data.

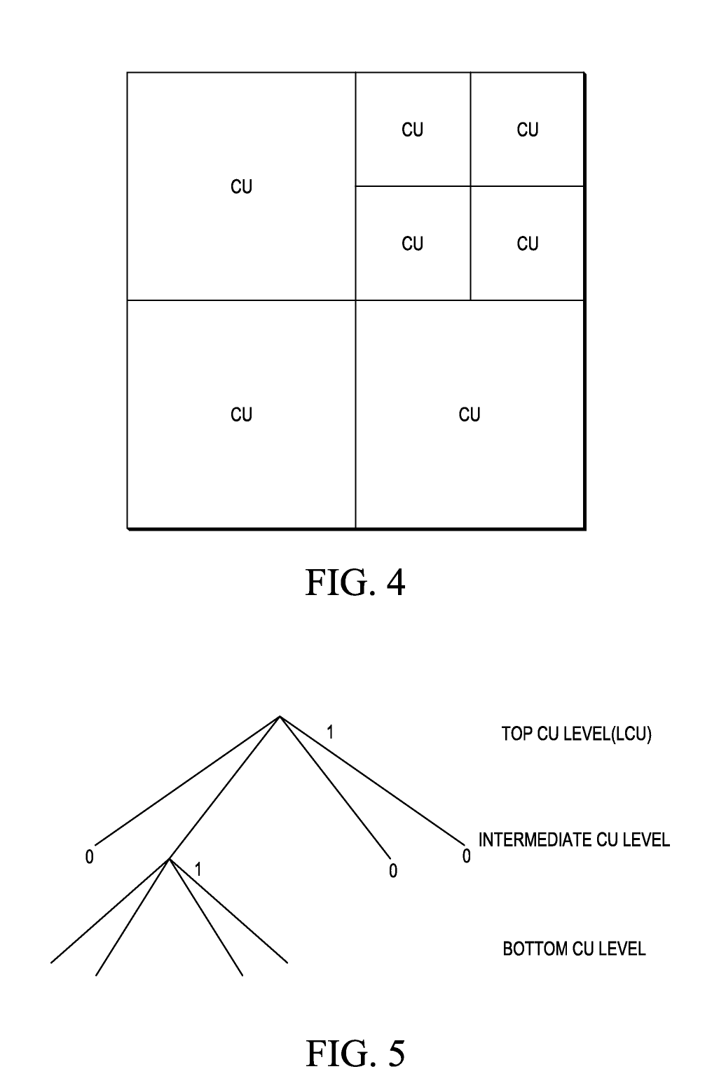

HM refers to a block of video data as a coding unit (CU). A CU may refer to an image region that serves as a basic unit to which various coding tools are applied for compression. In H.264, it may also be called a macroblock. Syntax data within a bitstream may define a largest coding unit (LCU), which is a largest CU in terms of the number of pixels. In general, a CU has a similar purpose to a macroblock of H.264, except that a CU does not have a size distinction. Thus, a CU may be partitioned, or “split” into sub-CUs, as shown in FIG. 4

An LCU may be associated with a quadtree data structure, as shown in FIG. 5 that indicates how the LCU is partitioned. Specifically, at each node of a quadtree, a bit “1” is assigned if the node is further split into sub-nodes, otherwise a bit “0” is assigned. For example, LCU partition in FIG. 4 may be represented by the quadtree shown in FIG. 5. The quadtree representation of binary data 10100 may be coded and transmitted as overhead.

In general, a quadtree data structure includes one node per CU of an LCU, where a root node corresponds to the LCU, and other nodes correspond to sub-CUs of the LCU. If a given CU is split into four sub-CUs, the node in the quadtree corresponding to the split CU includes four child nodes, each of which corresponds to one of the sub-CUs. Each node of the quadtree data structure may provide syntax information for the corresponding CU. For example, a node in the quadtree may include a split flag for the CU, indicating whether the CU corresponding to the node is split into four sub-CUs. Syntax information for a given CU may be defined recursively, and may depend on whether the CU is split into sub-CUs.

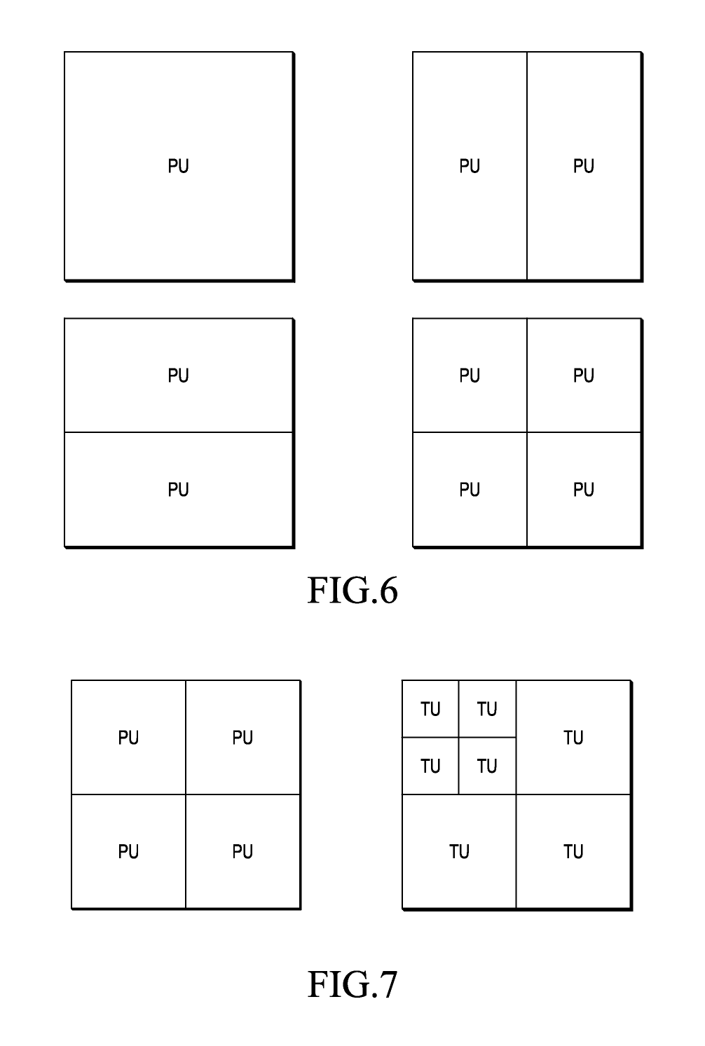

A CU that is not split (e.g., a CU corresponding a terminal, or “leaf” node in a given quadtree) may include one or more prediction units (PUs). In general, a PU represents all or a portion of the corresponding CU, and includes data for retrieving a reference sample for the PU for purposes of performing prediction for the CU. For example, when the CU is intra-mode encoded, the PU may include data describing an intra-prediction mode for the PU. As another example, when the CU is inter-mode encoded, the PU may include data defining a motion vector for the PU. The data defining the motion vector may describe, for example, a horizontal component of the motion vector, a vertical component of the motion vector, a resolution for the motion vector (e.g., one-quarter pixel precision or one-eighth pixel precision), a reference frame to which the motion vector points, and/or a reference list (e.g., list 0 or list 1) for the motion vector. Data for the CU defining the one or more PUs of the CU may also describe, for example, partitioning of the CU into the one or more PUs. Partitioning modes may differ between whether the CU is uncoded, intra-prediction mode encoded, or inter-prediction mode encoded. An example showing four possible partitions per CU is shown in FIG. 6.

In the current HEVC standard, there are 35 spatial prediction directions or modes per PU, including horizontal, vertical, 45-degree diagonal, 135-degree diagonal, DC, etc. A syntax is generally used to indicate the spatial prediction per PU.

In general, in inter-prediction encoding, video sequences have high temporal correlation between frames, enabling a block in the current frame to be accurately described by a region in the previous frames, which are known as reference frames. Inter-prediction utilizes previously encoded and reconstructed reference frames to develop a prediction using a block-based motion estimation and compensation technique.

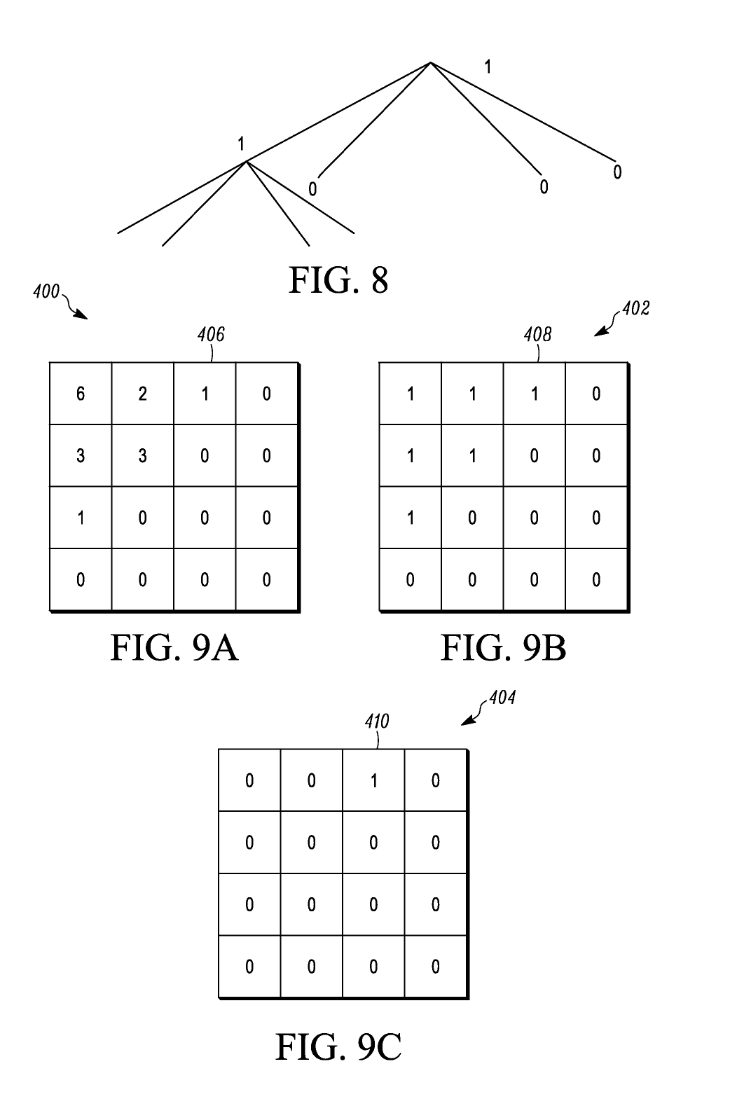

A CU having one or more PUs may also include one or more transform units (TUs), as shown in FIG. 7. Following prediction for a CU using one or more PUs, as described above, a video encoder may calculate one or more residual blocks for the respective portions of the CU corresponding to the one of more PUs. The residual blocks may represent a pixel difference between the video data for the CU and the predicted data for the one or more PUs. A set of residual values may be transformed, scanned, and quantized to define a set of quantized transform coefficients. A TU may define a partition data structure that indicates partition information for the transform coefficients that is substantially similar to the quadtree data structure described above with reference to a CU, as shown in FIG. 8.

As with other video coding standards, HEVC applies a block transform on residual data to decorrelate the pixels within a block and compact the block energy into low order transform coefficients. However, unlike the standards that apply a single 4×4 or 8×8 transform to a macroblock, HEVC can apply a set of block transforms of different sizes to a single CU. The set of block transforms to be applied to a CU is represented by its associated TUs. Thus, it should be appreciated that a TU is not necessarily limited to the size of a PU, e.g., TUs may be larger or smaller than corresponding PUs for the same CU. In some examples, the maximum size of a TU may correspond to the size of the corresponding CU. In general, TUs indicate what block transforms should be applied to the CU partitions, where the scope of each block transform is defined by the location and size of each TU. The configuration of TUs associated with a particular CU can differ based on various criteria.

In one example, residual samples corresponding to a CU may be subdivided into smaller units using a quadtree structure known as “residual quad tree” (RQT). As shown in FIG. 8, RQT representation 11000 may be coded and transmitted as overhead. In this case, the leaf nodes of the RQT may be referred as the TUs, for which the corresponding residual samples may be transformed and quantized.

Following intra-predictive or inter-predictive encoding to produce predictive data and residual data, and following any transforms (such as the 4×4 or 8×8 integer transform used in H.264/AVC or a discrete cosine transform (DCT) to produce transform coefficients, quantization of transform coefficients may be performed. Quantization generally refers to a process in which transform coefficients are quantized to possibly reduce the amount of data used to represent the coefficients, e.g., by converting high precision transform coefficients into a finite number of possible values. The quantization process may reduce the bit depth associated with some or all of the coefficients. For example, an n-bit value may be rounded down to an m-bit value during quantization, where n is greater than m. As should be appreciated, quantization is a lossy operation and the loss by quantization generally cannot be recovered.

Following quantization, entropy coding of the quantized data (e.g., quantized transform coefficients) may be performed. The entropy coding may conform to the techniques of this disclosure with respect to efficiently performing scanning of a rectangular block of video data, and may also use other entropy coding techniques, such as context adaptive variable length coding (CAVLC), CABAC, PIPE, or another entropy coding methodology. For example, coefficient values, represented as magnitudes and corresponding signs (e.g., “+1,” or “−1”) for the quantized transform coefficients may be encoded using the entropy coding techniques.

It should be noted that the prediction, transform, and quantization described above may be performed for any block of video data, e.g., to a PU and/or TU of a CU, or to a macroblock, depending on the specified coding standard. Accordingly, the techniques of this disclosure, relating to efficiently performing scanning of a rectangular block of video data, may apply to any rectangular block of video data, e.g., to any rectangular block of quantized transform coefficients, including a macroblock, or a TU of a CU. Furthermore, a block of video data (e.g., a macroblock, or a TU of a CU) may include each of a luminance component (Y), a first chrominance component (U), and a second chrominance component (V) of the corresponding video data. As such, the techniques of this disclosure may be performed for each of the Y, U, and V components of a given rectangular block of video data.

In order to encode blocks of video data as described above, information regarding position of significant coefficients within a given block may also be generated and encoded. Subsequently, the values of the significant coefficients may be encoded, as described above. In H.264/AVC and the emerging HEVC standard, when using a context adaptive entropy coding process, e.g., a CABAC process, the position of significant coefficients within a block of video data may be encoded prior to encoding the values of the significant coefficients. The process of encoding the position of all of the significant coefficients within the block may be referred to as significance map (SM) encoding. FIGS. 9A-9C, described in greater detail below, are conceptual diagrams that illustrate an example of a 4×4 block of quantized transform coefficients and corresponding SM data. It should be realized that a 4×4 block of quantized transform coefficients and corresponding SM data is shown purely for example purposes, as the techniques of this disclosure, relate generally to efficiently performing scanning of a rectangular block of video data.

A typical SM encoding procedure may be described as follows. For a given block of video data, an SM may be encoded only if there is at least one significant coefficient within the block. Presence of significant coefficients within a given block of video data may be indicated in a coded block pattern (e.g., using syntax element “coded_block_pattern,” or CBP), which is a binary value coded for a set of blocks (such as luminance and chrominance blocks) associated with an area of pixels in the video data. Each bit in the CBP is referred to as a coded block flag (e.g., corresponding to syntax element “coded_block_flag”) and used to indicate whether there is at least one significant coefficient within its corresponding block. In other words, a coded block flag is a one-bit symbol indicating whether there are any significant coefficients inside a single block of transform coefficients, and a CBP is a set of coded block flags for a set of related video data blocks.

If a coded block flag indicates that no significant coefficients are present within the corresponding block (e.g., the flag equals “0”), no further information may be encoded for the block. However, if a coded block flag indicates that at least one significant coefficient exists within the corresponding block (e.g., the flag equals “1”), an SM may be encoded for the block by following a coefficient scanning order associated with the block. In some embodiments, the significant coefficient may comprise a non-zero quantized transform coefficient. The scanning order may define the order in which the significance of each coefficient within the block is encoded as part of the SM encoding. In some embodiments, the significant coefficient may comprise a non-zero quantized transform coefficient. In other words, scanning may serialize the two-dimensional block of coefficients to a one-dimensional representation to determine the significance of the coefficients.

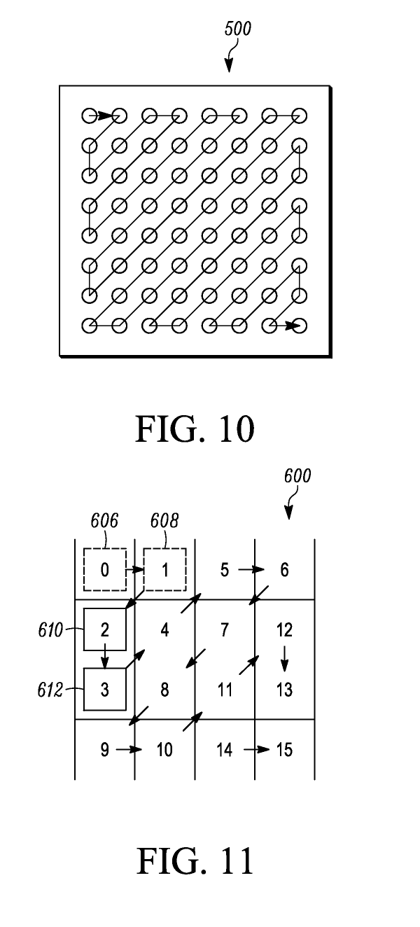

Different scanning orders e.g., zig-zag, have been traditionally used. FIG. 10 also described in greater detail below, illustrate examples of some of the various scanning orders that have been traditionally used for 8×8 blocks of video data. It should be realized that a 8×8 block of video data is shown purely for example purposes, as the techniques of this disclosure, relate generally to efficiently performing scanning of a rectangular block of video data.

Given a coded block flag that indicates that at least one significant coefficient exists within a given block, and a scanning order for the block, an SM for the block may be encoded as follows. The two-dimensional block of quantized transform coefficients may first be mapped into a one-dimensional array using the scanning order. For each coefficient in the array, following the scanning order, a one-bit significant coefficient flag (e.g., corresponding to syntax element “significant_coeff_flag”) may be encoded. That is, each position in the array may be assigned a binary value, which may be set to “1” if the corresponding coefficient is significant, and set to “0” if it is non-significant (e.g., zero).

If a given significant coefficient flag equals “1,” indicating that the corresponding coefficient is significant, an additional one-bit last significant coefficient flag (e.g., corresponding to syntax element “last_significant_coeff_flag”) may also be encoded, which may indicate whether the corresponding coefficient is the last significant coefficient within the array (e.g., within the block given the scanning order). Specifically, each last significant coefficient flag may be set to “1” if the corresponding coefficient is the last significant coefficient within the array, and set to “0” otherwise. If the last array position is reached in this manner, and the SM encoding process was not terminated by a last significant coefficient flag equal to “1,” then the last coefficient in the array (and thereby the block given the scanning order) may be inferred to be significant, and no last significant coefficient flag may be encoded for the last array position.

FIGS. 9B-9C are conceptual diagrams that illustrate examples of sets of significant coefficient flags and last significant coefficient flags, respectively, corresponding to SM data for the block depicted in FIG. 9A, presented in map, rather than array form. It should be noted that significant coefficient flags and last significant coefficient flags, as described above, may be set to different values (e.g., a significant coefficient flag may be set to “0” if the corresponding coefficient is significant, and “1” if it is non-significant, and a last significant coefficient flag may be set to “0” if the corresponding coefficient is the last significant coefficient, and “1” if it is not the last significant coefficient) in other examples.

After the SM is encoded, as described above, the value of each significant coefficient (e.g., each significant coefficient's magnitude and sign, e.g., indicated by syntax elements “coeff_abs_level_minus1” and “coeff_sign_flag,” respectively) in the block may also be encoded.

FIGS. 9A-9C are conceptual diagrams that illustrate an example of a block of video data and corresponding significant coefficient position information and last significant coefficient position information.

As shown in FIG. 9A, a block of video data, e.g., a macroblock, or a TU of a CU, may include quantized transform coefficients. For example, as shown in FIG. 9A, block 400 may include quantized transform coefficients generated using prediction, transform, and quantization techniques previously described. Assume, for this example, that block 400 has a size of 2N×2N, wherein N equals to two. Accordingly, block 400 has a size of 4×4, and includes sixteen quantized transform coefficients, as also shown in FIG. 9A. Assume further, that the scanning order associated with block 400 is the zig-zag scanning order, as shown in FIG. 10 described in greater detail below. In this example, a last significant coefficient within block 400 according to the zig-zag scanning order is a quantized transform coefficient equal to “1,” located in position 406 within block 400.

FIG. 9B illustrates an example of significant coefficient flag data, e.g., significant coefficient flags represented in map, or block form, as previously described. In the example of FIG. 9B, block 402 may correspond to block 400 depicted in FIG. 9A. In other words, the significant coefficient flags of block 402 may correspond to the quantized transform coefficients of block 400. As shown in FIG. 9B, the significant coefficient flags of block 402 that are equal to “1” correspond to significant coefficients of block 400. Similarly, the significant coefficient flags of block 402 that are equal to “0” correspond to zero, or non-significant coefficients of block 400. In this example, a significant coefficient flag of block 402 corresponding to the last significant coefficient within block 400 according to the zig-zag scanning order is a significant coefficient flag equal to “1,” located in position 408 within block 402.

FIG. 9C illustrates an example of last significant coefficient flag data, e.g., last significant coefficient flags represented in map, or block form, as also previously described. In the example of FIG. 9C, block 404 may correspond to block 400 and block 402 depicted in FIG. 9A and FIG. 9B, respectively. In other words, the last significant coefficient flags of block 404 may correspond to the quantized transform coefficients of block 400, and to the significant coefficient flags of block 402. As shown in FIG. 9C, the last significant coefficient flag of block 404 that is equal to “1,” located in position 410 within block 404, corresponds to a last significant coefficient of block 400, and to a last one of the significant coefficient flags of block 402 that are equal to “1,” according to the zig-zag scanning order. In any case, the significant coefficient flags of block 402, and the last significant coefficient flags of block 404, may be collectively referred to as SM data for block 400.

As described above, significant coefficient position information for a block of video data may be indicated by serializing significant coefficient flags for the block from a two-dimensional block representation, as depicted in block 402 shown in FIG. 9B, into a one-dimensional array, using a scanning order associated with the block. In the example of blocks 400-402 shown in FIGS. 9A-9B, again assuming the zig-zag scanning order, the significant coefficient position information for block 400 may be indicated by serializing the significant coefficient flags of block 402 into a one-dimensional array. That is, the significant coefficient position information for block 400 may be indicated by generating a sequence of significant coefficient flags of block 402 according to the zig-zag scanning order.

In this example, the generated sequence may correspond to a value “111111,” representing the first 6 significant coefficient flags of block 402 according to the zig-zag scanning order. It should be noted that the generated sequence may contain significant coefficient flags corresponding to a range of block positions within block 400, starting from a first block position in the zig-zag scanning order (e.g., the DC position or top-most, left-most corner) and ending with a block position corresponding to the last significant coefficient of block 400 according to the zig-zag scanning order (e.g., corresponding to the last significant coefficient flag equal to “1” of block 404).

As also described above, last significant coefficient position information for the block may be indicated by serializing last significant coefficient flags for the block from a two-dimensional block representation, as depicted in block 404 shown in FIG. 9C, into a one-dimensional array, using a scanning order associated with the block. In the example of blocks 400-404 shown in FIGS. 9A-9C, again assuming the zig-zag scanning order, the last significant coefficient position information for block 400 may be indicated by serializing the last significant coefficient flags of block 404 into a one-dimensional array. That is, the last significant coefficient position information for block 400 may be indicated by generating a sequence of last significant coefficient flags of block 404 according to the zig-zag scanning order. In this example, the generated sequence may correspond to a value “000001,” representing the first 6 last significant coefficient flags of block 404 according to the zig-zag scanning order.

FIG. 10 is a conceptual diagram that illustrates an example of blocks of video data scanned using a traditional zig-zag scanning order. As shown in FIG. 10, an 8×8 block of video data, e.g., a macroblock, or a TU of a CU, may include sixty-four quantized transform coefficients in corresponding block positions, denoted with circles. For example, block 500 may include sixty-four quantized transform coefficients generated using prediction, transform, and quantization techniques previously described, again, wherein each corresponding block position is denoted with a circle. Assume, for this example, that block 500 has a size of 2N×2N, wherein N equals to four. Accordingly, block 500 has a size of 8×8.

As shown in FIG. 10, the scanning order associated with block 500 is the traditional zig-zag scanning order. The zig-zag scanning order scans the quantized transform coefficients of block 500 in a diagonal manner as indicated by the arrows in FIG. 10.

FIG. 11 is a conceptual diagram that illustrates an additional example of blocks of video data scanned using a zig-zag scanning order. As shown in FIG. 11, block 600 may include sixteen block positions ordered from 0 to 15 according to the zig-zag scanning order, as indicated by the arrows, and described above with reference to FIG. 10. Each of the sixteen block positions may contain a quantized transform coefficient, as described above with reference to FIG. 9A. As also shown in FIG. 11, the first and second positions within block 600 according to the zig-zag scanning order, corresponding to positions “0” and “1,” may be referred to as common position 606 and common position 608, respectively. In some examples, one or more of common positions 606, 608 may coincide with first and second block positions within another block of video data according to another scanning order.

As described above and shown in FIGS. 10 and 11, the blocks of video data are scanned using a zig-zag pattern, whereby each block position is scanned in a diagonal and then when the end of the diagonal is reached, the scan changes direction and continues until the end of the second diagonal is reached, at which time, the scan changes direction again, and so on. While this zig-zag scan may capture each block of video data, the overall scan is somewhat slow because each block must wait on the block preceding it to finished being scanned. For example, block 612 must wait for block 610 to be scanned, which must wait for block 608 to be scanned, which must wait for block 606 to be scanned. Consequently, the time to scan all of the blocks in block 600 is at least the sum of the time it takes each individual block 606, 608, 610, and so on, to be scanned. Thus, there are dependencies on the previous blocks for each subsequent block. As a result, parallel processing of data or parallel data collection is not possible using the zig-zag scan.

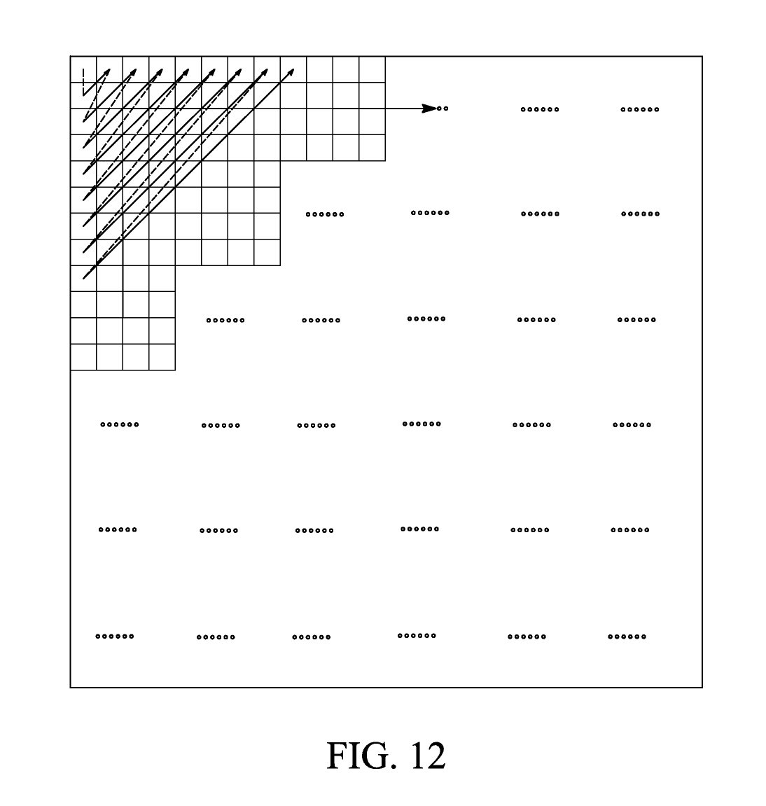

Square wavefront scan or fixed diagonal scan has been introduced to HEVC, as shown in FIG. 12. Also see V. Sze and M. Budagavi, “CE11: Parallelization of HHI_TRANSFORM_CODING (Fixed Diagonal Scan from C227),” JCTVC-F129, July 2011, incorporated herein by reference. Rather than using the traditional zig-zag scan, all the scan lines have the same diagonal scan direction e.g., when CABAC is used. A benefit of this scan is that there are no longer dependencies on the previously decoded data block or bin. Thus far, wavefront scan is limited to square block only, as shown in FIG. 12.

As mentioned above, one of the benefits of HEVC is that a video block may correspond to a coding unit, e.g., LCU, or a partition of a coding unit, and is not limited by size. This is desirable because, as shown in FIG. 1, a frame is often rectangular in shape, or characterized as N×M, where there are N pixels in a vertical direction and M pixels in a horizontal direction, where N and M represent non-equal nonnegative integer values. For example, still referring to FIG. 1, N is equal to 8 and M is equal to 12.

Generally, when a frame is rectangular, its partitions, or sub-blocks, are also likely going to be rectangular. In HEVC, rectangular PUs may be utilized because they generally have a better prediction for rectangular objects. Similarly, rectangular transforms may be used for better compression of rectangular or square predicted residuals. Therefore an effective scanning pattern for rectangular sub-blocks that may utilize parallel data collection is desirable.

Furthermore, rectangular transforms have been recently proposed to achieve higher coding efficiency for HEVC. One possible explanation for this higher coding efficiency is that rectangular transforms may give more choices of residual coding. For example, the encoder can adaptively choose if a square transform or a rectangular transform should be used according to given or predetermined criteria, so that higher compression efficiency may be achieved. See, for example, Y. Yuan, X. Zheng, X. Peng, J. Xu, L. Liu, Y. Wang, X. Cao, C. Lai, J. Zheng, Y. He, and H. Yu, “CE2: Non-Square Quadtree Transform for symmetric motion partitions,” JCTVC-F410, July 2011; Y. Yuan, X. Zheng, X. Peng, J. Xu, I.-K Kim, L. Liu, Y. Wang, X. Cao, C. Lai, J. Zheng, Y. He, and H. Yu, “CE2: Non-Square Quadtree Transform for symmetric and asymmetric motion partitions,” JCTVC-F412, July 2011; and L. Guo, J. Sole, R. Joshi, P. Chen, X. Wang, and M. Karczewicz, “Non-Square Transform for 2N×N and N×2N Motion Partitions,” JCTVC-F563, July 2011, each of which is hereby incorporated by reference.

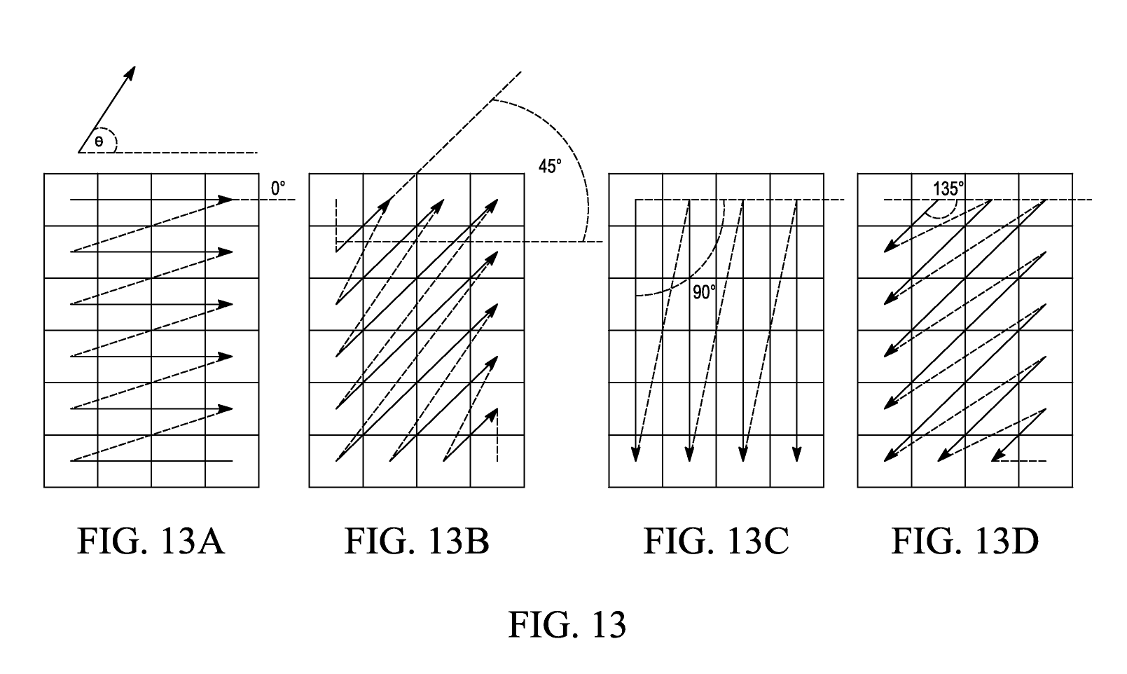

Consequently, it is proposed to use wavefront scans for rectangular transforms where all the scan lines are of the same scan direction. The scan direction of a wavefront scan can be of any angle, θ. FIGS. 13A-D illustrate such example scan patterns that allows for effective scanning of rectangular blocks or sub-blocks for θ at 0°, 45°, −90° and −135°.

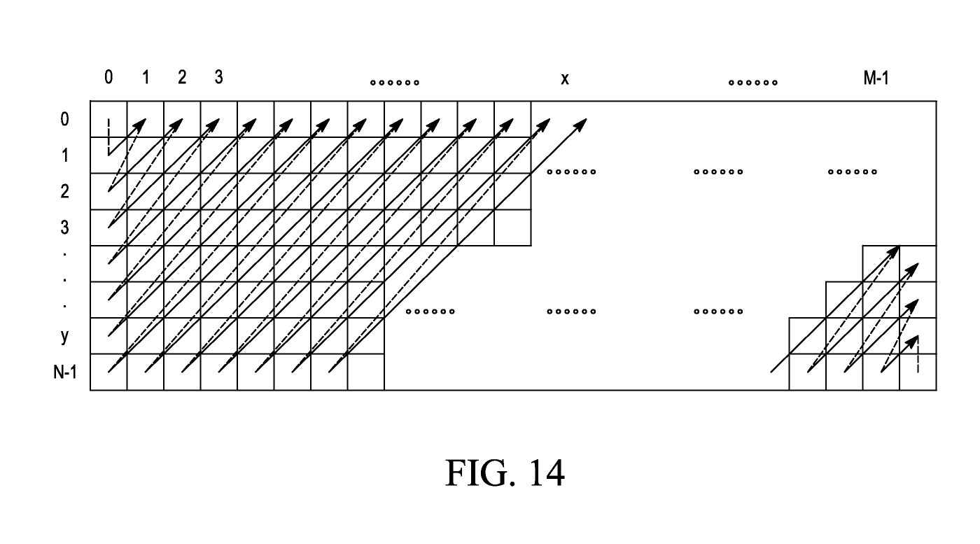

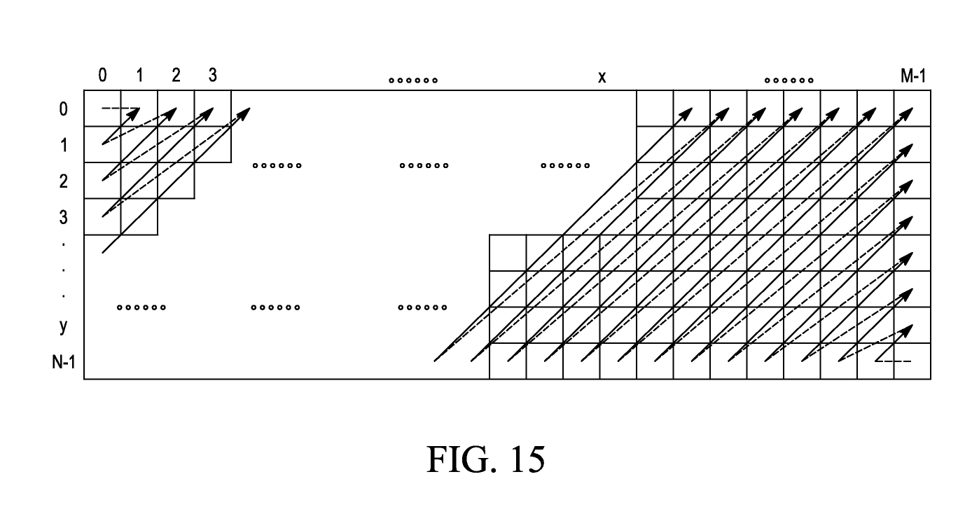

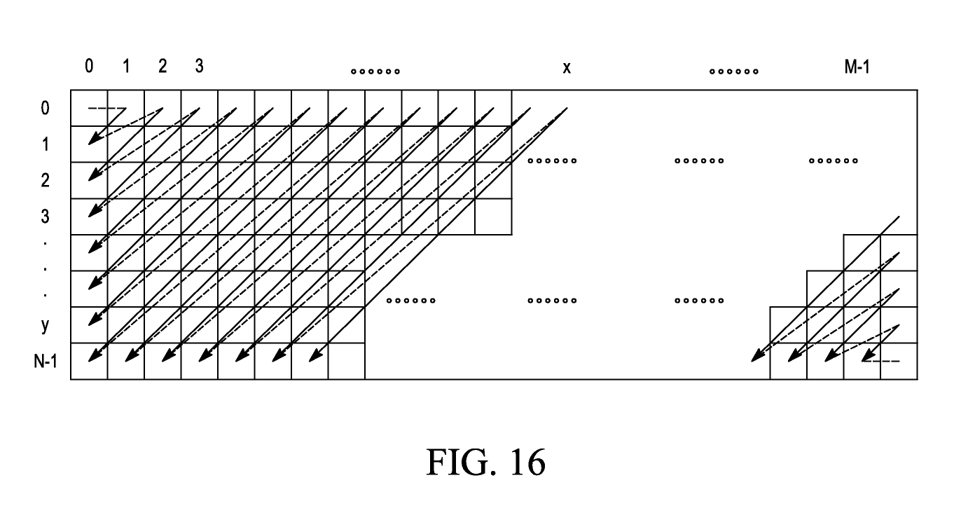

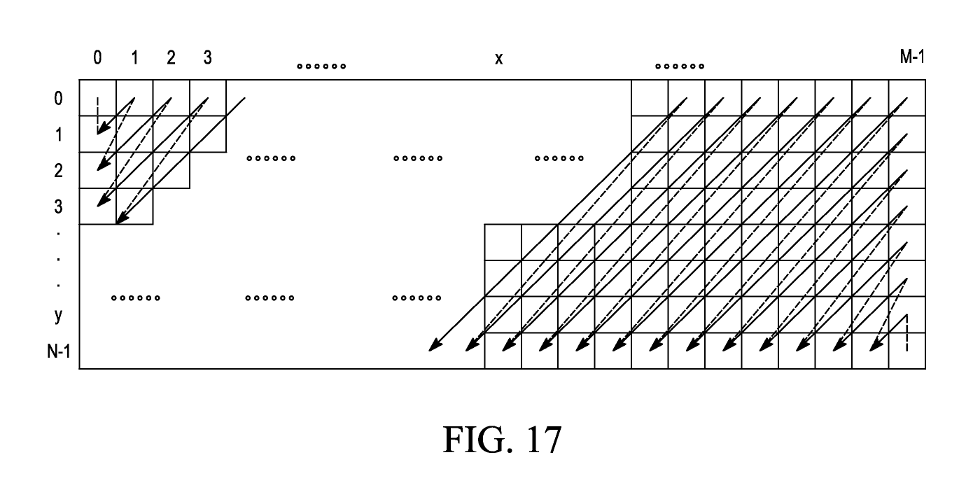

Four specific variations of rectangular-shaped wavefront scan are presented as follows. FIG. 14 illustrates an example of whole forward rectangular-shaped wavefront scan with a scan direction of 45°, where quantized transform coefficients on each scan line are processed from bottom-left to top-right. FIG. 15 illustrates an example of whole reverse rectangular-shaped wavefront scan pattern with a scan direction of 45°, where quantized transform coefficients on each scan line are processed from bottom-left to top-right. FIG. 16 illustrates an example of whole forward rectangular-shaped wavefront scan with a scan direction of −135°, where quantized transform coefficients on each scan line are processed from top-right to bottom-left. FIG. 17 illustrates an example of whole reverse rectangular-shaped wavefront scan with a scan direction of −135°, where quantized transform coefficients on each scan line are processed from top-right to bottom-left.

From reviewing FIGS. 14-17, it should be clear that each scan line is relatively independent, e.g., has small dependency, from the previous scan line. It should be appreciated that there may be some delays, although the delays may be relatively small. These delays may be due to the small dependencies between each line, however, the delay may be small compared to other scans, e.g. zig-zag. Consequently, each line may be scanned at approximately the same time, meaning that the total time necessary to process the data blocks data may be a function of the length of time it takes to scan a single scan line, e.g., with some amount of delay. There may be limitations, however, as it may be desirable to begin the scan of a second scan line after the scan of a first scan line has begun, such that the block immediately next to or proximate to a block in the second line has already been scanned in the first scan line. For example, for a forward scan e.g., wavefront or zig-zag, it may be desirable to decode the left neighbor first, because it may be used for context modeling of the position immediately to its right. Similarly, for a reverse scan it may be desirable to decode the right neighbor first, because it may be used for context modeling of the position immediately to its right. It should be appreciated that by scanning multiple lines at approximately the same time, e.g. more or less in parallel, better speed for read out in entropy encoding may be achieved. Additionally, computation complexity efficiency may be increased due, at least in part, to parallel processing of scanned data.

In general, high frequency transform coefficients inside a TU have smaller energies than DC or low-frequency transform coefficients. Generally, high frequency and low frequency e.g., for transform coefficients, are relative concepts. High frequency means a changing more rapidly frequency component while low frequency means a changing less rapidly frequency component. Specifically in video compression, after transform (e.g. DCT), DC is the component at the top-left position (0,0 position). Low frequencies are the components at the top-left corner and high frequencies are the components at the bottom-right corner.

Described another way, in Discrete Signal Processing (DSP), a block of N×M samples in spatial domain is often transformed into a block of N×M coefficients in transform domain. Each transform coefficient represents an energy at a certain frequency for the block. A block in a natural video picture often has more energy in low frequency and less energy in high frequency. That is why we often see big low frequency coefficients and small high frequency coefficients for a block in natural video picture.

Therefore, after quantization, many high frequency coefficients become 0, as explained in detail above. A well-designed entropy code often takes advantage of this characteristic of quantized transform coefficients. In some embodiments, we can assume the last non-zero quantized transform coefficient is specified in the sense of forward scan. This can be achieved using significant coefficient flags, as explained above in the discussion of FIG. 9.

If a forward scan is used, no further coding is needed along the scan path once the last non-zero quantized coefficient is encountered. On the other hand, if a reverse or backward scan is used, the coding may start with the last non-zero coefficient. The position information of the last non-zero coefficient on a specific (either forward or backward) scan can be coded using different methods. For example, a flag such as last_significant_coeff_flag, may be used to indicate whether a non-zero coefficient is the last or not. Alternatively, the coordinate of the last non-zero coefficient, last_significant_coeff_x and last_significant_coeff_y may be coded, as described in J. Sole, R. Joshi, M. Karczewicz, “CE11: Parallel Context Processing for the significance map in high coding efficiency,” JCTVC-E338, March 2011, incorporated herein by reference.

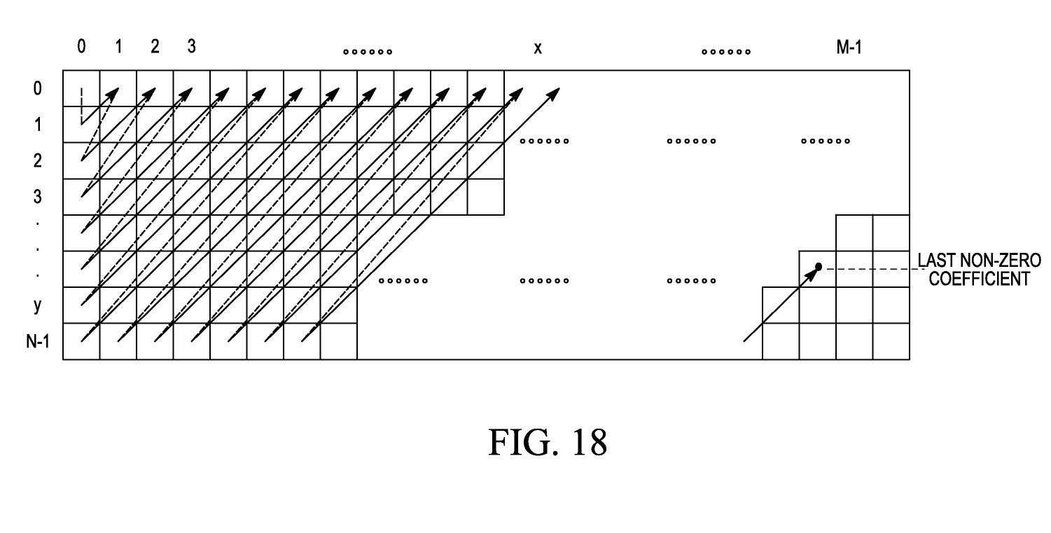

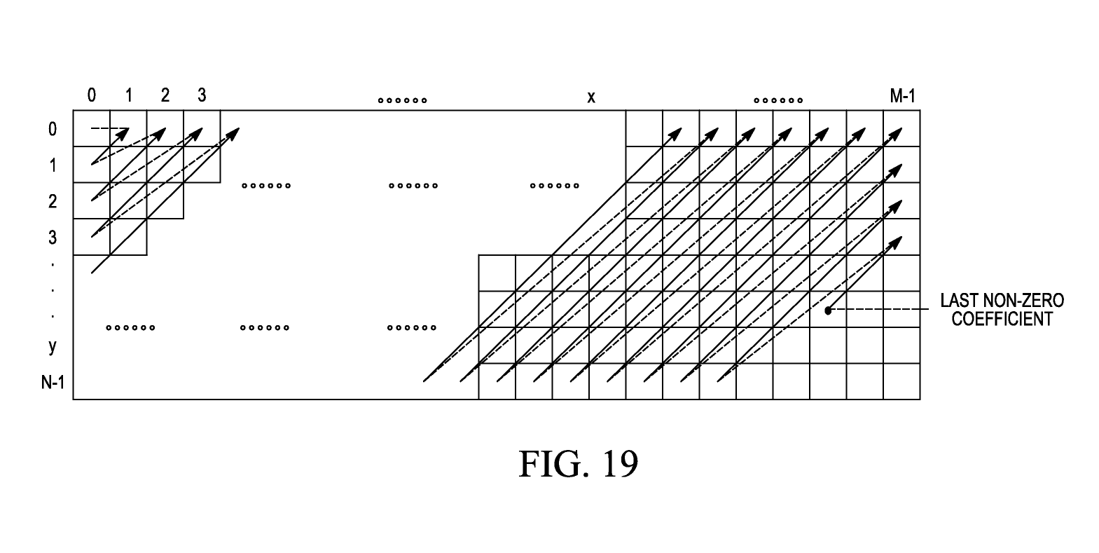

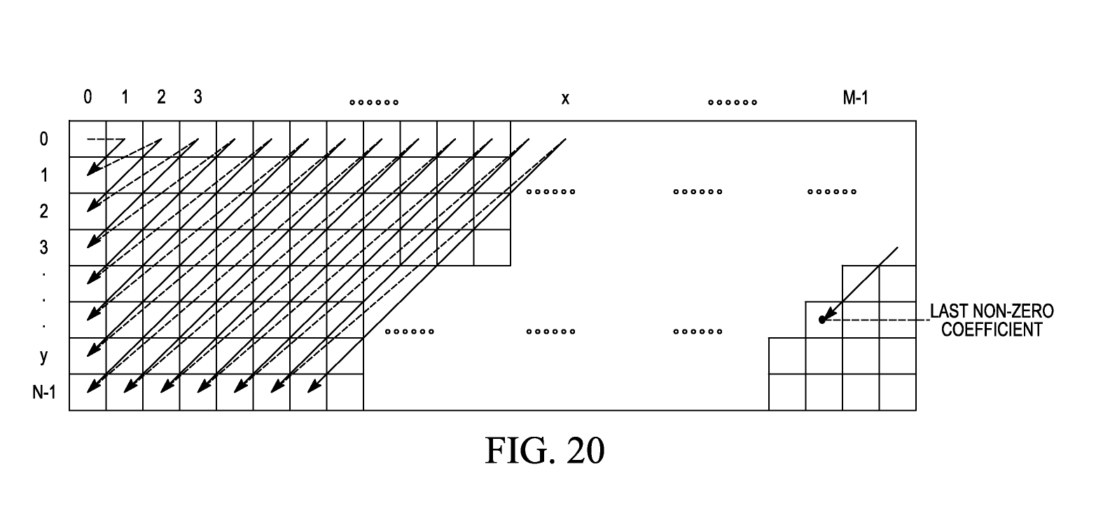

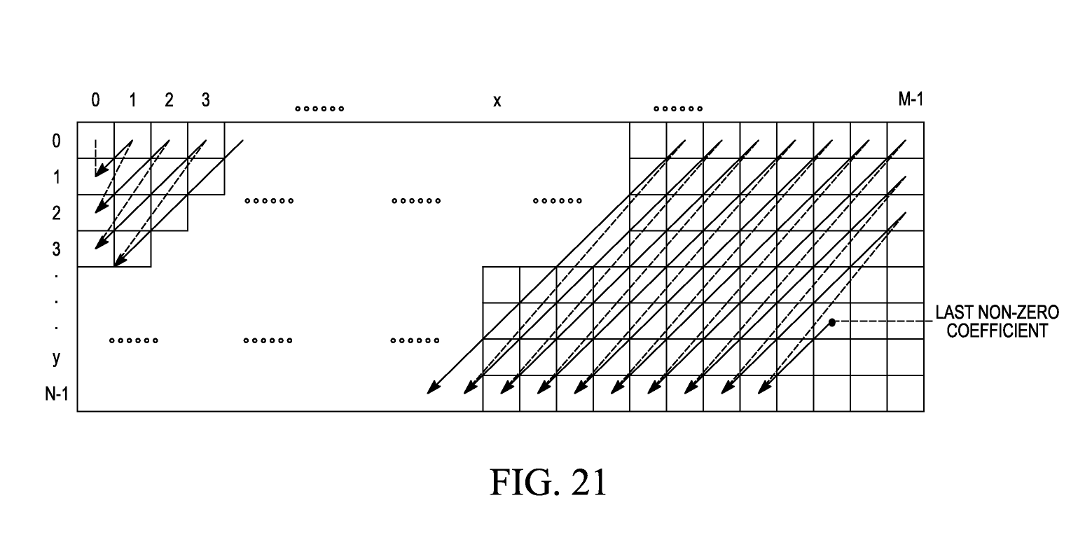

Four specific variations of rectangular-shaped wavefront scan that either terminate or begin at the last non-zero quantized transform coefficient are presented as follows. FIG. 18 illustrates an example of partial forward rectangular-shaped wavefront scan with a scan direction of 45°, where quantized transform coefficients on each scan line are processed from bottom-left to top-right. In this example, the process stops at the last non-zero quantized transform coefficient. FIG. 19 illustrates an example of partial reverse rectangular-shaped wavefront scan pattern with a scan direction of 45°, where quantized transform coefficients on each scan line are processed from bottom-left to top-right. In this example, the process starts from the last non-zero quantized transform coefficient. FIG. 20 illustrates an example of partial forward rectangular-shaped wavefront scan with a scan direction of −135°, where quantized transform coefficients on each scan line are processed from top-right to bottom-left. In this example, the process stops at the last non-zero quantized transform coefficient. FIG. 21 illustrates an example of partial reverse rectangular-shaped wavefront scan with a scan direction of −135°, where quantized transform coefficients on each scan line are processed from top-right to bottom-left. In this example, the process starts from the last non-zero quantized transform coefficient.

A comparison of FIGS. 14-17 and 18-21 reveal that the main difference is that FIGS. 18-21 only scan until or start scanning at the last non-zero quantized transform coefficient. Consequently, it should be appreciated that FIGS. 18-21 will generally have fewer coefficients to scan in and code, offering an improved efficiency (e.g., bit savings) over FIGS. 14-17.

Tables 1-12 are shown below that indicate mapping between scan index and coordinates of coefficients in a rectangular block of different sizes. In other examples, a block may have a size that is smaller or larger than the size of the blocks listed in Tables 1-12, and may include more or fewer quantized transform coefficients and corresponding block positions. In these examples, a scanning order associated with the block may scan the quantized transform coefficients of the block in a substantially similar manner as shown in the examples of rectangular blocks of FIGS. 14-17 and 18-21, e.g., the blocks may be scanned following any of the scanning orders previously described.

Example for Whole 8×2 Wavefront Scan Pattern

TABLE 1
Whole 8×2 wavefront scan pattern
Forward Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (0, 0) | (1, 0) | (0, 1) | (1, 1) | (0, 2) | (1, 2) | (0, 3) | (1, 3) |
| Scan Index | 8 | 9 | 10 | 11 | 12 | 13 | 14 | 15 |
| Position(y, x) | (0, 4) | (1, 4) | (0, 5) | (1, 5) | (0, 6) | (1, 6) | (0, 7) | (1, 7) |

Forward Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (0, 0) | (0, 1) | (1, 0) | (0, 2) | (1, 1) | (0, 3) | (1, 2) | (0, 4) |
| Scan Index | 8 | 9 | 10 | 11 | 12 | 13 | 14 | 15 |
| Position(y, x) | (1, 3) | (0, 5) | (1, 4) | (0, 6) | (1, 5) | (0, 7) | (1, 6) | (1, 7) |

Reverse Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (1, 7) | (1, 6) | (0, 7) | (1, 5) | (0, 6) | (1, 4) | (0, 5) | (1, 3) |
| Scan Index | 8 | 9 | 10 | 11 | 12 | 13 | 14 | 15 |
| Position(y, x) | (0, 4) | (1, 2) | (0, 3) | (1, 1) | (0, 2) | (1, 0) | (0, 1) | (0, 0) |

Reverse Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (1, 7) | (0, 7) | (1, 6) | (0, 6) | (1, 5) | (0, 5) | (1, 4) | (0, 4) |
| Scan Index | 8 | 9 | 10 | 11 | 12 | 13 | 14 | 15 |
| Position(y, x) | (1, 3) | (0, 3) | (1, 2) | (0, 2) | (1, 1) | (0, 1) | (1, 0) | (0, 0) |

Example for Whole 2×8 Wavefront Scan Pattern

TABLE 2
Whole 2×8 wavefront scan pattern
Forward Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (0, 0) | (1, 0) | (0, 1) | (2, 0) | (1, 1) | (3, 0) | (2, 1) | (4, 0) |
| Scan Index | 8 | 9 | 10 | 11 | 12 | 13 | 14 | 15 |
| Position(y, x) | (3, 1) | (5, 0) | (4, 1) | (6, 0) | (5, 1) | (7, 0) | (6, 1) | (7, 1) |

Forward Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (0, 0) | (0, 1) | (1, 0) | (1, 1) | (2, 0) | (2, 1) | (3, 0) | (3, 1) |
| Scan Index | 8 | 9 | 10 | 11 | 12 | 13 | 14 | 15 |
| Position(y, x) | (4, 0) | (4, 1) | (5, 0) | (5, 1) | (6, 0) | (6, 1) | (7, 0) | (7, 1) |

Reverse Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (7, 1) | (7, 0) | (6, 1) | (6, 0) | (5, 1) | (5, 0) | (4, 1) | (4, 0) |
| Scan Index | 8 | 9 | 10 | 11 | 12 | 13 | 14 | 15 |
| Position(y, x) | (3, 1) | (3, 0) | (2, 1) | (2, 0) | (1, 1) | (1, 0) | (0, 1) | (0, 0) |

Reverse Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (7, 1) | (6, 1) | (7, 0) | (5, 1) | (6, 0) | (4, 1) | (5, 0) | (3, 1) |
| Scan Index | 8 | 9 | 10 | 11 | 12 | 13 | 14 | 15 |
| Position(y, x) | (4, 0) | (2, 1) | (3, 0) | (1, 1) | (2, 0) | (0, 1) | (1, 0) | (0, 0) |

Example for Whole 8×4 Wavefront Scan Pattern

TABLE 3
Whole 8×4 wavefront scan pattern
Forward Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (0, 0) | (1, 0) | (0, 1) | (2, 0) | (1, 1) | (0, 2) | (3, 0) | (2, 1) |
| Scan Index | 8 | 9 | 10 | 11 | 12 | 13 | 14 | 15 |
| Position(y, x) | (1, 2) | (0, 3) | (3, 1) | (2, 2) | (1, 3) | (0, 4) | (3, 2) | (2, 3) |
| Scan Index | 16 | 17 | 18 | 19 | 20 | 21 | 22 | 23 |
| Position(y, x) | (1, 4) | (0, 5) | (3, 3) | (2, 4) | (1, 5) | (0, 6) | (3, 4) | (2, 5) |
| Scan Index | 24 | 25 | 26 | 27 | 28 | 29 | 30 | 31 |
| Position(y, x) | (1, 6) | (0, 7) | (3, 5) | (2, 6) | (1, 7) | (3, 6) | (2, 7) | (3, 7) |

Forward Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (0, 0) | (0, 1) | (1, 0) | (0, 2) | (1, 1) | (2, 0) | (0, 3) | (1, 2) |
| Scan Index | 8 | 9 | 10 | 11 | 12 | 13 | 14 | 15 |
| Position(y, x) | (2, 1) | (3, 0) | (0, 4) | (1, 3) | (2, 2) | (3, 1) | (0, 5) | (1, 4) |
| Scan Index | 16 | 17 | 18 | 19 | 20 | 21 | 22 | 23 |
| Position(y, x) | (2, 3) | (3, 2) | (0, 6) | (1, 5) | (2, 4) | (3, 3) | (0, 7) | (1, 6) |
| Scan Index | 24 | 25 | 26 | 27 | 28 | 29 | 30 | 31 |
| Position(y, x) | (2, 5) | (3, 4) | (1, 7) | (2, 6) | (3, 5) | (2, 7) | (3, 6) | (3, 7) |

Reverse Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (3, 7) | (3, 6) | (2, 7) | (3, 5) | (2, 6) | (1, 7) | (3, 4) | (2, 5) |
| Scan Index | 8 | 9 | 10 | 11 | 12 | 13 | 14 | 15 |
| Position(y, x) | (1, 6) | (0, 7) | (3, 3) | (2, 4) | (1, 5) | (0, 6) | (3, 2) | (2, 3) |
| Scan Index | 16 | 17 | 18 | 19 | 20 | 21 | 22 | 23 |
| Position(y, x) | (1, 4) | (0, 5) | (3, 1) | (2, 2) | (1, 3) | (0, 4) | (3, 0) | (2, 1) |
| Scan Index | 24 | 25 | 26 | 27 | 28 | 29 | 30 | 31 |
| Position(y, x) | (1, 2) | (0, 3) | (2, 0) | (1, 1) | (0, 2) | (1, 0) | (0, 1) | (0, 0) |

Reverse Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (3, 7) | (2, 7) | (3, 6) | (1, 7) | (2, 6) | (3, 5) | (0, 7) | (1, 6) |
| Scan Index | 8 | 9 | 10 | 11 | 12 | 13 | 14 | 15 |
| Position(y, x) | (2, 5) | (3, 4) | (0, 6) | (1, 5) | (2, 4) | (3, 3) | (0, 5) | (1, 4) |
| Scan Index | 16 | 17 | 18 | 19 | 20 | 21 | 22 | 23 |
| Position(y, x) | (2, 3) | (3, 2) | (0, 4) | (1, 3) | (2, 2) | (3, 1) | (0, 3) | (1, 2) |
| Scan Index | 24 | 25 | 26 | 27 | 28 | 29 | 30 | 31 |
| Position(y, x) | (2, 1) | (3, 0) | (0, 2) | (1, 1) | (2, 0) | (0, 1) | (1, 0) | (0, 0) |

Example for Whole 4×8 Wavefront Scan Pattern

TABLE 4
Whole 4×8 wavefront scan pattern
Forward Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (0, 0) | (1, 0) | (0, 1) | (2, 0) | (1, 1) | (0, 2) | (3, 0) | (2, 1) |
| Scan Index | 8 | 9 | 10 | 11 | 12 | 13 | 14 | 15 |
| Position(y, x) | (1, 2) | (0, 3) | (4, 0) | (3, 1) | (2, 2) | (1, 3) | (5, 0) | (4, 1) |
| Scan Index | 16 | 17 | 18 | 19 | 20 | 21 | 22 | 23 |
| Position(y, x) | (3, 2) | (2, 3) | (6, 0) | (5, 1) | (4, 2) | (3, 3) | (7, 0) | (6, 1) |
| Scan Index | 24 | 25 | 26 | 27 | 28 | 29 | 30 | 31 |
| Position(y, x) | (5, 2) | (4, 3) | (7, 1) | (6, 2) | (5, 3) | (7, 2) | (6, 3) | (7, 3) |

Forward Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (0, 0) | (0, 1) | (1, 0) | (0, 2) | (1, 1) | (2, 0) | (0, 3) | (1, 2) |
| Scan Index | 8 | 9 | 10 | 11 | 12 | 13 | 14 | 15 |
| Position(y, x) | (2, 1) | (3, 0) | (1, 3) | (2, 2) | (3, 1) | (4, 0) | (2, 3) | (3, 2) |
| Scan Index | 16 | 17 | 18 | 19 | 20 | 21 | 22 | 23 |
| Position(y, x) | (4, 1) | (5, 0) | (3, 3) | (4, 2) | (5, 1) | (6, 0) | (4, 3) | (5, 2) |
| Scan Index | 24 | 25 | 26 | 27 | 28 | 29 | 30 | 31 |
| Position(y, x) | (6, 1) | (7, 0) | (5, 3) | (6, 2) | (7, 1) | (6, 3) | (7, 2) | (7, 3) |

Reverse Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (7, 3) | (7, 2) | (6, 3) | (7, 1) | (6, 2) | (5, 3) | (7, 0) | (6, 1) |
| Scan Index | 8 | 9 | 10 | 11 | 12 | 13 | 14 | 15 |
| Position(y, x) | (5, 2) | (4, 3) | (6, 0) | (5, 1) | (4, 2) | (3, 3) | (5, 0) | (4, 1) |
| Scan Index | 16 | 17 | 18 | 19 | 20 | 21 | 22 | 23 |
| Position(y, x) | (3, 2) | (2, 3) | (4, 0) | (3, 1) | (2, 2) | (1, 3) | (3, 0) | (2, 1) |
| Scan Index | 24 | 25 | 26 | 27 | 28 | 29 | 30 | 31 |
| Position(y, x) | (1, 2) | (0, 3) | (2, 0) | (1, 1) | (0, 2) | (1, 0) | (0, 1) | (0, 0) |

Reverse Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (7, 3) | (6, 3) | (7, 2) | (5, 3) | (6, 2) | (7, 1) | (4, 3) | (5, 2) |
| Scan Index | 8 | 9 | 10 | 11 | 12 | 13 | 14 | 15 |
| Position(y, x) | (6, 1) | (7, 0) | (3, 3) | (4, 2) | (5, 1) | (6, 0) | (2, 3) | (3, 2) |
| Scan Index | 16 | 17 | 18 | 19 | 20 | 21 | 22 | 23 |
| Position(y, x) | (4, 1) | (5, 0) | (1, 3) | (2, 2) | (3, 1) | (4, 0) | (0, 3) | (1, 2) |
| Scan Index | 24 | 25 | 26 | 27 | 28 | 29 | 30 | 31 |
| Position(y, x) | (2, 1) | (3, 0) | (0, 2) | (1, 1) | (2, 0) | (0, 1) | (1, 0) | (0, 0) |

Example for Whole 16×4 Wavefront Scan Pattern

TABLE 5
Whole 16×4 wavefront scan pattern
Forward Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (0, 0) | (1, 0) | (0, 1) | (2, 0) | (1, 1) | (0, 2) | (3, 0) | (2, 1) |
| Scan Index | 8 | 9 | 10 | 11 | 12 | 13 | 14 | 15 |
| Position(y, x) | (1, 2) | (0, 3) | (3, 1) | (2, 2) | (1, 3) | (0, 4) | (3, 2) | (2, 3) |
| Scan Index | 16 | 17 | 18 | 19 | 20 | 21 | 22 | 23 |
| Position(y, x) | (1, 4) | (0, 5) | (3, 3) | (2, 4) | (1, 5) | (0, 6) | (3, 4) | (2, 5) |
| Scan Index | 24 | 25 | 26 | 27 | 28 | 29 | 30 | 31 |
| Position(y, x) | (1, 6) | (0, 7) | (3, 5) | (2, 6) | (1, 7) | (0, 8) | (3, 6) | (2, 7) |
| Scan Index | 32 | 33 | 34 | 35 | 36 | 37 | 38 | 39 |
| Position(y, x) | (1, 8) | (0, 9) | (3, 7) | (2, 8) | (1, 9) | (0, 10) | (3, 8) | (2, 9) |
| Scan Index | 40 | 41 | 42 | 43 | 44 | 45 | 46 | 47 |
| Position(y, x) | (1, 10) | (0, 11) | (3, 9) | (2, 10) | (1, 11) | (0, 12) | (3, 10) | (2, 11) |
| Scan Index | 48 | 49 | 50 | 51 | 52 | 53 | 54 | 55 |
| Position(y, x) | (1, 12) | (0, 13) | (3, 11) | (2, 12) | (1, 13) | (0, 14) | (3, 12) | (2, 13) |
| Scan Index | 56 | 57 | 58 | 59 | 60 | 61 | 62 | 63 |
| Position(y, x) | (1, 14) | (0, 15) | (3, 13) | (2, 14) | (1, 15) | (3, 14) | (2, 15) | (3, 15) |

Forward Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (0, 0) | (0, 1) | (1, 0) | (0, 2) | (1, 1) | (2, 0) | (0, 3) | (1, 2) |
| Scan Index | 8 | 9 | 10 | 11 | 12 | 13 | 14 | 15 |
| Position(y, x) | (2, 1) | (3, 0) | (0, 4) | (1, 3) | (2, 2) | (3, 1) | (0, 5) | (1, 4) |
| Scan Index | 16 | 17 | 18 | 19 | 20 | 21 | 22 | 23 |
| Position(y, x) | (2, 3) | (3, 2) | (0, 6) | (1, 5) | (2, 4) | (3, 3) | (0, 7) | (1, 6) |
| Scan Index | 24 | 25 | 26 | 27 | 28 | 29 | 30 | 31 |
| Position(y, x) | (2, 5) | (3, 4) | (0, 8) | (1, 7) | (2, 6) | (3, 5) | (0, 9) | (1, 8) |
| Scan Index | 32 | 33 | 34 | 35 | 36 | 37 | 38 | 39 |
| Position(y, x) | (2, 7) | (3, 6) | (0, 10) | (1, 9) | (2, 8) | (3, 7) | (0, 11) | (1, 10) |
| Scan Index | 40 | 41 | 42 | 43 | 44 | 45 | 46 | 47 |
| Position(y, x) | (2, 9) | (3, 8) | (0, 12) | (1, 11) | (2, 10) | (3, 9) | (0, 13) | (1, 12) |
| Scan Index | 48 | 49 | 50 | 51 | 52 | 53 | 54 | 55 |
| Position(y, x) | (2, 11) | (3, 10) | (0, 14) | (1, 13) | (2, 12) | (3, 11) | (0, 15) | (1, 14) |
| Scan Index | 56 | 57 | 58 | 59 | 60 | 61 | 62 | 63 |
| Position(y, x) | (2, 13) | (3, 12) | (1, 15) | (2, 14) | (3, 13) | (2, 15) | (3, 14) | (3, 15) |

Reverse Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (3, 15) | (3, 14) | (2, 15) | (3, 13) | (2, 14) | (1, 15) | (3, 12) | (2, 13) |
| Scan Index | 8 | 9 | 10 | 11 | 12 | 13 | 14 | 15 |
| Position(y, x) | (1, 14) | (0, 15) | (3, 11) | (2, 12) | (1, 13) | (0, 14) | (3, 10) | (2, 11) |
| Scan Index | 16 | 17 | 18 | 19 | 20 | 21 | 22 | 23 |
| Position(y, x) | (1, 12) | (0, 13) | (3, 9) | (2, 10) | (1, 11) | (0, 12) | (3, 8) | (2, 9) |
| Scan Index | 24 | 25 | 26 | 27 | 28 | 29 | 30 | 31 |
| Position(y, x) | (1, 10) | (0, 11) | (3, 7) | (2, 8) | (1, 9) | (0, 10) | (3, 6) | (2, 7) |
| Scan Index | 32 | 33 | 34 | 35 | 36 | 37 | 38 | 39 |
| Position(y, x) | (1, 8) | (0, 9) | (3, 5) | (2, 6) | (1, 7) | (0, 8) | (3, 4) | (2, 5) |
| Scan Index | 40 | 41 | 42 | 43 | 44 | 45 | 46 | 47 |
| Position(y, x) | (1, 6) | (0, 7) | (3, 3) | (2, 4) | (1, 5) | (0, 6) | (3, 2) | (2, 3) |
| Scan Index | 48 | 49 | 50 | 51 | 52 | 53 | 54 | 55 |
| Position(y, x) | (1, 4) | (0, 5) | (3, 1) | (2, 2) | (1, 3) | (0, 4) | (3, 0) | (2, 1) |
| Scan Index | 56 | 57 | 58 | 59 | 60 | 61 | 62 | 63 |
| Position(y, x) | (1, 2) | (0, 3) | (2, 0) | (1, 1) | (0, 2) | (1, 0) | (0, 1) | (0, 0) |

Reverse Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (3, 15) | (2, 15) | (3, 14) | (1, 15) | (2, 14) | (3, 13) | (0, 15) | (1, 14) |
| Scan Index | 8 | 9 | 10 | 11 | 12 | 13 | 14 | 15 |
| Position(y, x) | (2, 13) | (3, 12) | (0, 14) | (1, 13) | (2, 12) | (3, 11) | (0, 13) | (1, 12) |
| Scan Index | 16 | 17 | 18 | 19 | 20 | 21 | 22 | 23 |
| Position(y, x) | (2, 11) | (3, 10) | (0, 12) | (1, 11) | (2, 10) | (3, 9) | (0, 11) | (1, 10) |
| Scan Index | 24 | 25 | 26 | 27 | 28 | 29 | 30 | 31 |
| Position(y, x) | (2, 9) | (3, 8) | (0, 10) | (1, 9) | (2, 8) | (3, 7) | (0, 9) | (1, 8) |
| Scan Index | 32 | 33 | 34 | 35 | 36 | 37 | 38 | 39 |
| Position(y, x) | (2, 7) | (3, 6) | (0, 8) | (1, 7) | (2, 6) | (3, 5) | (0, 7) | (1, 6) |
| Scan Index | 40 | 41 | 42 | 43 | 44 | 45 | 46 | 47 |
| Position(y, x) | (2, 5) | (3, 4) | (0, 6) | (1, 5) | (2, 4) | (3, 3) | (0, 5) | (1, 4) |
| Scan Index | 48 | 49 | 50 | 51 | 52 | 53 | 54 | 55 |
| Position(y, x) | (2, 3) | (3, 2) | (0, 4) | (1, 3) | (2, 2) | (3, 1) | (0, 3) | (1, 2) |
| Scan Index | 56 | 57 | 58 | 59 | 60 | 61 | 62 | 63 |
| Position(y, x) | (2, 1) | (3, 0) | (0, 2) | (1, 1) | (2, 0) | (0, 1) | (1, 0) | (0, 0) |

Example for Whole 4×16 Wavefront Scan Pattern

TABLE 6
Whole 4×16 wavefront scan pattern
Forward Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (0, 0) | (1, 0) | (0, 1) | (2, 0) | (1, 1) | (0, 2) | (3, 0) | (2, 1) |
| Scan Index | 8 | 9 | 10 | 11 | 12 | 13 | 14 | 15 |
| Position(y, x) | (1, 2) | (0, 3) | (4, 0) | (3, 1) | (2, 2) | (1, 3) | (5, 0) | (4, 1) |
| Scan Index | 16 | 17 | 18 | 19 | 20 | 21 | 22 | 23 |
| Position(y, x) | (3, 2) | (2, 3) | (6, 0) | (5, 1) | (4, 2) | (3, 3) | (7, 0) | (6, 1) |
| Scan Index | 24 | 25 | 26 | 27 | 28 | 29 | 30 | 31 |
| Position(y, x) | (5, 2) | (4, 3) | (8, 0) | (7, 1) | (6, 2) | (5, 3) | (9, 0) | (8, 1) |
| Scan Index | 32 | 33 | 34 | 35 | 36 | 37 | 38 | 39 |
| Position(y, x) | (7, 2) | (6, 3) | (10, 0) | (9, 1) | (8, 2) | (7, 3) | (11, 0) | (10, 1) |
| Scan Index | 40 | 41 | 42 | 43 | 44 | 45 | 46 | 47 |
| Position(y, x) | (9, 2) | (8, 3) | (12, 0) | (11, 1) | (10, 2) | (9, 3) | (13, 0) | (12, 1) |
| Scan Index | 48 | 49 | 50 | 51 | 52 | 53 | 54 | 55 |
| Position(y, x) | (11, 2) | (10, 3) | (14, 0) | (13, 1) | (12, 2) | (11, 3) | (15, 0) | (14, 1) |
| Scan Index | 56 | 57 | 58 | 59 | 60 | 61 | 62 | 63 |
| Position(y, x) | (13, 2) | (12, 3) | (15, 1) | (14, 2) | (13, 3) | (15, 2) | (14, 3) | (15, 3) |

Forward Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (0, 0) | (0, 1) | (1, 0) | (0, 2) | (1, 1) | (2, 0) | (0, 3) | (1, 2) |
| Scan Index | 8 | 9 | 10 | 11 | 12 | 13 | 14 | 15 |
| Position(y, x) | (2, 1) | (3, 0) | (1, 3) | (2, 2) | (3, 1) | (4, 0) | (2, 3) | (3, 2) |
| Scan Index | 16 | 17 | 18 | 19 | 20 | 21 | 22 | 23 |
| Position(y, x) | (4, 1) | (5, 0) | (3, 3) | (4, 2) | (5, 1) | (6, 0) | (4, 3) | (5, 2) |
| Scan Index | 24 | 25 | 26 | 27 | 28 | 29 | 30 | 31 |
| Position(y, x) | (6, 1) | (7, 0) | (5, 3) | (6, 2) | (7, 1) | (8, 0) | (6, 3) | (7, 2) |
| Scan Index | 32 | 33 | 34 | 35 | 36 | 37 | 38 | 39 |
| Position(y, x) | (8, 1) | (9, 0) | (7, 3) | (8, 2) | (9, 1) | (10, 0) | (8, 3) | (9, 2) |
| Scan Index | 40 | 41 | 42 | 43 | 44 | 45 | 46 | 47 |
| Position(y, x) | (10, 1) | (11, 0) | (9, 3) | (10, 2) | (11, 1) | (12, 0) | (10, 3) | (11, 2) |
| Scan Index | 48 | 49 | 50 | 51 | 52 | 53 | 54 | 55 |
| Position(y, x) | (12, 1) | (13, 0) | (11, 3) | (12, 2) | (13, 1) | (14, 0) | (12, 3) | (13, 2) |
| Scan Index | 56 | 57 | 58 | 59 | 60 | 61 | 62 | 63 |
| Position(y, x) | (14, 1) | (15, 0) | (13, 3) | (14, 2) | (15, 1) | (14, 3) | (15, 2) | (15, 3) |

Reverse Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (15, 3) | (15, 2) | (14, 3) | (15, 1) | (14, 2) | (13, 3) | (15, 0) | (14, 1) |
| Scan Index | 8 | 9 | 10 | 11 | 12 | 13 | 14 | 15 |
| Position(y, x) | (13, 2) | (12, 3) | (14, 0) | (13, 1) | (12, 2) | (11, 3) | (13, 0) | (12, 1) |
| Scan Index | 16 | 17 | 18 | 19 | 20 | 21 | 22 | 23 |
| Position(y, x) | (11, 2) | (10, 3) | (12, 0) | (11, 1) | (10, 2) | (9, 3) | (11, 0) | (10, 1) |
| Scan Index | 24 | 25 | 26 | 27 | 28 | 29 | 30 | 31 |
| Position(y, x) | (9, 2) | (8, 3) | (10, 0) | (9, 1) | (8, 2) | (7, 3) | (9, 0) | (8, 1) |
| Scan Index | 32 | 33 | 34 | 35 | 36 | 37 | 38 | 39 |
| Position(y, x) | (7, 2) | (6, 3) | (8, 0) | (7, 1) | (6, 2) | (5, 3) | (7, 0) | (6, 1) |
| Scan Index | 40 | 41 | 42 | 43 | 44 | 45 | 46 | 47 |
| Position(y, x) | (5, 2) | (4, 3) | (6, 0) | (5, 1) | (4, 2) | (3, 3) | (5, 0) | (4, 1) |
| Scan Index | 48 | 49 | 50 | 51 | 52 | 53 | 54 | 55 |
| Position(y, x) | (3, 2) | (2, 3) | (4, 0) | (3, 1) | (2, 2) | (1, 3) | (3, 0) | (2, 1) |
| Scan Index | 56 | 57 | 58 | 59 | 60 | 61 | 62 | 63 |
| Position(y, x) | (1, 2) | (0, 3) | (2, 0) | (1, 1) | (0, 2) | (1, 0) | (0, 1) | (0, 0) |

Reverse Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (15, 3) | (14, 3) | (15, 2) | (13, 3) | (14, 2) | (15, 1) | (12, 3) | (13, 2) |
| Scan Index | 8 | 9 | 10 | 11 | 12 | 13 | 14 | 15 |
| Position(y, x) | (14, 1) | (15, 0) | (11, 3) | (12, 2) | (13, 1) | (14, 0) | (10, 3) | (11, 2) |
| Scan Index | 16 | 17 | 18 | 19 | 20 | 21 | 22 | 23 |
| Position(y, x) | (12, 1) | (13, 0) | (9, 3) | (10, 2) | (11, 1) | (12, 0) | (8, 3) | (9, 2) |
| Scan Index | 24 | 25 | 26 | 27 | 28 | 29 | 30 | 31 |
| Position(y, x) | (10, 1) | (11, 0) | (7, 3) | (8, 2) | (9, 1) | (10, 0) | (6, 3) | (7, 2) |
| Scan Index | 32 | 33 | 34 | 35 | 36 | 37 | 38 | 39 |
| Position(y, x) | (8, 1) | (9, 0) | (5, 3) | (6, 2) | (7, 1) | (8, 0) | (4, 3) | (5, 2) |
| Scan Index | 40 | 41 | 42 | 43 | 44 | 45 | 46 | 47 |
| Position(y, x) | (6, 1) | (7, 0) | (3, 3) | (4, 2) | (5, 1) | (6, 0) | (2, 3) | (3, 2) |
| Scan Index | 48 | 49 | 50 | 51 | 52 | 53 | 54 | 55 |
| Position(y, x) | (4, 1) | (5, 0) | (1, 3) | (2, 2) | (3, 1) | (4, 0) | (0, 3) | (1, 2) |
| Scan Index | 56 | 57 | 58 | 59 | 60 | 61 | 62 | 63 |
| Position(y, x) | (2, 1) | (3, 0) | (0, 2) | (1, 1) | (2, 0) | (0, 1) | (1, 0) | (0, 0) |

Example for Whole 16×8 Wavefront Scan Pattern

TABLE 7
Whole 16×8 wavefront scan pattern
Forward Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (0, 0) | (1, 0) | (0, 1) | (2, 0) | (1, 1) | (0, 2) | (3, 0) | (2, 1) |
| Scan Index | 8 | 9 | 10 | 11 | 12 | 13 | 14 | 15 |
| Position(y, x) | (1, 2) | (0, 3) | (4, 0) | (3, 1) | (2, 2) | (1, 3) | (0, 4) | (5, 0) |
| Scan Index | 16 | 17 | 18 | 19 | 20 | 21 | 22 | 23 |
| Position(y, x) | (4, 1) | (3, 2) | (2, 3) | (1, 4) | (0, 5) | (6, 0) | (5, 1) | (4, 2) |
| Scan Index | 24 | 25 | 26 | 27 | 28 | 29 | 30 | 31 |
| Position(y, x) | (3, 3) | (2, 4) | (1, 5) | (0, 6) | (7, 0) | (6, 1) | (5, 2) | (4, 3) |
| Scan Index | 32 | 33 | 34 | 35 | 36 | 37 | 38 | 39 |
| Position(y, x) | (3, 4) | (2, 5) | (1, 6) | (0, 7) | (7, 1) | (6, 2) | (5, 3) | (4, 4) |
| Scan Index | 40 | 41 | 42 | 43 | 44 | 45 | 46 | 47 |
| Position(y, x) | (3, 5) | (2, 6) | (1, 7) | (0, 8) | (7, 2) | (6, 3) | (5, 4) | (4, 5) |
| Scan Index | 48 | 49 | 50 | 51 | 52 | 53 | 54 | 55 |
| Position(y, x) | (3, 6) | (2, 7) | (1, 8) | (0, 9) | (7, 3) | (6, 4) | (5, 5) | (4, 6) |
| Scan Index | 56 | 57 | 58 | 59 | 60 | 61 | 62 | 63 |
| Position(y, x) | (3, 7) | (2, 8) | (1, 9) | (0, 10) | (7, 4) | (6, 5) | (5, 6) | (4, 7) |
| Scan Index | 64 | 65 | 66 | 67 | 68 | 69 | 70 | 71 |
| Position(y, x) | (3, 8) | (2, 9) | (1, 10) | (0, 11) | (7, 5) | (6, 6) | (5, 7) | (4, 8) |
| Scan Index | 72 | 73 | 74 | 75 | 76 | 77 | 78 | 79 |
| Position(y, x) | (3, 9) | (2, 10) | (1, 11) | (0, 12) | (7, 6) | (6, 7) | (5, 8) | (4, 9) |
| Scan Index | 80 | 81 | 82 | 83 | 84 | 85 | 86 | 87 |
| Position(y, x) | (3, 10) | (2, 11) | (1, 12) | (0, 13) | (7, 7) | (6, 8) | (5, 9) | (4, 10) |
| Scan Index | 88 | 89 | 90 | 91 | 92 | 93 | 94 | 95 |
| Position(y, x) | (3, 11) | (2, 12) | (1, 13) | (0, 14) | (7, 8) | (6, 9) | (5, 10) | (4, 11) |
| Scan Index | 96 | 97 | 98 | 99 | 100 | 101 | 102 | 103 |
| Position(y, x) | (3, 12) | (2, 13) | (1, 14) | (0, 15) | (7, 9) | (6, 10) | (5, 11) | (4, 12) |
| Scan Index | 104 | 105 | 106 | 107 | 108 | 109 | 110 | 111 |
| Position(y, x) | (3, 13) | (2, 14) | (1, 15) | (7, 10) | (6, 11) | (5, 12) | (4, 13) | (3, 14) |
| Scan Index | 112 | 113 | 114 | 115 | 116 | 117 | 118 | 119 |
| Position(y, x) | (2, 15) | (7, 11) | (6, 12) | (5, 13) | (4, 14) | (3, 15) | (7, 12) | (6, 13) |
| Scan Index | 120 | 121 | 122 | 123 | 124 | 125 | 126 | 127 |
| Position(y, x) | (5, 14) | (4, 15) | (7, 13) | (6, 14) | (5, 15) | (7, 14) | (6, 15) | (7, 15) |

Forward Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (0, 0) | (0, 1) | (1, 0) | (0, 2) | (1, 1) | (2, 0) | (0, 3) | (1, 2) |
| Scan Index | 8 | 9 | 10 | 11 | 12 | 13 | 14 | 15 |
| Position(y, x) | (2, 1) | (3, 0) | (0, 4) | (1, 3) | (2, 2) | (3, 1) | (4, 0) | (0, 5) |
| Scan Index | 16 | 17 | 18 | 19 | 20 | 21 | 22 | 23 |
| Position(y, x) | (1, 4) | (2, 3) | (3, 2) | (4, 1) | (5, 0) | (0, 6) | (1, 5) | (2, 4) |
| Scan Index | 24 | 25 | 26 | 27 | 28 | 29 | 30 | 31 |
| Position(y, x) | (3, 3) | (4, 2) | (5, 1) | (6, 0) | (0, 7) | (1, 6) | (2, 5) | (3, 4) |
| Scan Index | 32 | 33 | 34 | 35 | 36 | 37 | 38 | 39 |
| Position(y, x) | (4, 3) | (5, 2) | (6, 1) | (7, 0) | (0, 8) | (1, 7) | (2, 6) | (3, 5) |
| Scan Index | 40 | 41 | 42 | 43 | 44 | 45 | 46 | 47 |
| Position(y, x) | (4, 4) | (5, 3) | (6, 2) | (7, 1) | (0, 9) | (1, 8) | (2, 7) | (3, 6) |
| Scan Index | 48 | 49 | 50 | 51 | 52 | 53 | 54 | 55 |
| Position(y, x) | (4, 5) | (5, 4) | (6, 3) | (7, 2) | (0, 10) | (1, 9) | (2, 8) | (3, 7) |
| Scan Index | 56 | 57 | 58 | 59 | 60 | 61 | 62 | 63 |
| Position(y, x) | (4, 6) | (5, 5) | (6, 4) | (7, 3) | (0, 11) | (1, 10) | (2, 9) | (3, 8) |
| Scan Index | 64 | 65 | 66 | 67 | 68 | 69 | 70 | 71 |
| Position(y, x) | (4, 7) | (5, 6) | (6, 5) | (7, 4) | (0, 12) | (1, 11) | (2, 10) | (3, 9) |
| Scan Index | 72 | 73 | 74 | 75 | 76 | 77 | 78 | 79 |
| Position(y, x) | (4, 8) | (5, 7) | (6, 6) | (7, 5) | (0, 13) | (1, 12) | (2, 11) | (3, 10) |
| Scan Index | 80 | 81 | 82 | 83 | 84 | 85 | 86 | 87 |
| Position(y, x) | (4, 9) | (5, 8) | (6, 7) | (7, 6) | (0, 14) | (1, 13) | (2, 12) | (3, 11) |
| Scan Index | 88 | 89 | 90 | 91 | 92 | 93 | 94 | 95 |
| Position(y, x) | (4, 10) | (5, 9) | (6, 8) | (7, 7) | (0, 15) | (1, 14) | (2, 13) | (3, 12) |
| Scan Index | 96 | 97 | 98 | 99 | 100 | 101 | 102 | 103 |
| Position(y, x) | (4, 11) | (5, 10) | (6, 9) | (7, 8) | (1, 15) | (2, 14) | (3, 13) | (4, 12) |
| Scan Index | 104 | 105 | 106 | 107 | 108 | 109 | 110 | 111 |
| Position(y, x) | (5, 11) | (6, 10) | (7, 9) | (2, 15) | (3, 14) | (4, 13) | (5, 12) | (6, 11) |
| Scan Index | 112 | 113 | 114 | 115 | 116 | 117 | 118 | 119 |
| Position(y, x) | (7, 10) | (3, 15) | (4, 14) | (5, 13) | (6, 12) | (7, 11) | (4, 15) | (5, 14) |
| Scan Index | 120 | 121 | 122 | 123 | 124 | 125 | 126 | 127 |
| Position(y, x) | (6, 13) | (7, 12) | (5, 15) | (6, 14) | (7, 13) | (6, 15) | (7, 14) | (7, 15) |

Reverse Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (7, 15) | (7, 14) | (6, 15) | (7, 13) | (6, 14) | (5, 15) | (7, 12) | (6, 13) |
| Scan Index | 8 | 9 | 10 | 11 | 12 | 13 | 14 | 15 |
| Position(y, x) | (5, 14) | (4, 15) | (7, 11) | (6, 12) | (5, 13) | (4, 14) | (3, 15) | (7, 10) |
| Scan Index | 16 | 17 | 18 | 19 | 20 | 21 | 22 | 23 |
| Position(y, x) | (6, 11) | (5, 12) | (4, 13) | (3, 14) | (2, 15) | (7, 9) | (6, 10) | (5, 11) |
| Scan Index | 24 | 25 | 26 | 27 | 28 | 29 | 30 | 31 |
| Position(y, x) | (4, 12) | (3, 13) | (2, 14) | (1, 15) | (7, 8) | (6, 9) | (5, 10) | (4, 11) |
| Scan Index | 32 | 33 | 34 | 35 | 36 | 37 | 38 | 39 |
| Position(y, x) | (3, 12) | (2, 13) | (1, 14) | (0, 15) | (7, 7) | (6, 8) | (5, 9) | (4, 10) |
| Scan Index | 40 | 41 | 42 | 43 | 44 | 45 | 46 | 47 |
| Position(y, x) | (3, 11) | (2, 12) | (1, 13) | (0, 14) | (7, 6) | (6, 7) | (5, 8) | (4, 9) |
| Scan Index | 48 | 49 | 50 | 51 | 52 | 53 | 54 | 55 |
| Position(y, x) | (3, 10) | (2, 11) | (1, 12) | (0, 13) | (7, 5) | (6, 6) | (5, 7) | (4, 8) |
| Scan Index | 56 | 57 | 58 | 59 | 60 | 61 | 62 | 63 |
| Position(y, x) | (3, 9) | (2, 10) | (1, 11) | (0, 12) | (7, 4) | (6, 5) | (5, 6) | (4, 7) |
| Scan Index | 64 | 65 | 66 | 67 | 68 | 69 | 70 | 71 |
| Position(y, x) | (3, 8) | (2, 9) | (1, 10) | (0, 11) | (7, 3) | (6, 4) | (5, 5) | (4, 6) |
| Scan Index | 72 | 73 | 74 | 75 | 76 | 77 | 78 | 79 |
| Position(y, x) | (3, 7) | (2, 8) | (1, 9) | (0, 10) | (7, 2) | (6, 3) | (5, 4) | (4, 5) |
| Scan Index | 80 | 81 | 82 | 83 | 84 | 85 | 86 | 87 |
| Position(y, x) | (3, 6) | (2, 7) | (1, 8) | (0, 9) | (7, 1) | (6, 2) | (5, 3) | (4, 4) |
| Scan Index | 88 | 89 | 90 | 91 | 92 | 93 | 94 | 95 |
| Position(y, x) | (3, 5) | (2, 6) | (1, 7) | (0, 8) | (7, 0) | (6, 1) | (5, 2) | (4, 3) |
| Scan Index | 96 | 97 | 98 | 99 | 100 | 101 | 102 | 103 |
| Position(y, x) | (3, 4) | (2, 5) | (1, 6) | (0, 7) | (6, 0) | (5, 1) | (4, 2) | (3, 3) |
| Scan Index | 104 | 105 | 106 | 107 | 108 | 109 | 110 | 111 |
| Position(y, x) | (2, 4) | (1, 5) | (0, 6) | (5, 0) | (4, 1) | (3, 2) | (2, 3) | (1, 4) |
| Scan Index | 112 | 113 | 114 | 115 | 116 | 117 | 118 | 119 |
| Position(y, x) | (0, 5) | (4, 0) | (3, 1) | (2, 2) | (1, 3) | (0, 4) | (3, 0) | (2, 1) |
| Scan Index | 120 | 121 | 122 | 123 | 124 | 125 | 126 | 127 |
| Position(y, x) | (1, 2) | (0, 3) | (2, 0) | (1, 1) | (0, 2) | (1, 0) | (0, 1) | (0, 0) |

Reverse Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (7, 15) | (6, 15) | (7, 14) | (5, 15) | (6, 14) | (7, 13) | (4, 15) | (5, 14) |
| Scan Index | 8 | 9 | 10 | 11 | 12 | 13 | 14 | 15 |
| Position(y, x) | (6, 13) | (7, 12) | (3, 15) | (4, 14) | (5, 13) | (6, 12) | (7, 11) | (2, 15) |
| Scan Index | 16 | 17 | 18 | 19 | 20 | 21 | 22 | 23 |
| Position(y, x) | (3, 14) | (4, 13) | (5, 12) | (6, 11) | (7, 10) | (1, 15) | (2, 14) | (3, 13) |
| Scan Index | 24 | 25 | 26 | 27 | 28 | 29 | 30 | 31 |
| Position(y, x) | (4, 12) | (5, 11) | (6, 10) | (7, 9) | (0, 15) | (1, 14) | (2, 13) | (3, 12) |
| Scan Index | 32 | 33 | 34 | 35 | 36 | 37 | 38 | 39 |
| Position(y, x) | (4, 11) | (5, 10) | (6, 9) | (7, 8) | (0, 14) | (1, 13) | (2, 12) | (3, 11) |
| Scan Index | 40 | 41 | 42 | 43 | 44 | 45 | 46 | 47 |
| Position(y, x) | (4, 10) | (5, 9) | (6, 8) | (7, 7) | (0, 13) | (1, 12) | (2, 11) | (3, 10) |
| Scan Index | 48 | 49 | 50 | 51 | 52 | 53 | 54 | 55 |
| Position(y, x) | (4, 9) | (5, 8) | (6, 7) | (7, 6) | (0, 12) | (1, 11) | (2, 10) | (3, 9) |
| Scan Index | 56 | 57 | 58 | 59 | 60 | 61 | 62 | 63 |
| Position(y, x) | (4, 8) | (5, 7) | (6, 6) | (7, 5) | (0, 11) | (1, 10) | (2, 9) | (3, 8) |
| Scan Index | 64 | 65 | 66 | 67 | 68 | 69 | 70 | 71 |
| Position(y, x) | (4, 7) | (5, 6) | (6, 5) | (7, 4) | (0, 10) | (1, 9) | (2, 8) | (3, 7) |
| Scan Index | 72 | 73 | 74 | 75 | 76 | 77 | 78 | 79 |
| Position(y, x) | (4, 6) | (5, 5) | (6, 4) | (7, 3) | (0, 9) | (1, 8) | (2, 7) | (3, 6) |
| Scan Index | 80 | 81 | 82 | 83 | 84 | 85 | 86 | 87 |
| Position(y, x) | (4, 5) | (5, 4) | (6, 3) | (7, 2) | (0, 8) | (1, 7) | (2, 6) | (3, 5) |
| Scan Index | 88 | 89 | 90 | 91 | 92 | 93 | 94 | 95 |
| Position(y, x) | (4, 4) | (5, 3) | (6, 2) | (7, 1) | (0, 7) | (1, 6) | (2, 5) | (3, 4) |
| Scan Index | 96 | 97 | 98 | 99 | 100 | 101 | 102 | 103 |
| Position(y, x) | (4, 3) | (5, 2) | (6, 1) | (7, 0) | (0, 6) | (1, 5) | (2, 4) | (3, 3) |
| Scan Index | 104 | 105 | 106 | 107 | 108 | 109 | 110 | 111 |
| Position(y, x) | (4, 2) | (5, 1) | (6, 0) | (0, 5) | (1, 4) | (2, 3) | (3, 2) | (4, 1) |
| Scan Index | 112 | 113 | 114 | 115 | 116 | 117 | 118 | 119 |
| Position(y, x) | (5, 0) | (0, 4) | (1, 3) | (2, 2) | (3, 1) | (4, 0) | (0, 3) | (1, 2) |
| Scan Index | 120 | 121 | 122 | 123 | 124 | 125 | 126 | 127 |
| Position(y, x) | (2, 1) | (3, 0) | (0, 2) | (1, 1) | (2, 0) | (0, 1) | (1, 0) | (0, 0) |

Example for Whole 8×16 Wavefront Scan Pattern

TABLE 8
Whole 8×16 wavefront scan pattern
Forward Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (0, 0) | (1, 0) | (0, 1) | (2, 0) | (1, 1) | (0, 2) | (3, 0) | (2, 1) |
| Scan Index | 8 | 9 | 10 | 11 | 12 | 13 | 14 | 15 |
| Position(y, x) | (1, 2) | (0, 3) | (4, 0) | (3, 1) | (2, 2) | (1, 3) | (0, 4) | (5, 0) |
| Scan Index | 16 | 17 | 18 | 19 | 20 | 21 | 22 | 23 |
| Position(y, x) | (4, 1) | (3, 2) | (2, 3) | (1, 4) | (0, 5) | (6, 0) | (5, 1) | (4, 2) |
| Scan Index | 24 | 25 | 26 | 27 | 28 | 29 | 30 | 31 |
| Position(y, x) | (3, 3) | (2, 4) | (1, 5) | (0, 6) | (7, 0) | (6, 1) | (5, 2) | (4, 3) |
| Scan Index | 32 | 33 | 34 | 35 | 36 | 37 | 38 | 39 |
| Position(y, x) | (3, 4) | (2, 5) | (1, 6) | (0, 7) | (8, 0) | (7, 1) | (6, 2) | (5, 3) |
| Scan Index | 40 | 41 | 42 | 43 | 44 | 45 | 46 | 47 |
| Position(y, x) | (4, 4) | (3, 5) | (2, 6) | (1, 7) | (9, 0) | (8, 1) | (7, 2) | (6, 3) |
| Scan Index | 48 | 49 | 50 | 51 | 52 | 53 | 54 | 55 |
| Position(y, x) | (5, 4) | (4, 5) | (3, 6) | (2, 7) | (10, 0) | (9, 1) | (8, 2) | (7, 3) |
| Scan Index | 56 | 57 | 58 | 59 | 60 | 61 | 62 | 63 |
| Position(y, x) | (6, 4) | (5, 5) | (4, 6) | (3, 7) | (11, 0) | (10, 1) | (9, 2) | (8, 3) |
| Scan Index | 64 | 65 | 66 | 67 | 68 | 69 | 70 | 71 |
| Position(y, x) | (7, 4) | (6, 5) | (5, 6) | (4, 7) | (12, 0) | (11, 1) | (10, 2) | (9, 3) |
| Scan Index | 72 | 73 | 74 | 75 | 76 | 77 | 78 | 79 |
| Position(y, x) | (8, 4) | (7, 5) | (6, 6) | (5, 7) | (13, 0) | (12, 1) | (11, 2) | (10, 3) |
| Scan Index | 80 | 81 | 82 | 83 | 84 | 85 | 86 | 87 |
| Position(y, x) | (9, 4) | (8, 5) | (7, 6) | (6, 7) | (14, 0) | (13, 1) | (12, 2) | (11, 3) |
| Scan Index | 88 | 89 | 90 | 91 | 92 | 93 | 94 | 95 |
| Position(y, x) | (10, 4) | (9, 5) | (8, 6) | (7, 7) | (15, 0) | (14, 1) | (13, 2) | (12, 3) |
| Scan Index | 96 | 97 | 98 | 99 | 100 | 101 | 102 | 103 |
| Position(y, x) | (11, 4) | (10, 5) | (9, 6) | (8, 7) | (15, 1) | (14, 2) | (13, 3) | (12, 4) |
| Scan Index | 104 | 105 | 106 | 107 | 108 | 109 | 110 | 111 |
| Position(y, x) | (11, 5) | (10, 6) | (9, 7) | (15, 2) | (14, 3) | (13, 4) | (12, 5) | (11, 6) |
| Scan Index | 112 | 113 | 114 | 115 | 116 | 117 | 118 | 119 |
| Position(y, x) | (10, 7) | (15, 3) | (14, 4) | (13, 5) | (12, 6) | (11, 7) | (15, 4) | (14, 5) |
| Scan Index | 120 | 121 | 122 | 123 | 124 | 125 | 126 | 127 |
| Position(y, x) | (13, 6) | (12, 7) | (15, 5) | (14, 6) | (13, 7) | (15, 6) | (14, 7) | (15, 7) |

Forward Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (0, 0) | (0, 1) | (1, 0) | (0, 2) | (1, 1) | (2, 0) | (0, 3) | (1, 2) |
| Scan Index | 8 | 9 | 10 | 11 | 12 | 13 | 14 | 15 |
| Position(y, x) | (2, 1) | (3, 0) | (0, 4) | (1, 3) | (2, 2) | (3, 1) | (4, 0) | (0, 5) |
| Scan Index | 16 | 17 | 18 | 19 | 20 | 21 | 22 | 23 |
| Position(y, x) | (1, 4) | (2, 3) | (3, 2) | (4, 1) | (5, 0) | (0, 6) | (1, 5) | (2, 4) |
| Scan Index | 24 | 25 | 26 | 27 | 28 | 29 | 30 | 31 |
| Position(y, x) | (3, 3) | (4, 2) | (5, 1) | (6, 0) | (0, 7) | (1, 6) | (2, 5) | (3, 4) |
| Scan Index | 32 | 33 | 34 | 35 | 36 | 37 | 38 | 39 |
| Position(y, x) | (4, 3) | (5, 2) | (6, 1) | (7, 0) | (1, 7) | (2, 6) | (3, 5) | (4, 4) |
| Scan Index | 40 | 41 | 42 | 43 | 44 | 45 | 46 | 47 |
| Position(y, x) | (5, 3) | (6, 2) | (7, 1) | (8, 0) | (2, 7) | (3, 6) | (4, 5) | (5, 4) |
| Scan Index | 48 | 49 | 50 | 51 | 52 | 53 | 54 | 55 |
| Position(y, x) | (6, 3) | (7, 2) | (8, 1) | (9, 0) | (3, 7) | (4, 6) | (5, 5) | (6, 4) |
| Scan Index | 56 | 57 | 58 | 59 | 60 | 61 | 62 | 63 |
| Position(y, x) | (7, 3) | (8, 2) | (9, 1) | (10, 0) | (4, 7) | (5, 6) | (6, 5) | (7, 4) |
| Scan Index | 64 | 65 | 66 | 67 | 68 | 69 | 70 | 71 |
| Position(y, x) | (8, 3) | (9, 2) | (10, 1) | (11, 0) | (5, 7) | (6, 6) | (7, 5) | (8, 4) |
| Scan Index | 72 | 73 | 74 | 75 | 76 | 77 | 78 | 79 |
| Position(y, x) | (9, 3) | (10, 2) | (11, 1) | (12, 0) | (6, 7) | (7, 6) | (8, 5) | (9, 4) |
| Scan Index | 80 | 81 | 82 | 83 | 84 | 85 | 86 | 87 |
| Position(y, x) | (10, 3) | (11, 2) | (12, 1) | (13, 0) | (7, 7) | (8, 6) | (9, 5) | (10, 4) |
| Scan Index | 88 | 89 | 90 | 91 | 92 | 93 | 94 | 95 |
| Position(y, x) | (11, 3) | (12, 2) | (13, 1) | (14, 0) | (8, 7) | (9, 6) | (10, 5) | (11, 4) |
| Scan Index | 96 | 97 | 98 | 99 | 100 | 101 | 102 | 103 |
| Position(y, x) | (12, 3) | (13, 2) | (14, 1) | (15, 0) | (9, 7) | (10, 6) | (11, 5) | (12, 4) |
| Scan Index | 104 | 105 | 106 | 107 | 108 | 109 | 110 | 111 |
| Position(y, x) | (13, 3) | (14, 2) | (15, 1) | (10, 7) | (11, 6) | (12, 5) | (13, 4) | (14, 3) |
| Scan Index | 112 | 113 | 114 | 115 | 116 | 117 | 118 | 119 |
| Position(y, x) | (15, 2) | (11, 7) | (12, 6) | (13, 5) | (14, 4) | (15, 3) | (12, 7) | (13, 6) |
| Scan Index | 120 | 121 | 122 | 123 | 124 | 125 | 126 | 127 |
| Position(y, x) | (14, 5) | (15, 4) | (13, 7) | (14, 6) | (15, 5) | (14, 7) | (15, 6) | (15, 7) |

Reverse Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (15, 7) | (15, 6) | (14, 7) | (15, 5) | (14, 6) | (13, 7) | (15, 4) | (14, 5) |
| Scan Index | 8 | 9 | 10 | 11 | 12 | 13 | 14 | 15 |
| Position(y, x) | (13, 6) | (12, 7) | (15, 3) | (14, 4) | (13, 5) | (12, 6) | (11, 7) | (15, 2) |
| Scan Index | 16 | 17 | 18 | 19 | 20 | 21 | 22 | 23 |
| Position(y, x) | (14, 3) | (13, 4) | (12, 5) | (11, 6) | (10, 7) | (15, 1) | (14, 2) | (13, 3) |
| Scan Index | 24 | 25 | 26 | 27 | 28 | 29 | 30 | 31 |
| Position(y, x) | (12, 4) | (11, 5) | (10, 6) | (9, 7) | (15, 0) | (14, 1) | (13, 2) | (12, 3) |
| Scan Index | 32 | 33 | 34 | 35 | 36 | 37 | 38 | 39 |
| Position(y, x) | (11, 4) | (10, 5) | (9, 6) | (8, 7) | (14, 0) | (13, 1) | (12, 2) | (11, 3) |
| Scan Index | 40 | 41 | 42 | 43 | 44 | 45 | 46 | 47 |
| Position(y, x) | (10, 4) | (9, 5) | (8, 6) | (7, 7) | (13, 0) | (12, 1) | (11, 2) | (10, 3) |
| Scan Index | 48 | 49 | 50 | 51 | 52 | 53 | 54 | 55 |
| Position(y, x) | (9, 4) | (8, 5) | (7, 6) | (6, 7) | (12, 0) | (11, 1) | (10, 2) | (9, 3) |
| Scan Index | 56 | 57 | 58 | 59 | 60 | 61 | 62 | 63 |
| Position(y, x) | (8, 4) | (7, 5) | (6, 6) | (5, 7) | (11, 0) | (10, 1) | (9, 2) | (8, 3) |
| Scan Index | 64 | 65 | 66 | 67 | 68 | 69 | 70 | 71 |
| Position(y, x) | (7, 4) | (6, 5) | (5, 6) | (4, 7) | (10, 0) | (9, 1) | (8, 2) | (7, 3) |
| Scan Index | 72 | 73 | 74 | 75 | 76 | 77 | 78 | 79 |
| Position(y, x) | (6, 4) | (5, 5) | (4, 6) | (3, 7) | (9, 0) | (8, 1) | (7, 2) | (6, 3) |
| Scan Index | 80 | 81 | 82 | 83 | 84 | 85 | 86 | 87 |
| Position(y, x) | (5, 4) | (4, 5) | (3, 6) | (2, 7) | (8, 0) | (7, 1) | (6, 2) | (5, 3) |
| Scan Index | 88 | 89 | 90 | 91 | 92 | 93 | 94 | 95 |
| Position(y, x) | (4, 4) | (3, 5) | (2, 6) | (1, 7) | (7, 0) | (6, 1) | (5, 2) | (4, 3) |
| Scan Index | 96 | 97 | 98 | 99 | 100 | 101 | 102 | 103 |
| Position(y, x) | (3, 4) | (2, 5) | (1, 6) | (0, 7) | (6, 0) | (5, 1) | (4, 2) | (3, 3) |
| Scan Index | 104 | 105 | 106 | 107 | 108 | 109 | 110 | 111 |
| Position(y, x) | (2, 4) | (1, 5) | (0, 6) | (5, 0) | (4, 1) | (3, 2) | (2, 3) | (1, 4) |
| Scan Index | 112 | 113 | 114 | 115 | 116 | 117 | 118 | 119 |
| Position(y, x) | (0, 5) | (4, 0) | (3, 1) | (2, 2) | (1, 3) | (0, 4) | (3, 0) | (2, 1) |
| Scan Index | 120 | 121 | 122 | 123 | 124 | 125 | 126 | 127 |
| Position(y, x) | (1, 2) | (0, 3) | (2, 0) | (1, 1) | (0, 2) | (1, 0) | (0, 1) | (0, 0) |

Reverse Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (15, 7) | (14, 7) | (15, 6) | (13, 7) | (14, 6) | (15, 5) | (12, 7) | (13, 6) |
| Scan Index | 8 | 9 | 10 | 11 | 12 | 13 | 14 | 15 |
| Position(y, x) | (14, 5) | (15, 4) | (11, 7) | (12, 6) | (13, 5) | (14, 4) | (15, 3) | (10, 7) |
| Scan Index | 16 | 17 | 18 | 19 | 20 | 21 | 22 | 23 |
| Position(y, x) | (11, 6) | (12, 5) | (13, 4) | (14, 3) | (15, 2) | (9, 7) | (10, 6) | (11, 5) |
| Scan Index | 24 | 25 | 26 | 27 | 28 | 29 | 30 | 31 |
| Position(y, x) | (12, 4) | (13, 3) | (14, 2) | (15, 1) | (8, 7) | (9, 6) | (10, 5) | (11, 4) |
| Scan Index | 32 | 33 | 34 | 35 | 36 | 37 | 38 | 39 |
| Position(y, x) | (12, 3) | (13, 2) | (14, 1) | (15, 0) | (7, 7) | (8, 6) | (9, 5) | (10, 4) |
| Scan Index | 40 | 41 | 42 | 43 | 44 | 45 | 46 | 47 |
| Position(y, x) | (11, 3) | (12, 2) | (13, 1) | (14, 0) | (6, 7) | (7, 6) | (8, 5) | (9, 4) |
| Scan Index | 48 | 49 | 50 | 51 | 52 | 53 | 54 | 55 |
| Position(y, x) | (10, 3) | (11, 2) | (12, 1) | (13, 0) | (5, 7) | (6, 6) | (7, 5) | (8, 4) |
| Scan Index | 56 | 57 | 58 | 59 | 60 | 61 | 62 | 63 |
| Position(y, x) | (9, 3) | (10, 2) | (11, 1) | (12, 0) | (4, 7) | (5, 6) | (6, 5) | (7, 4) |
| Scan Index | 64 | 65 | 66 | 67 | 68 | 69 | 70 | 71 |
| Position(y, x) | (8, 3) | (9, 2) | (10, 1) | (11, 0) | (3, 7) | (4, 6) | (5, 5) | (6, 4) |
| Scan Index | 72 | 73 | 74 | 75 | 76 | 77 | 78 | 79 |
| Position(y, x) | (7, 3) | (8, 2) | (9, 1) | (10, 0) | (2, 7) | (3, 6) | (4, 5) | (5, 4) |
| Scan Index | 80 | 81 | 82 | 83 | 84 | 85 | 86 | 87 |
| Position(y, x) | (6, 3) | (7, 2) | (8, 1) | (9, 0) | (1, 7) | (2, 6) | (3, 5) | (4, 4) |
| Scan Index | 88 | 89 | 90 | 91 | 92 | 93 | 94 | 95 |
| Position(y, x) | (5, 3) | (6, 2) | (7, 1) | (8, 0) | (0, 7) | (1, 6) | (2, 5) | (3, 4) |
| Scan Index | 96 | 97 | 98 | 99 | 100 | 101 | 102 | 103 |
| Position(y, x) | (4, 3) | (5, 2) | (6, 1) | (7, 0) | (0, 6) | (1, 5) | (2, 4) | (3, 3) |
| Scan Index | 104 | 105 | 106 | 107 | 108 | 109 | 110 | 111 |
| Position(y, x) | (4, 2) | (5, 1) | (6, 0) | (0, 5) | (1, 4) | (2, 3) | (3, 2) | (4, 1) |
| Scan Index | 112 | 113 | 114 | 115 | 116 | 117 | 118 | 119 |
| Position(y, x) | (5, 0) | (0, 4) | (1, 3) | (2, 2) | (3, 1) | (4, 0) | (0, 3) | (1, 2) |
| Scan Index | 120 | 121 | 122 | 123 | 124 | 125 | 126 | 127 |
| Position(y, x) | (2, 1) | (3, 0) | (0, 2) | (1, 1) | (2, 0) | (0, 1) | (1, 0) | (0, 0) |

Example for Whole 32×8 Wavefront Scan Pattern

TABLE 9
Whole 32 × 8 wavefront scan pattern
Forward Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (0, 0) | (1, 0) | (0, 1) | (2, 0) | (1, 1) | (0, 2) | (3, 0) | (2, 1) |
| Scan Index | 8 | 9 | 10 | 11 | 12 | 13 | 14 | 15 |
| Position(y, x) | (1, 2) | (0, 3) | (4, 0) | (3, 1) | (2, 2) | (1, 3) | (0, 4) | (5, 0) |
| Scan Index | 16 | 17 | 18 | 19 | 20 | 21 | 22 | 23 |
| Position(y, x) | (4, 1) | (3, 2) | (2, 3) | (1, 4) | (0, 5) | (6, 0) | (5, 1) | (4, 2) |
| Scan Index | 24 | 25 | 26 | 27 | 28 | 29 | 30 | 31 |
| Position(y, x) | (3, 3) | (2, 4) | (1, 5) | (0, 6) | (7, 0) | (6, 1) | (5, 2) | (4, 3) |
| Scan Index | 32 | 33 | 34 | 35 | 36 | 37 | 38 | 39 |
| Position(y, x) | (3, 4) | (2, 5) | (1, 6) | (0, 7) | (7, 1) | (6, 2) | (5, 3) | (4, 4) |
| Scan Index | 40 | 41 | 42 | 43 | 44 | 45 | 46 | 47 |
| Position(y, x) | (3, 5) | (2, 6) | (1, 7) | (0, 8) | (7, 2) | (6, 3) | (5, 4) | (4, 5) |
| Scan Index | 48 | 49 | 50 | 51 | 52 | 53 | 54 | 55 |
| Position(y, x) | (3, 6) | (2, 7) | (1, 8) | (0, 9) | (7, 3) | (6, 4) | (5, 5) | (4, 6) |
| Scan Index | 56 | 57 | 58 | 59 | 60 | 61 | 62 | 63 |
| Position(y, x) | (3, 7) | (2, 8) | (1, 9) | (0, 10) | (7, 4) | (6, 5) | (5, 6) | (4, 7) |
| Scan Index | 64 | 65 | 66 | 67 | 68 | 69 | 70 | 71 |
| Position(y, x) | (3, 8) | (2, 9) | (1, 10) | (0, 11) | (7, 5) | (6, 6) | (5, 7) | (4, 8) |
| Scan Index | 72 | 73 | 74 | 75 | 76 | 77 | 78 | 79 |
| Position(y, x) | (3, 9) | (2, 10) | (1, 11) | (0, 12) | (7, 6) | (6, 7) | (5, 8) | (4, 9) |
| Scan Index | 80 | 81 | 82 | 83 | 84 | 85 | 86 | 87 |
| Position(y, x) | (3, 10) | (2, 11) | (1, 12) | (0, 13) | (7, 7) | (6, 8) | (5, 9) | (4, 10) |
| Scan Index | 88 | 89 | 90 | 91 | 92 | 93 | 94 | 95 |
| Position(y, x) | (3, 11) | (2, 12) | (1, 13) | (0, 14) | (7, 8) | (6, 9) | (5, 10) | (4, 11) |
| Scan Index | 96 | 97 | 98 | 99 | 100 | 101 | 102 | 103 |
| Position(y, x) | (3, 12) | (2, 13) | (1, 14) | (0, 15) | (7, 9) | (6, 10) | (5, 11) | (4, 12) |
| Scan Index | 104 | 105 | 106 | 107 | 108 | 109 | 110 | 111 |
| Position(y, x) | (3, 13) | (2, 14) | (1, 15) | (0, 16) | (7, 10) | (6, 11) | (5, 12) | (4, 13) |
| Scan Index | 112 | 113 | 114 | 115 | 116 | 117 | 118 | 119 |
| Position(y, x) | (3, 14) | (2, 15) | (1, 16) | (0, 17) | (7, 11) | (6, 12) | (5, 13) | (4, 14) |
| Scan Index | 120 | 121 | 122 | 123 | 124 | 125 | 126 | 127 |
| Position(y, x) | (3, 15) | (2, 16) | (1, 17) | (0, 18) | (7, 12) | (6, 13) | (5, 14) | (4, 15) |
| Scan Index | 128 | 129 | 130 | 131 | 132 | 133 | 134 | 135 |
| Position(y, x) | (3, 16) | (2, 17) | (1, 18) | (0, 19) | (7, 13) | (6, 14) | (5, 15) | (4, 16) |
| Scan Index | 136 | 137 | 138 | 139 | 140 | 141 | 142 | 143 |
| Position(y, x) | (3, 17) | (2, 18) | (1, 19) | (0, 20) | (7, 14) | (6, 15) | (5, 16) | (4, 17) |
| Scan Index | 144 | 145 | 146 | 147 | 148 | 149 | 150 | 151 |
| Position(y, x) | (3, 18) | (2, 19) | (1, 20) | (0, 21) | (7, 15) | (6, 16) | (5, 17) | (4, 18) |
| Scan Index | 152 | 153 | 154 | 155 | 156 | 157 | 158 | 159 |
| Position(y, x) | (3, 19) | (2, 20) | (1, 21) | (0, 22) | (7, 16) | (6, 17) | (5, 18) | (4, 19) |
| Scan Index | 160 | 161 | 162 | 163 | 164 | 165 | 166 | 167 |
| Position(y, x) | (3, 20) | (2, 21) | (1, 22) | (0, 23) | (7, 17) | (6, 18) | (5, 19) | (4, 20) |
| Scan Index | 168 | 169 | 170 | 171 | 172 | 173 | 174 | 175 |
| Position(y, x) | (3, 21) | (2, 22) | (1, 23) | (0, 24) | (7, 18) | (6, 19) | (5, 20) | (4, 21) |
| Scan Index | 176 | 177 | 178 | 179 | 180 | 181 | 182 | 183 |
| Position(y, x) | (3, 22) | (2, 23) | (1, 24) | (0, 25) | (7, 19) | (6, 20) | (5, 21) | (4, 22) |
| Scan Index | 184 | 185 | 186 | 187 | 188 | 189 | 190 | 191 |
| Position(y, x) | (3, 23) | (2, 24) | (1, 25) | (0, 26) | (7, 20) | (6, 21) | (5, 22) | (4, 23) |
| Scan Index | 192 | 193 | 194 | 195 | 196 | 197 | 198 | 199 |
| Position(y, x) | (3, 24) | (2, 25) | (1, 26) | (0, 27) | (7, 21) | (6, 22) | (5, 23) | (4, 24) |
| Scan Index | 200 | 201 | 202 | 203 | 204 | 205 | 206 | 207 |
| Position(y, x) | (3, 25) | (2, 26) | (1, 27) | (0, 28) | (7, 22) | (6, 23) | (5, 24) | (4, 25) |
| Scan Index | 208 | 209 | 210 | 211 | 212 | 213 | 214 | 215 |
| Position(y, x) | (3, 26) | (2, 27) | (1, 28) | (0, 29) | (7, 23) | (6, 24) | (5, 25) | (4, 26) |
| Scan Index | 216 | 217 | 218 | 219 | 220 | 221 | 222 | 223 |
| Position(y, x) | (3, 27) | (2, 28) | (1, 29) | (0, 30) | (7, 24) | (6, 25) | (5, 26) | (4, 27) |
| Scan Index | 224 | 225 | 226 | 227 | 228 | 229 | 230 | 231 |
| Position(y, x) | (3, 28) | (2, 29) | (1, 30) | (0, 31) | (7, 25) | (6, 26) | (5, 27) | (4, 28) |
| Scan Index | 232 | 233 | 234 | 235 | 236 | 237 | 238 | 239 |
| Position(y, x) | (3, 29) | (2, 30) | (1, 31) | (7, 26) | (6, 27) | (5, 28) | (4, 29) | (3, 30) |
| Scan Index | 240 | 241 | 242 | 243 | 244 | 245 | 246 | 247 |
| Position(y, x) | (2, 31) | (7, 27) | (6, 28) | (5, 29) | (4, 30) | (3, 31) | (7, 28) | (6, 29) |
| Scan Index | 248 | 249 | 250 | 251 | 252 | 253 | 254 | 255 |
| Position(y, x) | (5, 30) | (4, 31) | (7, 29) | (6, 30) | (5, 31) | (7, 30) | (6, 31) | (7, 31) |

Forward Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (0, 0) | (0, 1) | (1, 0) | (0, 2) | (1, 1) | (2, 0) | (0, 3) | (1, 2) |
| Scan Index | 8 | 9 | 10 | 11 | 12 | 13 | 14 | 15 |
| Position(y, x) | (2, 1) | (3, 0) | (0, 4) | (1, 3) | (2, 2) | (3, 1) | (4, 0) | (0, 5) |
| Scan Index | 16 | 17 | 18 | 19 | 20 | 21 | 22 | 23 |
| Position(y, x) | (1, 4) | (2, 3) | (3, 2) | (4, 1) | (5, 0) | (0, 6) | (1, 5) | (2, 4) |
| Scan Index | 24 | 25 | 26 | 27 | 28 | 29 | 30 | 31 |
| Position(y, x) | (3, 3) | (4, 2) | (5, 1) | (6, 0) | (0, 7) | (1, 6) | (2, 5) | (3, 4) |
| Scan Index | 32 | 33 | 34 | 35 | 36 | 37 | 38 | 39 |
| Position(y, x) | (4, 3) | (5, 2) | (6, 1) | (7, 0) | (0, 8) | (1, 7) | (2, 6) | (3, 5) |
| Scan Index | 40 | 41 | 42 | 43 | 44 | 45 | 46 | 47 |
| Position(y, x) | (4, 4) | (5, 3) | (6, 2) | (7, 1) | (0, 9) | (1, 8) | (2, 7) | (3, 6) |
| Scan Index | 48 | 49 | 50 | 51 | 52 | 53 | 54 | 55 |
| Position(y, x) | (4, 5) | (5, 4) | (6, 3) | (7, 2) | (0, 10) | (1, 9) | (2, 8) | (3, 7) |
| Scan Index | 56 | 57 | 58 | 59 | 60 | 61 | 62 | 63 |
| Position(y, x) | (4, 6) | (5, 5) | (6, 4) | (7, 3) | (0, 11) | (1, 10) | (2, 9) | (3, 8) |
| Scan Index | 64 | 65 | 66 | 67 | 68 | 69 | 70 | 71 |
| Position(y, x) | (4, 7) | (5, 6) | (6, 5) | (7, 4) | (0, 12) | (1, 11) | (2, 10) | (3, 9) |
| Scan Index | 72 | 73 | 74 | 75 | 76 | 77 | 78 | 79 |
| Position(y, x) | (4, 8) | (5, 7) | (6, 6) | (7, 5) | (0, 13) | (1, 12) | (2, 11) | (3, 10) |
| Scan Index | 80 | 81 | 82 | 83 | 84 | 85 | 86 | 87 |
| Position(y, x) | (4, 9) | (5, 8) | (6, 7) | (7, 6) | (0, 14) | (1, 13) | (2, 12) | (3, 11) |
| Scan Index | 88 | 89 | 90 | 91 | 92 | 93 | 94 | 95 |
| Position(y, x) | (4, 10) | (5, 9) | (6, 8) | (7, 7) | (0, 15) | (1, 14) | (2, 13) | (3, 12) |
| Scan Index | 96 | 97 | 98 | 99 | 100 | 101 | 102 | 103 |
| Position(y, x) | (4, 11) | (5, 10) | (6, 9) | (7, 8) | (0, 16) | (1, 15) | (2, 14) | (3, 13) |
| Scan Index | 104 | 105 | 106 | 107 | 108 | 109 | 110 | 111 |
| Position(y, x) | (4, 12) | (5, 11) | (6, 10) | (7, 9) | (0, 17) | (1, 16) | (2, 15) | (3, 14) |
| Scan Index | 112 | 113 | 114 | 115 | 116 | 117 | 118 | 119 |
| Position(y, x) | (4, 13) | (5, 12) | (6, 11) | (7, 10) | (0, 18) | (1, 17) | (2, 16) | (3, 15) |
| Scan Index | 120 | 121 | 122 | 123 | 124 | 125 | 126 | 127 |
| Position(y, x) | (4, 14) | (5, 13) | (6, 12) | (7, 11) | (0, 19) | (1, 18) | (2, 17) | (3, 16) |
| Scan Index | 128 | 129 | 130 | 131 | 132 | 133 | 134 | 135 |
| Position(y, x) | (4, 15) | (5, 14) | (6, 13) | (7, 12) | (0, 20) | (1, 19) | (2, 18) | (3, 17) |
| Scan Index | 136 | 137 | 138 | 139 | 140 | 141 | 142 | 143 |
| Position(y, x) | (4, 16) | (5, 15) | (6, 14) | (7, 13) | (0, 21) | (1, 20) | (2, 19) | (3, 18) |
| Scan Index | 144 | 145 | 146 | 147 | 148 | 149 | 150 | 151 |
| Position(y, x) | (4, 17) | (5, 16) | (6, 15) | (7, 14) | (0, 22) | (1, 21) | (2, 20) | (3, 19) |
| Scan Index | 152 | 153 | 154 | 155 | 156 | 157 | 158 | 159 |
| Position(y, x) | (4, 18) | (5, 17) | (6, 16) | (7, 15) | (0, 23) | (1, 22) | (2, 21) | (3, 20) |
| Scan Index | 160 | 161 | 162 | 163 | 164 | 165 | 166 | 167 |
| Position(y, x) | (4, 19) | (5, 18) | (6, 17) | (7, 16) | (0, 24) | (1, 23) | (2, 22) | (3, 21) |
| Scan Index | 168 | 169 | 170 | 171 | 172 | 173 | 174 | 175 |
| Position(y, x) | (4, 20) | (5, 19) | (6, 18) | (7, 17) | (0, 25) | (1, 24) | (2, 23) | (3, 22) |
| Scan Index | 176 | 177 | 178 | 179 | 180 | 181 | 182 | 183 |
| Position(y, x) | (4, 21) | (5, 20) | (6, 19) | (7, 18) | (0, 26) | (1, 25) | (2, 24) | (3, 23) |
| Scan Index | 184 | 185 | 186 | 187 | 188 | 189 | 190 | 191 |
| Position(y, x) | (4, 22) | (5, 21) | (6, 20) | (7, 19) | (0, 27) | (1, 26) | (2, 25) | (3, 24) |
| Scan Index | 192 | 193 | 194 | 195 | 196 | 197 | 198 | 199 |
| Position(y, x) | (4, 23) | (5, 22) | (6, 21) | (7, 20) | (0, 28) | (1, 27) | (2, 26) | (3, 25) |
| Scan Index | 200 | 201 | 202 | 203 | 204 | 205 | 206 | 207 |
| Position(y, x) | (4, 24) | (5, 23) | (6, 22) | (7, 21) | (0, 29) | (1, 28) | (2, 27) | (3, 26) |
| Scan Index | 208 | 209 | 210 | 211 | 212 | 213 | 214 | 215 |
| Position(y, x) | (4, 25) | (5, 24) | (6, 23) | (7, 22) | (0, 30) | (1, 29) | (2, 28) | (3, 27) |
| Scan Index | 216 | 217 | 218 | 219 | 220 | 221 | 222 | 223 |
| Position(y, x) | (4, 26) | (5, 25) | (6, 24) | (7, 23) | (0, 31) | (1, 30) | (2, 29) | (3, 28) |
| Scan Index | 224 | 225 | 226 | 227 | 228 | 229 | 230 | 231 |
| Position(y, x) | (4, 27) | (5, 26) | (6, 25) | (7, 24) | (1, 31) | (2, 30) | (3, 29) | (4, 28) |
| Scan Index | 232 | 233 | 234 | 235 | 236 | 237 | 238 | 239 |
| Position(y, x) | (5, 27) | (6, 26) | (7, 25) | (2, 31) | (3, 30) | (4, 29) | (5, 28) | (6, 27) |
| Scan Index | 240 | 241 | 242 | 243 | 244 | 245 | 246 | 247 |
| Position(y, x) | (7, 26) | (3, 31) | (4, 30) | (5, 29) | (6, 28) | (7, 27) | (4, 31) | (5, 30) |
| Scan Index | 248 | 249 | 250 | 251 | 252 | 253 | 254 | 255 |
| Position(y, x) | (6, 29) | (7, 28) | (5, 31) | (6, 30) | (7, 29) | (6, 31) | (7, 30) | (7, 31) |

Reverse Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (7, 31) | (7, 30) | (6, 31) | (7, 29) | (6, 30) | (5, 31) | (7, 28) | (6, 29) |
| Scan Index | 8 | 9 | 10 | 11 | 12 | 13 | 14 | 15 |
| Position(y, x) | (5, 30) | (4, 31) | (7, 27) | (6, 28) | (5, 29) | (4, 30) | (3, 31) | (7, 26) |
| Scan Index | 16 | 17 | 18 | 19 | 20 | 21 | 22 | 23 |
| Position(y, x) | (6, 27) | (5, 28) | (4, 29) | (3, 30) | (2, 31) | (7, 25) | (6, 26) | (5, 27) |
| Scan Index | 24 | 25 | 26 | 27 | 28 | 29 | 30 | 31 |
| Position(y, x) | (4, 28) | (3, 29) | (2, 30) | (1, 31) | (7, 24) | (6, 25) | (5, 26) | (4, 27) |
| Scan Index | 32 | 33 | 34 | 35 | 36 | 37 | 38 | 39 |
| Position(y, x) | (3, 28) | (2, 29) | (1, 30) | (0, 31) | (7, 23) | (6, 24) | (5, 25) | (4, 26) |
| Scan Index | 40 | 41 | 42 | 43 | 44 | 45 | 46 | 47 |
| Position(y, x) | (3, 27) | (2, 28) | (1, 29) | (0, 30) | (7, 22) | (6, 23) | (5, 24) | (4, 25) |
| Scan Index | 48 | 49 | 50 | 51 | 52 | 53 | 54 | 55 |
| Position(y, x) | (3, 26) | (2, 27) | (1, 28) | (0, 29) | (7, 21) | (6, 22) | (5, 23) | (4, 24) |
| Scan Index | 56 | 57 | 58 | 59 | 60 | 61 | 62 | 63 |
| Position(y, x) | (3, 25) | (2, 26) | (1, 27) | (0, 28) | (7, 20) | (6, 21) | (5, 22) | (4, 23) |
| Scan Index | 64 | 65 | 66 | 67 | 68 | 69 | 70 | 71 |
| Position(y, x) | (3, 24) | (2, 25) | (1, 26) | (0, 27) | (7, 19) | (6, 20) | (5, 21) | (4, 22) |
| Scan Index | 72 | 73 | 74 | 75 | 76 | 77 | 78 | 79 |
| Position(y, x) | (3, 23) | (2, 24) | (1, 25) | (0, 26) | (7, 18) | (6, 19) | (5, 20) | (4, 21) |
| Scan Index | 80 | 81 | 82 | 83 | 84 | 85 | 86 | 87 |
| Position(y, x) | (3, 22) | (2, 23) | (1, 24) | (0, 25) | (7, 17) | (6, 18) | (5, 19) | (4, 20) |
| Scan Index | 88 | 89 | 90 | 91 | 92 | 93 | 94 | 95 |
| Position(y, x) | (3, 21) | (2, 22) | (1, 23) | (0, 24) | (7, 16) | (6, 17) | (5, 18) | (4, 19) |
| Scan Index | 96 | 97 | 98 | 99 | 100 | 101 | 102 | 103 |
| Position(y, x) | (3, 20) | (2, 21) | (1, 22) | (0, 23) | (7, 15) | (6, 16) | (5, 17) | (4, 18) |
| Scan Index | 104 | 105 | 106 | 107 | 108 | 109 | 110 | 111 |
| Position(y, x) | (3, 19) | (2, 20) | (1, 21) | (0, 22) | (7, 14) | (6, 15) | (5, 16) | (4, 17) |
| Scan Index | 112 | 113 | 114 | 115 | 116 | 117 | 118 | 119 |
| Position(y, x) | (3, 18) | (2, 19) | (1, 20) | (0, 21) | (7, 13) | (6, 14) | (5, 15) | (4, 16) |
| Scan Index | 120 | 121 | 122 | 123 | 124 | 125 | 126 | 127 |
| Position(y, x) | (3, 17) | (2, 18) | (1, 19) | (0, 20) | (7, 12) | (6, 13) | (5, 14) | (4, 15) |
| Scan Index | 128 | 129 | 130 | 131 | 132 | 133 | 134 | 135 |
| Position(y, x) | (3, 16) | (2, 17) | (1, 18) | (0, 19) | (7, 11) | (6, 12) | (5, 13) | (4, 14) |
| Scan Index | 136 | 137 | 138 | 139 | 140 | 141 | 142 | 143 |
| Position(y, x) | (3, 15) | (2, 16) | (1, 17) | (0, 18) | (7, 10) | (6, 11) | (5, 12) | (4, 13) |
| Scan Index | 144 | 145 | 146 | 147 | 148 | 149 | 150 | 151 |
| Position(y, x) | (3, 14) | (2, 15) | (1, 16) | (0, 17) | (7, 9) | (6, 10) | (5, 11) | (4, 12) |
| Scan Index | 152 | 153 | 154 | 155 | 156 | 157 | 158 | 159 |
| Position(y, x) | (3, 13) | (2, 14) | (1, 15) | (0, 16) | (7, 8) | (6, 9) | (5, 10) | (4, 11) |
| Scan Index | 160 | 161 | 162 | 163 | 164 | 165 | 166 | 167 |
| Position(y, x) | (3, 12) | (2, 13) | (1, 14) | (0, 15) | (7, 7) | (6, 8) | (5, 9) | (4, 10) |
| Scan Index | 168 | 169 | 170 | 171 | 172 | 173 | 174 | 175 |
| Position(y, x) | (3, 11) | (2, 12) | (1, 13) | (0, 14) | (7, 6) | (6, 7) | (5, 8) | (4, 9) |
| Scan Index | 176 | 177 | 178 | 179 | 180 | 181 | 182 | 183 |
| Position(y, x) | (3, 10) | (2, 11) | (1, 12) | (0, 13) | (7, 5) | (6, 6) | (5, 7) | (4, 8) |
| Scan Index | 184 | 185 | 186 | 187 | 188 | 189 | 190 | 191 |
| Position(y, x) | (3, 9) | (2, 10) | (1, 11) | (0, 12) | (7, 4) | (6, 5) | (5, 6) | (4, 7) |
| Scan Index | 192 | 193 | 194 | 195 | 196 | 197 | 198 | 199 |
| Position(y, x) | (3, 8) | (2, 9) | (1, 10) | (0, 11) | (7, 3) | (6, 4) | (5, 5) | (4, 6) |
| Scan Index | 200 | 201 | 202 | 203 | 204 | 205 | 206 | 207 |
| Position(y, x) | (3, 7) | (2, 8) | (1, 9) | (0, 10) | (7, 2) | (6, 3) | (5, 4) | (4, 5) |
| Scan Index | 208 | 209 | 210 | 211 | 212 | 213 | 214 | 215 |
| Position(y, x) | (3, 6) | (2, 7) | (1, 8) | (0, 9) | (7, 1) | (6, 2) | (5, 3) | (4, 4) |
| Scan Index | 216 | 217 | 218 | 219 | 220 | 221 | 222 | 223 |
| Position(y, x) | (3, 5) | (2, 6) | (1, 7) | (0, 8) | (7, 0) | (6, 1) | (5, 2) | (4, 3) |
| Scan Index | 224 | 225 | 226 | 227 | 228 | 229 | 230 | 231 |
| Position(y, x) | (3, 4) | (2, 5) | (1, 6) | (0, 7) | (6, 0) | (5, 1) | (4, 2) | (3, 3) |
| Scan Index | 232 | 233 | 234 | 235 | 236 | 237 | 238 | 239 |
| Position(y, x) | (2, 4) | (1, 5) | (0, 6) | (5, 0) | (4, 1) | (3, 2) | (2, 3) | (1, 4) |
| Scan Index | 240 | 241 | 242 | 243 | 244 | 245 | 246 | 247 |
| Position(y, x) | (0, 5) | (4, 0) | (3, 1) | (2, 2) | (1, 3) | (0, 4) | (3, 0) | (2, 1) |
| Scan Index | 248 | 249 | 250 | 251 | 252 | 253 | 254 | 255 |
| Position(y, x) | (1, 2) | (0, 3) | (2, 0) | (1, 1) | (0, 2) | (1, 0) | (0, 1) | (0, 0) |

Reverse Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (7, 31) | (6, 31) | (7, 30) | (5, 31) | (6, 30) | (7, 29) | (4, 31) | (5, 30) |
| Scan Index | 8 | 9 | 10 | 11 | 12 | 13 | 14 | 15 |
| Position(y, x) | (6, 29) | (7, 28) | (3, 31) | (4, 30) | (5, 29) | (6, 28) | (7, 27) | (2, 31) |
| Scan Index | 16 | 17 | 18 | 19 | 20 | 21 | 22 | 23 |
| Position(y, x) | (3, 30) | (4, 29) | (5, 28) | (6, 27) | (7, 26) | (1, 31) | (2, 30) | (3, 29) |
| Scan Index | 24 | 25 | 26 | 27 | 28 | 29 | 30 | 31 |
| Position(y, x) | (4, 28) | (5, 27) | (6, 26) | (7, 25) | (0, 31) | (1, 30) | (2, 29) | (3, 28) |
| Scan Index | 32 | 33 | 34 | 35 | 36 | 37 | 38 | 39 |
| Position(y, x) | (4, 27) | (5, 26) | (6, 25) | (7, 24) | (0, 30) | (1, 29) | (2, 28) | (3, 27) |
| Scan Index | 40 | 41 | 42 | 43 | 44 | 45 | 46 | 47 |
| Position(y, x) | (4, 26) | (5, 25) | (6, 24) | (7, 23) | (0, 29) | (1, 28) | (2, 27) | (3, 26) |
| Scan Index | 48 | 49 | 50 | 51 | 52 | 53 | 54 | 55 |
| Position(y, x) | (4, 25) | (5, 24) | (6, 23) | (7, 22) | (0, 28) | (1, 27) | (2, 26) | (3, 25) |
| Scan Index | 56 | 57 | 58 | 59 | 60 | 61 | 62 | 63 |
| Position(y, x) | (4, 24) | (5, 23) | (6, 22) | (7, 21) | (0, 27) | (1, 26) | (2, 25) | (3, 24) |
| Scan Index | 64 | 65 | 66 | 67 | 68 | 69 | 70 | 71 |
| Position(y, x) | (4, 23) | (5, 22) | (6, 21) | (7, 20) | (0, 26) | (1, 25) | (2, 24) | (3, 23) |
| Scan Index | 72 | 73 | 74 | 75 | 76 | 77 | 78 | 79 |
| Position(y, x) | (4, 22) | (5, 21) | (6, 20) | (7, 19) | (0, 25) | (1, 24) | (2, 23) | (3, 22) |
| Scan Index | 80 | 81 | 82 | 83 | 84 | 85 | 86 | 87 |
| Position(y, x) | (4, 21) | (5, 20) | (6, 19) | (7, 18) | (0, 24) | (1, 23) | (2, 22) | (3, 21) |
| Scan Index | 88 | 89 | 90 | 91 | 92 | 93 | 94 | 95 |
| Position(y, x) | (4, 20) | (5, 19) | (6, 18) | (7, 17) | (0, 23) | (1, 22) | (2, 21) | (3, 20) |
| Scan Index | 96 | 97 | 98 | 99 | 100 | 101 | 102 | 103 |
| Position(y, x) | (4, 19) | (5, 18) | (6, 17) | (7, 16) | (0, 22) | (1, 21) | (2, 20) | (3, 19) |
| Scan Index | 104 | 105 | 106 | 107 | 108 | 109 | 110 | 111 |
| Position(y, x) | (4, 18) | (5, 17) | (6, 16) | (7, 15) | (0, 21) | (1, 20) | (2, 19) | (3, 18) |
| Scan Index | 112 | 113 | 114 | 115 | 116 | 117 | 118 | 119 |
| Position(y, x) | (4, 17) | (5, 16) | (6, 15) | (7, 14) | (0, 20) | (1, 19) | (2, 18) | (3, 17) |
| Scan Index | 120 | 121 | 122 | 123 | 124 | 125 | 126 | 127 |
| Position(y, x) | (4, 16) | (5, 15) | (6, 14) | (7, 13) | (0, 19) | (1, 18) | (2, 17) | (3, 16) |
| Scan Index | 128 | 129 | 130 | 131 | 132 | 133 | 134 | 135 |
| Position(y, x) | (4, 15) | (5, 14) | (6, 13) | (7, 12) | (0, 18) | (1, 17) | (2, 16) | (3, 15) |
| Scan Index | 136 | 137 | 138 | 139 | 140 | 141 | 142 | 143 |
| Position(y, x) | (4, 14) | (5, 13) | (6, 12) | (7, 11) | (0, 17) | (1, 16) | (2, 15) | (3, 14) |
| Scan Index | 144 | 145 | 146 | 147 | 148 | 149 | 150 | 151 |
| Position(y, x) | (4, 13) | (5, 12) | (6, 11) | (7, 10) | (0, 16) | (1, 15) | (2, 14) | (3, 13) |
| Scan Index | 152 | 153 | 154 | 155 | 156 | 157 | 158 | 159 |
| Position(y, x) | (4, 12) | (5, 11) | (6, 10) | (7, 9) | (0, 15) | (1, 14) | (2, 13) | (3, 12) |
| Scan Index | 160 | 161 | 162 | 163 | 164 | 165 | 166 | 167 |
| Position(y, x) | (4, 11) | (5, 10) | (6, 9) | (7, 8) | (0, 14) | (1, 13) | (2, 12) | (3, 11) |
| Scan Index | 168 | 169 | 170 | 171 | 172 | 173 | 174 | 175 |
| Position(y, x) | (4, 10) | (5, 9) | (6, 8) | (7, 7) | (0, 13) | (1, 12) | (2, 11) | (3, 10) |
| Scan Index | 176 | 177 | 178 | 179 | 180 | 181 | 182 | 183 |
| Position(y, x) | (4, 9) | (5, 8) | (6, 7) | (7, 6) | (0, 12) | (1, 11) | (2, 10) | (3, 9) |
| Scan Index | 184 | 185 | 186 | 187 | 188 | 189 | 190 | 191 |
| Position(y, x) | (4, 8) | (5, 7) | (6, 6) | (7, 5) | (0, 11) | (1, 10) | (2, 9) | (3, 8) |
| Scan Index | 192 | 193 | 194 | 195 | 196 | 197 | 198 | 199 |
| Position(y, x) | (4, 7) | (5, 6) | (6, 5) | (7, 4) | (0, 10) | (1, 9) | (2, 8) | (3, 7) |
| Scan Index | 200 | 201 | 202 | 203 | 204 | 205 | 206 | 207 |
| Position(y, x) | (4, 6) | (5, 5) | (6, 4) | (7, 3) | (0, 9) | (1, 8) | (2, 7) | (3, 6) |
| Scan Index | 208 | 209 | 210 | 211 | 212 | 213 | 214 | 215 |
| Position(y, x) | (4, 5) | (5, 4) | (6, 3) | (7, 2) | (0, 8) | (1, 7) | (2, 6) | (3, 5) |
| Scan Index | 216 | 217 | 218 | 219 | 220 | 221 | 222 | 223 |
| Position(y, x) | (4, 4) | (5, 3) | (6, 2) | (7, 1) | (0, 7) | (1, 6) | (2, 5) | (3, 4) |
| Scan Index | 224 | 225 | 226 | 227 | 228 | 229 | 230 | 231 |
| Position(y, x) | (4, 3) | (5, 2) | (6, 1) | (7, 0) | (0, 6) | (1, 5) | (2, 4) | (3, 3) |
| Scan Index | 232 | 233 | 234 | 235 | 236 | 237 | 238 | 239 |
| Position(y, x) | (4, 2) | (5, 1) | (6, 0) | (0, 5) | (1, 4) | (2, 3) | (3, 2) | (4, 1) |
| Scan Index | 240 | 241 | 242 | 243 | 244 | 245 | 246 | 247 |
| Position(y, x) | (5, 0) | (0, 4) | (1, 3) | (2, 2) | (3, 1) | (4, 0) | (0, 3) | (1, 2) |
| Scan Index | 248 | 249 | 250 | 251 | 252 | 253 | 254 | 255 |
| Position(y, x) | (2, 1) | (3, 0) | (0, 2) | (1, 1) | (2, 0) | (0, 1) | (1, 0) | (0, 0) |

Example for Whole 8×32 Wavefront Scan Pattern

TABLE 10
Whole 8 × 32 wavefront scan pattern
Forward Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (0, 0) | (1, 0) | (0, 1) | (2, 0) | (1, 1) | (0, 2) | (3, 0) | (2, 1) |
| Scan Index | 8 | 9 | 10 | 11 | 12 | 13 | 14 | 15 |
| Position(y, x) | (1, 2) | (0, 3) | (4, 0) | (3, 1) | (2, 2) | (1, 3) | (0, 4) | (5, 0) |
| Scan Index | 16 | 17 | 18 | 19 | 20 | 21 | 22 | 23 |
| Position(y, x) | (4, 1) | (3, 2) | (2, 3) | (1, 4) | (0, 5) | (6, 0) | (5, 1) | (4, 2) |
| Scan Index | 24 | 25 | 26 | 27 | 28 | 29 | 30 | 31 |
| Position(y, x) | (3, 3) | (2, 4) | (1, 5) | (0, 6) | (7, 0) | (6, 1) | (5, 2) | (4, 3) |
| Scan Index | 32 | 33 | 34 | 35 | 36 | 37 | 38 | 39 |
| Position(y, x) | (3, 4) | (2, 5) | (1, 6) | (0, 7) | (8, 0) | (7, 1) | (6, 2) | (5, 3) |
| Scan Index | 40 | 41 | 42 | 43 | 44 | 45 | 46 | 47 |
| Position(y, x) | (4, 4) | (3, 5) | (2, 6) | (1, 7) | (9, 0) | (8, 1) | (7, 2) | (6, 3) |
| Scan Index | 48 | 49 | 50 | 51 | 52 | 53 | 54 | 55 |
| Position(y, x) | (5, 4) | (4, 5) | (3, 6) | (2, 7) | (10, 0) | (9, 1) | (8, 2) | (7, 3) |
| Scan Index | 56 | 57 | 58 | 59 | 60 | 61 | 62 | 63 |
| Position(y, x) | (6, 4) | (5, 5) | (4, 6) | (3, 7) | (11, 0) | (10, 1) | (9, 2) | (8, 3) |
| Scan Index | 64 | 65 | 66 | 67 | 68 | 69 | 70 | 71 |
| Position(y, x) | (7, 4) | (6, 5) | (5, 6) | (4, 7) | (12, 0) | (11, 1) | (10, 2) | (9, 3) |
| Scan Index | 72 | 73 | 74 | 75 | 76 | 77 | 78 | 79 |
| Position(y, x) | (8, 4) | (7, 5) | (6, 6) | (5, 7) | (13, 0) | (12, 1) | (11, 2) | (10, 3) |
| Scan Index | 80 | 81 | 82 | 83 | 84 | 85 | 86 | 87 |
| Position(y, x) | (9, 4) | (8, 5) | (7, 6) | (6, 7) | (14, 0) | (13, 1) | (12, 2) | (11, 3) |
| Scan Index | 88 | 89 | 90 | 91 | 92 | 93 | 94 | 95 |
| Position(y, x) | (10, 4) | (9, 5) | (8, 6) | (7, 7) | (15, 0) | (14, 1) | (13, 2) | (12, 3) |
| Scan Index | 96 | 97 | 98 | 99 | 100 | 101 | 102 | 103 |
| Position(y, x) | (11, 4) | (10, 5) | (9, 6) | (8, 7) | (16, 0) | (15, 1) | (14, 2) | (13, 3) |
| Scan Index | 104 | 105 | 106 | 107 | 108 | 109 | 110 | 111 |
| Position(y, x) | (12, 4) | (11, 5) | (10, 6) | (9, 7) | (17, 0) | (16, 1) | (15, 2) | (14, 3) |
| Scan Index | 112 | 113 | 114 | 115 | 116 | 117 | 118 | 119 |
| Position(y, x) | (13, 4) | (12, 5) | (11, 6) | (10, 7) | (18, 0) | (17, 1) | (16, 2) | (15, 3) |
| Scan Index | 120 | 121 | 122 | 123 | 124 | 125 | 126 | 127 |
| Position(y, x) | (14, 4) | (13, 5) | (12, 6) | (11, 7) | (19, 0) | (18, 1) | (17, 2) | (16, 3) |
| Scan Index | 128 | 129 | 130 | 131 | 132 | 133 | 134 | 135 |
| Position(y, x) | (15, 4) | (14, 5) | (13, 6) | (12, 7) | (20, 0) | (19, 1) | (18, 2) | (17, 3) |
| Scan Index | 136 | 137 | 138 | 139 | 140 | 141 | 142 | 143 |
| Position(y, x) | (16, 4) | (15, 5) | (14, 6) | (13, 7) | (21, 0) | (20, 1) | (19, 2) | (18, 3) |
| Scan Index | 144 | 145 | 146 | 147 | 148 | 149 | 150 | 151 |
| Position(y, x) | (17, 4) | (16, 5) | (15, 6) | (14, 7) | (22, 0) | (21, 1) | (20, 2) | (19, 3) |
| Scan Index | 152 | 153 | 154 | 155 | 156 | 157 | 158 | 159 |
| Position(y, x) | (18, 4) | (17, 5) | (16, 6) | (15, 7) | (23, 0) | (22, 1) | (21, 2) | (20, 3) |
| Scan Index | 160 | 161 | 162 | 163 | 164 | 165 | 166 | 167 |
| Position(y, x) | (19, 4) | (18, 5) | (17, 6) | (16, 7) | (24, 0) | (23, 1) | (22, 2) | (21, 3) |
| Scan Index | 168 | 169 | 170 | 171 | 172 | 173 | 174 | 175 |
| Position(y, x) | (20, 4) | (19, 5) | (18, 6) | (17, 7) | (25, 0) | (24, 1) | (23, 2) | (22, 3) |
| Scan Index | 176 | 177 | 178 | 179 | 180 | 181 | 182 | 183 |
| Position(y, x) | (21, 4) | (20, 5) | (19, 6) | (18, 7) | (26, 0) | (25, 1) | (24, 2) | (23, 3) |
| Scan Index | 184 | 185 | 186 | 187 | 188 | 189 | 190 | 191 |
| Position(y, x) | (22, 4) | (21, 5) | (20, 6) | (19, 7) | (27, 0) | (26, 1) | (25, 2) | (24, 3) |
| Scan Index | 192 | 193 | 194 | 195 | 196 | 197 | 198 | 199 |
| Position(y, x) | (23, 4) | (22, 5) | (21, 6) | (20, 7) | (28, 0) | (27, 1) | (26, 2) | (25, 3) |
| Scan Index | 200 | 201 | 202 | 203 | 204 | 205 | 206 | 207 |
| Position(y, x) | (24, 4) | (23, 5) | (22, 6) | (21, 7) | (29, 0) | (28, 1) | (27, 2) | (26, 3) |
| Scan Index | 208 | 209 | 210 | 211 | 212 | 213 | 214 | 215 |
| Position(y, x) | (25, 4) | (24, 5) | (23, 6) | (22, 7) | (30, 0) | (29, 1) | (28, 2) | (27, 3) |
| Scan Index | 216 | 217 | 218 | 219 | 220 | 221 | 222 | 223 |
| Position(y, x) | (26, 4) | (25, 5) | (24, 6) | (23, 7) | (31, 0) | (30, 1) | (29, 2) | (28, 3) |
| Scan Index | 224 | 225 | 226 | 227 | 228 | 229 | 230 | 231 |
| Position(y, x) | (27, 4) | (26, 5) | (25, 6) | (24, 7) | (31, 1) | (30, 2) | (29, 3) | (28, 4) |
| Scan Index | 232 | 233 | 234 | 235 | 236 | 237 | 238 | 239 |
| Position(y, x) | (27, 5) | (26, 6) | (25, 7) | (31, 2) | (30, 3) | (29, 4) | (28, 5) | (27, 6) |
| Scan Index | 240 | 241 | 242 | 243 | 244 | 245 | 246 | 247 |
| Position(y, x) | (26, 7) | (31, 3) | (30, 4) | (29, 5) | (28, 6) | (27, 7) | (31, 4) | (30, 5) |
| Scan Index | 248 | 249 | 250 | 251 | 252 | 253 | 254 | 255 |
| Position(y, x) | (29, 6) | (28, 7) | (31, 5) | (30, 6) | (29, 7) | (31, 6) | (30, 7) | (31, 7) |

Forward Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (0, 0) | (0, 1) | (1, 0) | (0, 2) | (1, 1) | (2, 0) | (0, 3) | (1, 2) |
| Scan Index | 8 | 9 | 10 | 11 | 12 | 13 | 14 | 15 |
| Position(y, x) | (2, 1) | (3, 0) | (0, 4) | (1, 3) | (2, 2) | (3, 1) | (4, 0) | (0, 5) |
| Scan Index | 16 | 17 | 18 | 19 | 20 | 21 | 22 | 23 |
| Position(y, x) | (1, 4) | (2, 3) | (3, 2) | (4, 1) | (5, 0) | (0, 6) | (1, 5) | (2, 4) |
| Scan Index | 24 | 25 | 26 | 27 | 28 | 29 | 30 | 31 |
| Position(y, x) | (3, 3) | (4, 2) | (5, 1) | (6, 0) | (0, 7) | (1, 6) | (2, 5) | (3, 4) |
| Scan Index | 32 | 33 | 34 | 35 | 36 | 37 | 38 | 39 |
| Position(y, x) | (4, 3) | (5, 2) | (6, 1) | (7, 0) | (1, 7) | (2, 6) | (3, 5) | (4, 4) |
| Scan Index | 40 | 41 | 42 | 43 | 44 | 45 | 46 | 47 |
| Position(y, x) | (5, 3) | (6, 2) | (7, 1) | (8, 0) | (2, 7) | (3, 6) | (4, 5) | (5, 4) |
| Scan Index | 48 | 49 | 50 | 51 | 52 | 53 | 54 | 55 |
| Position(y, x) | (6, 3) | (7, 2) | (8, 1) | (9, 0) | (3, 7) | (4, 6) | (5, 5) | (6, 4) |
| Scan Index | 56 | 57 | 58 | 59 | 60 | 61 | 62 | 63 |
| Position(y, x) | (7, 3) | (8, 2) | (9, 1) | (10, 0) | (4, 7) | (5, 6) | (6, 5) | (7, 4) |
| Scan Index | 64 | 65 | 66 | 67 | 68 | 69 | 70 | 71 |
| Position(y, x) | (8, 3) | (9, 2) | (10, 1) | (11, 0) | (5, 7) | (6, 6) | (7, 5) | (8, 4) |
| Scan Index | 72 | 73 | 74 | 75 | 76 | 77 | 78 | 79 |
| Position(y, x) | (9, 3) | (10, 2) | (11, 1) | (12, 0) | (6, 7) | (7, 6) | (8, 5) | (9, 4) |
| Scan Index | 80 | 81 | 82 | 83 | 84 | 85 | 86 | 87 |
| Position(y, x) | (10, 3) | (11, 2) | (12, 1) | (13, 0) | (7, 7) | (8, 6) | (9, 5) | (10, 4) |
| Scan Index | 88 | 89 | 90 | 91 | 92 | 93 | 94 | 95 |
| Position(y, x) | (11, 3) | (12, 2) | (13, 1) | (14, 0) | (8, 7) | (9, 6) | (10, 5) | (11, 4) |
| Scan Index | 96 | 97 | 98 | 99 | 100 | 101 | 102 | 103 |
| Position(y, x) | (12, 3) | (13, 2) | (14, 1) | (15, 0) | (9, 7) | (10, 6) | (11, 5) | (12, 4) |
| Scan Index | 104 | 105 | 106 | 107 | 108 | 109 | 110 | 111 |
| Position(y, x) | (13, 3) | (14, 2) | (15, 1) | (16, 0) | (10, 7) | (11, 6) | (12, 5) | (13, 4) |
| Scan Index | 112 | 113 | 114 | 115 | 116 | 117 | 118 | 119 |
| Position(y, x) | (14, 3) | (15, 2) | (16, 1) | (17, 0) | (11, 7) | (12, 6) | (13, 5) | (14, 4) |
| Scan Index | 120 | 121 | 122 | 123 | 124 | 125 | 126 | 127 |
| Position(y, x) | (15, 3) | (16, 2) | (17, 1) | (18, 0) | (12, 7) | (13, 6) | (14, 5) | (15, 4) |
| Scan Index | 128 | 129 | 130 | 131 | 132 | 133 | 134 | 135 |
| Position(y, x) | (16, 3) | (17, 2) | (18, 1) | (19, 0) | (13, 7) | (14, 6) | (15, 5) | (16, 4) |
| Scan Index | 136 | 137 | 138 | 139 | 140 | 141 | 142 | 143 |
| Position(y, x) | (17, 3) | (18, 2) | (19, 1) | (20, 0) | (14, 7) | (15, 6) | (16, 5) | (17, 4) |
| Scan Index | 144 | 145 | 146 | 147 | 148 | 149 | 150 | 151 |
| Position(y, x) | (18, 3) | (19, 2) | (20, 1) | (21, 0) | (15, 7) | (16, 6) | (17, 5) | (18, 4) |
| Scan Index | 152 | 153 | 154 | 155 | 156 | 157 | 158 | 159 |
| Position(y, x) | (19, 3) | (20, 2) | (21, 1) | (22, 0) | (16, 7) | (17, 6) | (18, 5) | (19, 4) |
| Scan Index | 160 | 161 | 162 | 163 | 164 | 165 | 166 | 167 |
| Position(y, x) | (20, 3) | (21, 2) | (22, 1) | (23, 0) | (17, 7) | (18, 6) | (19, 5) | (20, 4) |
| Scan Index | 168 | 169 | 170 | 171 | 172 | 173 | 174 | 175 |
| Position(y, x) | (21, 3) | (22, 2) | (23, 1) | (24, 0) | (18, 7) | (19, 6) | (20, 5) | (21, 4) |
| Scan Index | 176 | 177 | 178 | 179 | 180 | 181 | 182 | 183 |
| Position(y, x) | (22, 3) | (23, 2) | (24, 1) | (25, 0) | (19, 7) | (20, 6) | (21, 5) | (22, 4) |
| Scan Index | 184 | 185 | 186 | 187 | 188 | 189 | 190 | 191 |
| Position(y, x) | (23, 3) | (24, 2) | (25, 1) | (26, 0) | (20, 7) | (21, 6) | (22, 5) | (23, 4) |
| Scan Index | 192 | 193 | 194 | 195 | 196 | 197 | 198 | 199 |
| Position(y, x) | (24, 3) | (25, 2) | (26, 1) | (27, 0) | (21, 7) | (22, 6) | (23, 5) | (24, 4) |
| Scan Index | 200 | 201 | 202 | 203 | 204 | 205 | 206 | 207 |
| Position(y, x) | (25, 3) | (26, 2) | (27, 1) | (28, 0) | (22, 7) | (23, 6) | (24, 5) | (25, 4) |
| Scan Index | 208 | 209 | 210 | 211 | 212 | 213 | 214 | 215 |
| Position(y, x) | (26, 3) | (27, 2) | (28, 1) | (29, 0) | (23, 7) | (24, 6) | (25, 5) | (26, 4) |
| Scan Index | 216 | 217 | 218 | 219 | 220 | 221 | 222 | 223 |
| Position(y, x) | (27, 3) | (28, 2) | (29, 1) | (30, 0) | (24, 7) | (25, 6) | (26, 5) | (27, 4) |
| Scan Index | 224 | 225 | 226 | 227 | 228 | 229 | 230 | 231 |
| Position(y, x) | (28, 3) | (29, 2) | (30, 1) | (31, 0) | (25, 7) | (26, 6) | (27, 5) | (28, 4) |
| Scan Index | 232 | 233 | 234 | 235 | 236 | 237 | 238 | 239 |
| Position(y, x) | (29, 3) | (30, 2) | (31, 1) | (26, 7) | (27, 6) | (28, 5) | (29, 4) | (30, 3) |
| Scan Index | 240 | 241 | 242 | 243 | 244 | 245 | 246 | 247 |
| Position(y, x) | (31, 2) | (27, 7) | (28, 6) | (29, 5) | (30, 4) | (31, 3) | (28, 7) | (29, 6) |
| Scan Index | 248 | 249 | 250 | 251 | 252 | 253 | 254 | 255 |
| Position(y, x) | (30, 5) | (31, 4) | (29, 7) | (30, 6) | (31, 5) | (30, 7) | (31, 6) | (31, 7) |

Reverse Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (31, 7) | (31, 6) | (30, 7) | (31, 5) | (30, 6) | (29, 7) | (31, 4) | (30, 5) |
| Scan Index | 8 | 9 | 10 | 11 | 12 | 13 | 14 | 15 |
| Position(y, x) | (29, 6) | (28, 7) | (31, 3) | (30, 4) | (29, 5) | (28, 6) | (27, 7) | (31, 2) |
| Scan Index | 16 | 17 | 18 | 19 | 20 | 21 | 22 | 23 |
| Position(y, x) | (30, 3) | (29, 4) | (28, 5) | (27, 6) | (26, 7) | (31, 1) | (30, 2) | (29, 3) |
| Scan Index | 24 | 25 | 26 | 27 | 28 | 29 | 30 | 31 |
| Position(y, x) | (28, 4) | (27, 5) | (26, 6) | (25, 7) | (31, 0) | (30, 1) | (29, 2) | (28, 3) |
| Scan Index | 32 | 33 | 34 | 35 | 36 | 37 | 38 | 39 |
| Position(y, x) | (27, 4) | (26, 5) | (25, 6) | (24, 7) | (30, 0) | (29, 1) | (28, 2) | (27, 3) |
| Scan Index | 40 | 41 | 42 | 43 | 44 | 45 | 46 | 47 |
| Position(y, x) | (26, 4) | (25, 5) | (24, 6) | (23, 7) | (29, 0) | (28, 1) | (27, 2) | (26, 3) |
| Scan Index | 48 | 49 | 50 | 51 | 52 | 53 | 54 | 55 |
| Position(y, x) | (25, 4) | (24, 5) | (23, 6) | (22, 7) | (28, 0) | (27, 1) | (26, 2) | (25, 3) |
| Scan Index | 56 | 57 | 58 | 59 | 60 | 61 | 62 | 63 |
| Position(y, x) | (24, 4) | (23, 5) | (22, 6) | (21, 7) | (27, 0) | (26, 1) | (25, 2) | (24, 3) |
| Scan Index | 64 | 65 | 66 | 67 | 68 | 69 | 70 | 71 |
| Position(y, x) | (23, 4) | (22, 5) | (21, 6) | (20, 7) | (26, 0) | (25, 1) | (24, 2) | (23, 3) |
| Scan Index | 72 | 73 | 74 | 75 | 76 | 77 | 78 | 79 |
| Position(y, x) | (22, 4) | (21, 5) | (20, 6) | (19, 7) | (25, 0) | (24, 1) | (23, 2) | (22, 3) |
| Scan Index | 80 | 81 | 82 | 83 | 84 | 85 | 86 | 87 |
| Position(y, x) | (21, 4) | (20, 5) | (19, 6) | (18, 7) | (24, 0) | (23, 1) | (22, 2) | (21, 3) |
| Scan Index | 88 | 89 | 90 | 91 | 92 | 93 | 94 | 95 |
| Position(y, x) | (20, 4) | (19, 5) | (18, 6) | (17, 7) | (23, 0) | (22, 1) | (21, 2) | (20, 3) |
| Scan Index | 96 | 97 | 98 | 99 | 100 | 101 | 102 | 103 |
| Position(y, x) | (19, 4) | (18, 5) | (17, 6) | (16, 7) | (22, 0) | (21, 1) | (20, 2) | (19, 3) |
| Scan Index | 104 | 105 | 106 | 107 | 108 | 109 | 110 | 111 |
| Position(y, x) | (18, 4) | (17, 5) | (16, 6) | (15, 7) | (21, 0) | (20, 1) | (19, 2) | (18, 3) |
| Scan Index | 112 | 113 | 114 | 115 | 116 | 117 | 118 | 119 |
| Position(y, x) | (17, 4) | (16, 5) | (15, 6) | (14, 7) | (20, 0) | (19, 1) | (18, 2) | (17, 3) |
| Scan Index | 120 | 121 | 122 | 123 | 124 | 125 | 126 | 127 |
| Position(y, x) | (16, 4) | (15, 5) | (14, 6) | (13, 7) | (19, 0) | (18, 1) | (17, 2) | (16, 3) |
| Scan Index | 128 | 129 | 130 | 131 | 132 | 133 | 134 | 135 |
| Position(y, x) | (15, 4) | (14, 5) | (13, 6) | (12, 7) | (18, 0) | (17, 1) | (16, 2) | (15, 3) |
| Scan Index | 136 | 137 | 138 | 139 | 140 | 141 | 142 | 143 |
| Position(y, x) | (14, 4) | (13, 5) | (12, 6) | (11, 7) | (17, 0) | (16, 1) | (15, 2) | (14, 3) |
| Scan Index | 144 | 145 | 146 | 147 | 148 | 149 | 150 | 151 |
| Position(y, x) | (13, 4) | (12, 5) | (11, 6) | (10, 7) | (16, 0) | (15, 1) | (14, 2) | (13, 3) |
| Scan Index | 152 | 153 | 154 | 155 | 156 | 157 | 158 | 159 |
| Position(y, x) | (12, 4) | (11, 5) | (10, 6) | (9, 7) | (15, 0) | (14, 1) | (13, 2) | (12, 3) |
| Scan Index | 160 | 161 | 162 | 163 | 164 | 165 | 166 | 167 |
| Position(y, x) | (11, 4) | (10, 5) | (9, 6) | (8, 7) | (14, 0) | (13, 1) | (12, 2) | (11, 3) |
| Scan Index | 168 | 169 | 170 | 171 | 172 | 173 | 174 | 175 |
| Position(y, x) | (10, 4) | (9, 5) | (8, 6) | (7, 7) | (13, 0) | (12, 1) | (11, 2) | (10, 3) |
| Scan Index | 176 | 177 | 178 | 179 | 180 | 181 | 182 | 183 |
| Position(y, x) | (9, 4) | (8, 5) | (7, 6) | (6, 7) | (12, 0) | (11, 1) | (10, 2) | (9, 3) |
| Scan Index | 184 | 185 | 186 | 187 | 188 | 189 | 190 | 191 |
| Position(y, x) | (8, 4) | (7, 5) | (6, 6) | (5, 7) | (11, 0) | (10, 1) | (9, 2) | (8, 3) |
| Scan Index | 192 | 193 | 194 | 195 | 196 | 197 | 198 | 199 |
| Position(y, x) | (7, 4) | (6, 5) | (5, 6) | (4, 7) | (10, 0) | (9, 1) | (8, 2) | (7, 3) |
| Scan Index | 200 | 201 | 202 | 203 | 204 | 205 | 206 | 207 |
| Position(y, x) | (6, 4) | (5, 5) | (4, 6) | (3, 7) | (9, 0) | (8, 1) | (7, 2) | (6, 3) |
| Scan Index | 208 | 209 | 210 | 211 | 212 | 213 | 214 | 215 |
| Position(y, x) | (5, 4) | (4, 5) | (3, 6) | (2, 7) | (8, 0) | (7, 1) | (6, 2) | (5, 3) |
| Scan Index | 216 | 217 | 218 | 219 | 220 | 221 | 222 | 223 |
| Position(y, x) | (4, 4) | (3, 5) | (2, 6) | (1, 7) | (7, 0) | (6, 1) | (5, 2) | (4, 3) |
| Scan Index | 224 | 225 | 226 | 227 | 228 | 229 | 230 | 231 |
| Position(y, x) | (3, 4) | (2, 5) | (1, 6) | (0, 7) | (6, 0) | (5, 1) | (4, 2) | (3, 3) |
| Scan Index | 232 | 233 | 234 | 235 | 236 | 237 | 238 | 239 |
| Position(y, x) | (2, 4) | (1, 5) | (0, 6) | (5, 0) | (4, 1) | (3, 2) | (2, 3) | (1, 4) |
| Scan Index | 240 | 241 | 242 | 243 | 244 | 245 | 246 | 247 |
| Position(y, x) | (0, 5) | (4, 0) | (3, 1) | (2, 2) | (1, 3) | (0, 4) | (3, 0) | (2, 1) |
| Scan Index | 248 | 249 | 250 | 251 | 252 | 253 | 254 | 255 |
| Position(y, x) | (1, 2) | (0, 3) | (2, 0) | (1, 1) | (0, 2) | (1, 0) | (0, 1) | (0, 0) |

Reverse Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (31, 7) | (30, 7) | (31, 6) | (29, 7) | (30, 6) | (31, 5) | (28, 7) | (29, 6) |
| Scan Index | 8 | 9 | 10 | 11 | 12 | 13 | 14 | 15 |
| Position(y, x) | (30, 5) | (31, 4) | (27, 7) | (28, 6) | (29, 5) | (30, 4) | (31, 3) | (26, 7) |
| Scan Index | 16 | 17 | 18 | 19 | 20 | 21 | 22 | 23 |
| Position(y, x) | (27, 6) | (28, 5) | (29, 4) | (30, 3) | (31, 2) | (25, 7) | (26, 6) | (27, 5) |
| Scan Index | 24 | 25 | 26 | 27 | 28 | 29 | 30 | 31 |
| Position(y, x) | (28, 4) | (29, 3) | (30, 2) | (31, 1) | (24, 7) | (25, 6) | (26, 5) | (27, 4) |
| Scan Index | 32 | 33 | 34 | 35 | 36 | 37 | 38 | 39 |
| Position(y, x) | (28, 3) | (29, 2) | (30, 1) | (31, 0) | (23, 7) | (24, 6) | (25, 5) | (26, 4) |
| Scan Index | 40 | 41 | 42 | 43 | 44 | 45 | 46 | 47 |
| Position(y, x) | (27, 3) | (28, 2) | (29, 1) | (30, 0) | (22, 7) | (23, 6) | (24, 5) | (25, 4) |
| Scan Index | 48 | 49 | 50 | 51 | 52 | 53 | 54 | 55 |
| Position(y, x) | (26, 3) | (27, 2) | (28, 1) | (29, 0) | (21, 7) | (22, 6) | (23, 5) | (24, 4) |
| Scan Index | 56 | 57 | 58 | 59 | 60 | 61 | 62 | 63 |
| Position(y, x) | (25, 3) | (26, 2) | (27, 1) | (28, 0) | (20, 7) | (21, 6) | (22, 5) | (23, 4) |
| Scan Index | 64 | 65 | 66 | 67 | 68 | 69 | 70 | 71 |
| Position(y, x) | (24, 3) | (25, 2) | (26, 1) | (27, 0) | (19, 7) | (20, 6) | (21, 5) | (22, 4) |
| Scan Index | 72 | 73 | 74 | 75 | 76 | 77 | 78 | 79 |
| Position(y, x) | (23, 3) | (24, 2) | (25, 1) | (26, 0) | (18, 7) | (19, 6) | (20, 5) | (21, 4) |
| Scan Index | 80 | 81 | 82 | 83 | 84 | 85 | 86 | 87 |
| Position(y, x) | (22, 3) | (23, 2) | (24, 1) | (25, 0) | (17, 7) | (18, 6) | (19, 5) | (20, 4) |
| Scan Index | 88 | 89 | 90 | 91 | 92 | 93 | 94 | 95 |
| Position(y, x) | (21, 3) | (22, 2) | (23, 1) | (24, 0) | (16, 7) | (17, 6) | (18, 5) | (19, 4) |
| Scan Index | 96 | 97 | 98 | 99 | 100 | 101 | 102 | 103 |
| Position(y, x) | (20, 3) | (21, 2) | (22, 1) | (23, 0) | (15, 7) | (16, 6) | (17, 5) | (18, 4) |
| Scan Index | 104 | 105 | 106 | 107 | 108 | 109 | 110 | 111 |
| Position(y, x) | (19, 3) | (20, 2) | (21, 1) | (22, 0) | (14, 7) | (15, 6) | (16, 5) | (17, 4) |
| Scan Index | 112 | 113 | 114 | 115 | 116 | 117 | 118 | 119 |
| Position(y, x) | (18, 3) | (19, 2) | (20, 1) | (21, 0) | (13, 7) | (14, 6) | (15, 5) | (16, 4) |
| Scan Index | 120 | 121 | 122 | 123 | 124 | 125 | 126 | 127 |
| Position(y, x) | (17, 3) | (18, 2) | (19, 1) | (20, 0) | (12, 7) | (13, 6) | (14, 5) | (15, 4) |
| Scan Index | 128 | 129 | 130 | 131 | 132 | 133 | 134 | 135 |
| Position(y, x) | (16, 3) | (17, 2) | (18, 1) | (19, 0) | (11, 7) | (12, 6) | (13, 5) | (14, 4) |
| Scan Index | 136 | 137 | 138 | 139 | 140 | 141 | 142 | 143 |
| Position(y, x) | (15, 3) | (16, 2) | (17, 1) | (18, 0) | (10, 7) | (11, 6) | (12, 5) | (13, 4) |
| Scan Index | 144 | 145 | 146 | 147 | 148 | 149 | 150 | 151 |
| Position(y, x) | (14, 3) | (15, 2) | (16, 1) | (17, 0) | (9, 7) | (10, 6) | (11, 5) | (12, 4) |
| Scan Index | 152 | 153 | 154 | 155 | 156 | 157 | 158 | 159 |
| Position(y, x) | (13, 3) | (14, 2) | (15, 1) | (16, 0) | (8, 7) | (9, 6) | (10, 5) | (11, 4) |
| Scan Index | 160 | 161 | 162 | 163 | 164 | 165 | 166 | 167 |
| Position(y, x) | (12, 3) | (13, 2) | (14, 1) | (15, 0) | (7, 7) | (8, 6) | (9, 5) | (10, 4) |
| Scan Index | 168 | 169 | 170 | 171 | 172 | 173 | 174 | 175 |
| Position(y, x) | (11, 3) | (12, 2) | (13, 1) | (14, 0) | (6, 7) | (7, 6) | (8, 5) | (9, 4) |
| Scan Index | 176 | 177 | 178 | 179 | 180 | 181 | 182 | 183 |
| Position(y, x) | (10, 3) | (11, 2) | (12, 1) | (13, 0) | (5, 7) | (6, 6) | (7, 5) | (8, 4) |
| Scan Index | 184 | 185 | 186 | 187 | 188 | 189 | 190 | 191 |
| Position(y, x) | (9, 3) | (10, 2) | (11, 1) | (12, 0) | (4, 7) | (5, 6) | (6, 5) | (7, 4) |
| Scan Index | 192 | 193 | 194 | 195 | 196 | 197 | 198 | 199 |
| Position(y, x) | (8, 3) | (9, 2) | (10, 1) | (11, 0) | (3, 7) | (4, 6) | (5, 5) | (6, 4) |
| Scan Index | 200 | 201 | 202 | 203 | 204 | 205 | 206 | 207 |
| Position(y, x) | (7, 3) | (8, 2) | (9, 1) | (10, 0) | (2, 7) | (3, 6) | (4, 5) | (5, 4) |
| Scan Index | 208 | 209 | 210 | 211 | 212 | 213 | 214 | 215 |
| Position(y, x) | (6, 3) | (7, 2) | (8, 1) | (9, 0) | (1, 7) | (2, 6) | (3, 5) | (4, 4) |
| Scan Index | 216 | 217 | 218 | 219 | 220 | 221 | 222 | 223 |
| Position(y, x) | (5, 3) | (6, 2) | (7, 1) | (8, 0) | (0, 7) | (1, 6) | (2, 5) | (3, 4) |
| Scan Index | 224 | 225 | 226 | 227 | 228 | 229 | 230 | 231 |
| Position(y, x) | (4, 3) | (5, 2) | (6, 1) | (7, 0) | (0, 6) | (1, 5) | (2, 4) | (3, 3) |
| Scan Index | 232 | 233 | 234 | 235 | 236 | 237 | 238 | 239 |
| Position(y, x) | (4, 2) | (5, 1) | (6, 0) | (0, 5) | (1, 4) | (2, 3) | (3, 2) | (4, 1) |
| Scan Index | 240 | 241 | 242 | 243 | 244 | 245 | 246 | 247 |
| Position(y, x) | (5, 0) | (0, 4) | (1, 3) | (2, 2) | (3, 1) | (4, 0) | (0, 3) | (1, 2) |
| Scan Index | 248 | 249 | 250 | 251 | 252 | 253 | 254 | 255 |
| Position(y, x) | (2, 1) | (3, 0) | (0, 2) | (1, 1) | (2, 0) | (0, 1) | (1, 0) | (0, 0) |

Example for Whole 32×16 Wavefront Scan Pattern

TABLE 11
Whole 32 × 16 wavefront scan pattern
Forward Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (0, 0) | (1, 0) | (0, 1) | (2, 0) | (1, 1) | (0, 2) | (3, 0) | (2, 1) |
| Scan Index | 8 | 9 | 10 | 11 | 12 | 13 | 14 | 15 |
| Position(y, x) | (1, 2) | (0, 3) | (4, 0) | (3, 1) | (2, 2) | (1, 3) | (0, 4) | (5, 0) |
| Scan Index | 16 | 17 | 18 | 19 | 20 | 21 | 22 | 23 |
| Position(y, x) | (4, 1) | (3, 2) | (2, 3) | (1, 4) | (0, 5) | (6, 0) | (5, 1) | (4, 2) |
| Scan Index | 24 | 25 | 26 | 27 | 28 | 29 | 30 | 31 |
| Position(y, x) | (3, 3) | (2, 4) | (1, 5) | (0, 6) | (7, 0) | (6, 1) | (5, 2) | (4, 3) |
| Scan Index | 32 | 33 | 34 | 35 | 36 | 37 | 38 | 39 |
| Position(y, x) | (3, 4) | (2, 5) | (1, 6) | (0, 7) | (8, 0) | (7, 1) | (6, 2) | (5, 3) |
| Scan Index | 40 | 41 | 42 | 43 | 44 | 45 | 46 | 47 |
| Position(y, x) | (4, 4) | (3, 5) | (2, 6) | (1, 7) | (0, 8) | (9, 0) | (8, 1) | (7, 2) |
| Scan Index | 48 | 49 | 50 | 51 | 52 | 53 | 54 | 55 |
| Position(y, x) | (6, 3) | (5, 4) | (4, 5) | (3, 6) | (2, 7) | (1, 8) | (0, 9) | (10, 0) |
| Scan Index | 56 | 57 | 58 | 59 | 60 | 61 | 62 | 63 |
| Position(y, x) | (9, 1) | (8, 2) | (7, 3) | (6, 4) | (5, 5) | (4, 6) | (3, 7) | (2, 8) |
| Scan Index | 64 | 65 | 66 | 67 | 68 | 69 | 70 | 71 |
| Position(y, x) | (1, 9) | (0, 10) | (11, 0) | (10, 1) | (9, 2) | (8, 3) | (7, 4) | (6, 5) |
| Scan Index | 72 | 73 | 74 | 75 | 76 | 77 | 78 | 79 |
| Position(y, x) | (5, 6) | (4, 7) | (3, 8) | (2, 9) | (1, 10) | (0, 11) | (12, 0) | (11, 1) |
| Scan Index | 80 | 81 | 82 | 83 | 84 | 85 | 86 | 87 |
| Position(y, x) | (10, 2) | (9, 3) | (8, 4) | (7, 5) | (6, 6) | (5, 7) | (4, 8) | (3, 9) |
| Scan Index | 88 | 89 | 90 | 91 | 92 | 93 | 94 | 95 |
| Position(y, x) | (2, 10) | (1, 11) | (0, 12) | (13, 0) | (12, 1) | (11, 2) | (10, 3) | (9, 4) |
| Scan Index | 96 | 97 | 98 | 99 | 100 | 101 | 102 | 103 |
| Position(y, x) | (8, 5) | (7, 6) | (6, 7) | (5, 8) | (4, 9) | (3, 10) | (2, 11) | (1, 12) |
| Scan Index | 104 | 105 | 106 | 107 | 108 | 109 | 110 | 111 |
| Position(y, x) | (0, 13) | (14, 0) | (13, 1) | (12, 2) | (11, 3) | (10, 4) | (9, 5) | (8, 6) |
| Scan Index | 112 | 113 | 114 | 115 | 116 | 117 | 118 | 119 |
| Position(y, x) | (7, 7) | (6, 8) | (5, 9) | (4, 10) | (3, 11) | (2, 12) | (1, 13) | (0, 14) |
| Scan Index | 120 | 121 | 122 | 123 | 124 | 125 | 126 | 127 |
| Position(y, x) | (15, 0) | (14, 1) | (13, 2) | (12, 3) | (11, 4) | (10, 5) | (9, 6) | (8, 7) |
| Scan Index | 128 | 129 | 130 | 131 | 132 | 133 | 134 | 135 |
| Position(y, x) | (7, 8) | (6, 9) | (5, 10) | (4, 11) | (3, 12) | (2, 13) | (1, 14) | (0, 15) |
| Scan Index | 136 | 137 | 138 | 139 | 140 | 141 | 142 | 143 |
| Position(y, x) | (15, 1) | (14, 2) | (13, 3) | (12, 4) | (11, 5) | (10, 6) | (9, 7) | (8, 8) |
| Scan Index | 144 | 145 | 146 | 147 | 148 | 149 | 150 | 151 |
| Position(y, x) | (7, 9) | (6, 10) | (5, 11) | (4, 12) | (3, 13) | (2, 14) | (1, 15) | (0, 16) |
| Scan Index | 152 | 153 | 154 | 155 | 156 | 157 | 158 | 159 |
| Position(y, x) | (15, 2) | (14, 3) | (13, 4) | (12, 5) | (11, 6) | (10, 7) | (9, 8) | (8, 9) |
| Scan Index | 160 | 161 | 162 | 163 | 164 | 165 | 166 | 167 |
| Position(y, x) | (7, 10) | (6, 11) | (5, 12) | (4, 13) | (3, 14) | (2, 15) | (1, 16) | (0, 17) |
| Scan Index | 168 | 169 | 170 | 171 | 172 | 173 | 174 | 175 |
| Position(y, x) | (15, 3) | (14, 4) | (13, 5) | (12, 6) | (11, 7) | (10, 8) | (9, 9) | (8, 10) |
| Scan Index | 176 | 177 | 178 | 179 | 180 | 181 | 182 | 183 |
| Position(y, x) | (7, 11) | (6, 12) | (5, 13) | (4, 14) | (3, 15) | (2, 16) | (1, 17) | (0, 18) |
| Scan Index | 184 | 185 | 186 | 187 | 188 | 189 | 190 | 191 |
| Position(y, x) | (15, 4) | (14, 5) | (13, 6) | (12, 7) | (11, 8) | (10, 9) | (9, 10) | (8, 11) |
| Scan Index | 192 | 193 | 194 | 195 | 196 | 197 | 198 | 199 |
| Position(y, x) | (7, 12) | (6, 13) | (5, 14) | (4, 15) | (3, 16) | (2, 17) | (1, 18) | (0, 19) |
| Scan Index | 200 | 201 | 202 | 203 | 204 | 205 | 206 | 207 |
| Position(y, x) | (15, 5) | (14, 6) | (13, 7) | (12, 8) | (11, 9) | (10, 10) | (9, 11) | (8, 12) |
| Scan Index | 208 | 209 | 210 | 211 | 212 | 213 | 214 | 215 |
| Position(y, x) | (7, 13) | (6, 14) | (5, 15) | (4, 16) | (3, 17) | (2, 18) | (1, 19) | (0, 20) |
| Scan Index | 216 | 217 | 218 | 219 | 220 | 221 | 222 | 223 |
| Position(y, x) | (15, 6) | (14, 7) | (13, 8) | (12, 9) | (11, 10) | (10, 11) | (9, 12) | (8, 13) |
| Scan Index | 224 | 225 | 226 | 227 | 228 | 229 | 230 | 231 |
| Position(y, x) | (7, 14) | (6, 15) | (5, 16) | (4, 17) | (3, 18) | (2, 19) | (1, 20) | (0, 21) |
| Scan Index | 232 | 233 | 234 | 235 | 236 | 237 | 238 | 239 |
| Position(y, x) | (15, 7) | (14, 8) | (13, 9) | (12, 10) | (11, 11) | (10, 12) | (9, 13) | (8, 14) |
| Scan Index | 240 | 241 | 242 | 243 | 244 | 245 | 246 | 247 |
| Position(y, x) | (7, 15) | (6, 16) | (5, 17) | (4, 18) | (3, 19) | (2, 20) | (1, 21) | (0, 22) |
| Scan Index | 248 | 249 | 250 | 251 | 252 | 253 | 254 | 255 |
| Position(y, x) | (15, 8) | (14, 9) | (13, 10) | (12, 11) | (11, 12) | (10, 13) | (9, 14) | (8, 15) |
| Scan Index | 256 | 257 | 258 | 259 | 260 | 261 | 262 | 263 |
| Position(y, x) | (7, 16) | (6, 17) | (5, 18) | (4, 19) | (3, 20) | (2, 21) | (1, 22) | (0, 23) |
| Scan Index | 264 | 265 | 266 | 267 | 268 | 269 | 270 | 271 |
| Position(y, x) | (15, 9) | (14, 10) | (13, 11) | (12, 12) | (11, 13) | (10, 14) | (9, 15) | (8, 16) |
| Scan Index | 272 | 273 | 274 | 275 | 276 | 277 | 278 | 279 |
| Position(y, x) | (7, 17) | (6, 18) | (5, 19) | (4, 20) | (3, 21) | (2, 22) | (1, 23) | (0, 24) |
| Scan Index | 280 | 281 | 282 | 283 | 284 | 285 | 286 | 287 |
| Position(y, x) | (15, 10) | (14, 11) | (13, 12) | (12, 13) | (11, 14) | (10, 15) | (9, 16) | (8, 17) |
| Scan Index | 288 | 289 | 290 | 291 | 292 | 293 | 294 | 295 |
| Position(y, x) | (7, 18) | (6, 19) | (5, 20) | (4, 21) | (3, 22) | (2, 23) | (1, 24) | (0, 25) |
| Scan Index | 296 | 297 | 298 | 299 | 300 | 301 | 302 | 303 |
| Position(y, x) | (15, 11) | (14, 12) | (13, 13) | (12, 14) | (11, 15) | (10, 16) | (9, 17) | (8, 18) |
| Scan Index | 304 | 305 | 306 | 307 | 308 | 309 | 310 | 311 |
| Position(y, x) | (7, 19) | (6, 20) | (5, 21) | (4, 22) | (3, 23) | (2, 24) | (1, 25) | (0, 26) |
| Scan Index | 312 | 313 | 314 | 315 | 316 | 317 | 318 | 319 |
| Position(y, x) | (15, 12) | (14, 13) | (13, 14) | (12, 15) | (11, 16) | (10, 17) | (9, 18) | (8, 19) |
| Scan Index | 320 | 321 | 322 | 323 | 324 | 325 | 326 | 327 |
| Position(y, x) | (7, 20) | (6, 21) | (5, 22) | (4, 23) | (3, 24) | (2, 25) | (1, 26) | (0, 27) |
| Scan Index | 328 | 329 | 330 | 331 | 332 | 333 | 334 | 335 |
| Position(y, x) | (15, 13) | (14, 14) | (13, 15) | (12, 16) | (11, 17) | (10, 18) | (9, 19) | (8, 20) |
| Scan Index | 336 | 337 | 338 | 339 | 340 | 341 | 342 | 343 |
| Position(y, x) | (7, 21) | (6, 22) | (5, 23) | (4, 24) | (3, 25) | (2, 26) | (1, 27) | (0, 28) |
| Scan Index | 344 | 345 | 346 | 347 | 348 | 349 | 350 | 351 |
| Position(y, x) | (15, 14) | (14, 15) | (13, 16) | (12, 17) | (11, 18) | (10, 19) | (9, 20) | (8, 21) |
| Scan Index | 352 | 353 | 354 | 355 | 356 | 357 | 358 | 359 |
| Position(y, x) | (7, 22) | (6, 23) | (5, 24) | (4, 25) | (3, 26) | (2, 27) | (1, 28) | (0, 29) |
| Scan Index | 360 | 361 | 362 | 363 | 364 | 365 | 366 | 367 |
| Position(y, x) | (15, 15) | (14, 16) | (13, 17) | (12, 18) | (11, 19) | (10, 20) | (9, 21) | (8, 22) |
| Scan Index | 368 | 369 | 370 | 371 | 372 | 373 | 374 | 375 |
| Position(y, x) | (7, 23) | (6, 24) | (5, 25) | (4, 26) | (3, 27) | (2, 28) | (1, 29) | (0, 30) |
| Scan Index | 376 | 377 | 378 | 379 | 380 | 381 | 382 | 383 |
| Position(y, x) | (15, 16) | (14, 17) | (13, 18) | (12, 19) | (11, 20) | (10, 21) | (9, 22) | (8, 23) |
| Scan Index | 384 | 385 | 386 | 387 | 388 | 389 | 390 | 391 |
| Position(y, x) | (7, 24) | (6, 25) | (5, 26) | (4, 27) | (3, 28) | (2, 29) | (1, 30) | (0, 31) |
| Scan Index | 392 | 393 | 394 | 395 | 396 | 397 | 398 | 399 |
| Position(y, x) | (15, 17) | (14, 18) | (13, 19) | (12, 20) | (11, 21) | (10, 22) | (9, 23) | (8, 24) |
| Scan Index | 400 | 401 | 402 | 403 | 404 | 405 | 406 | 407 |
| Position(y, x) | (7, 25) | (6, 26) | (5, 27) | (4, 28) | (3, 29) | (2, 30) | (1, 31) | (15, 18) |
| Scan Index | 408 | 409 | 410 | 411 | 412 | 413 | 414 | 415 |
| Position(y, x) | (14, 19) | (13, 20) | (12, 21) | (11, 22) | (10, 23) | (9, 24) | (8, 25) | (7, 26) |
| Scan Index | 416 | 417 | 418 | 419 | 420 | 421 | 422 | 423 |
| Position(y, x) | (6, 27) | (5, 28) | (4, 29) | (3, 30) | (2, 31) | (15, 19) | (14, 20) | (13, 21) |
| Scan Index | 424 | 425 | 426 | 427 | 428 | 429 | 430 | 431 |
| Position(y, x) | (12, 22) | (11, 23) | (10, 24) | (9, 25) | (8, 26) | (7, 27) | (6, 28) | (5, 29) |
| Scan Index | 432 | 433 | 434 | 435 | 436 | 437 | 438 | 439 |
| Position(y, x) | (4, 30) | (3, 31) | (15, 20) | (14, 21) | (13, 22) | (12, 23) | (11, 24) | (10, 25) |
| Scan Index | 440 | 441 | 442 | 443 | 444 | 445 | 446 | 447 |
| Position(y, x) | (9, 26) | (8, 27) | (7, 28) | (6, 29) | (5, 30) | (4, 31) | (15, 21) | (14, 22) |
| Scan Index | 448 | 449 | 450 | 451 | 452 | 453 | 454 | 455 |
| Position(y, x) | (13, 23) | (12, 24) | (11, 25) | (10, 26) | (9, 27) | (8, 28) | (7, 29) | (6, 30) |
| Scan Index | 456 | 457 | 458 | 459 | 460 | 461 | 462 | 463 |
| Position(y, x) | (5, 31) | (15, 22) | (14, 23) | (13, 24) | (12, 25) | (11, 26) | (10, 27) | (9, 28) |
| Scan Index | 464 | 465 | 466 | 467 | 468 | 469 | 470 | 471 |
| Position(y, x) | (8, 29) | (7, 30) | (6, 31) | (15, 23) | (14, 24) | (13, 25) | (12, 26) | (11, 27) |
| Scan Index | 472 | 473 | 474 | 475 | 476 | 477 | 478 | 479 |
| Position(y, x) | (10, 28) | (9, 29) | (8, 30) | (7, 31) | (15, 24) | (14, 25) | (13, 26) | (12, 27) |
| Scan Index | 480 | 481 | 482 | 483 | 484 | 485 | 486 | 487 |
| Position(y, x) | (11, 28) | (10, 29) | (9, 30) | (8, 31) | (15, 25) | (14, 26) | (13, 27) | (12, 28) |
| Scan Index | 488 | 489 | 490 | 491 | 492 | 493 | 494 | 495 |
| Position(y, x) | (11, 29) | (10, 30) | (9, 31) | (15, 26) | (14, 27) | (13, 28) | (12, 29) | (11, 30) |
| Scan Index | 496 | 497 | 498 | 499 | 500 | 501 | 502 | 503 |
| Position(y, x) | (10, 31) | (15, 27) | (14, 28) | (13, 29) | (12, 30) | (11, 31) | (15, 28) | (14, 29) |
| Scan Index | 504 | 505 | 506 | 507 | 508 | 509 | 510 | 511 |
| Position(y, x) | (13, 30) | (12, 31) | (15, 29) | (14, 30) | (13, 31) | (15, 30) | (14, 31) | (15, 31) |

Forward Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (0, 0) | (0, 1) | (1, 0) | (0, 2) | (1, 1) | (2, 0) | (0, 3) | (1, 2) |
| Scan Index | 8 | 9 | 10 | 11 | 12 | 13 | 14 | 15 |
| Position(y, x) | (2, 1) | (3, 0) | (0, 4) | (1, 3) | (2, 2) | (3, 1) | (4, 0) | (0, 5) |
| Scan Index | 16 | 17 | 18 | 19 | 20 | 21 | 22 | 23 |
| Position(y, x) | (1, 4) | (2, 3) | (3, 2) | (4, 1) | (5, 0) | (0, 6) | (1, 5) | (2, 4) |
| Scan Index | 24 | 25 | 26 | 27 | 28 | 29 | 30 | 31 |
| Position(y, x) | (3, 3) | (4, 2) | (5, 1) | (6, 0) | (0, 7) | (1, 6) | (2, 5) | (3, 4) |
| Scan Index | 32 | 33 | 34 | 35 | 36 | 37 | 38 | 39 |
| Position(y, x) | (4, 3) | (5, 2) | (6, 1) | (7, 0) | (0, 8) | (1, 7) | (2, 6) | (3, 5) |
| Scan Index | 40 | 41 | 42 | 43 | 44 | 45 | 46 | 47 |
| Position(y, x) | (4, 4) | (5, 3) | (6, 2) | (7, 1) | (8, 0) | (0, 9) | (1, 8) | (2, 7) |
| Scan Index | 48 | 49 | 50 | 51 | 52 | 53 | 54 | 55 |
| Position(y, x) | (3, 6) | (4, 5) | (5, 4) | (6, 3) | (7, 2) | (8, 1) | (9, 0) | (0, 10) |
| Scan Index | 56 | 57 | 58 | 59 | 60 | 61 | 62 | 63 |
| Position(y, x) | (1, 9) | (2, 8) | (3, 7) | (4, 6) | (5, 5) | (6, 4) | (7, 3) | (8, 2) |
| Scan Index | 64 | 65 | 66 | 67 | 68 | 69 | 70 | 71 |
| Position(y, x) | (9, 1) | (10, 0) | (0, 11) | (1, 10) | (2, 9) | (3, 8) | (4, 7) | (5, 6) |
| Scan Index | 72 | 73 | 74 | 75 | 76 | 77 | 78 | 79 |
| Position(y, x) | (6, 5) | (7, 4) | (8, 3) | (9, 2) | (10, 1) | (11, 0) | (0, 12) | (1, 11) |
| Scan Index | 80 | 81 | 82 | 83 | 84 | 85 | 86 | 87 |
| Position(y, x) | (2, 10) | (3, 9) | (4, 8) | (5, 7) | (6, 6) | (7, 5) | (8, 4) | (9, 3) |
| Scan Index | 88 | 89 | 90 | 91 | 92 | 93 | 94 | 95 |
| Position(y, x) | (10, 2) | (11, 1) | (12, 0) | (0, 13) | (1, 12) | (2, 11) | (3, 10) | (4, 9) |
| Scan Index | 96 | 97 | 98 | 99 | 100 | 101 | 102 | 103 |
| Position(y, x) | (5, 8) | (6, 7) | (7, 6) | (8, 5) | (9, 4) | (10, 3) | (11, 2) | (12, 1) |
| Scan Index | 104 | 105 | 106 | 107 | 108 | 109 | 110 | 111 |
| Position(y, x) | (13, 0) | (0, 14) | (1, 13) | (2, 12) | (3, 11) | (4, 10) | (5, 9) | (6, 8) |
| Scan Index | 112 | 113 | 114 | 115 | 116 | 117 | 118 | 119 |
| Position(y, x) | (7, 7) | (8, 6) | (9, 5) | (10, 4) | (11, 3) | (12, 2) | (13, 1) | (14, 0) |
| Scan Index | 120 | 121 | 122 | 123 | 124 | 125 | 126 | 127 |
| Position(y, x) | (0, 15) | (1, 14) | (2, 13) | (3, 12) | (4, 11) | (5, 10) | (6, 9) | (7, 8) |
| Scan Index | 128 | 129 | 130 | 131 | 132 | 133 | 134 | 135 |
| Position(y, x) | (8, 7) | (9, 6) | (10, 5) | (11, 4) | (12, 3) | (13, 2) | (14, 1) | (15, 0) |
| Scan Index | 136 | 137 | 138 | 139 | 140 | 141 | 142 | 143 |
| Position(y, x) | (0, 16) | (1, 15) | (2, 14) | (3, 13) | (4, 12) | (5, 11) | (6, 10) | (7, 9) |
| Scan Index | 144 | 145 | 146 | 147 | 148 | 149 | 150 | 151 |
| Position(y, x) | (8, 8) | (9, 7) | (10, 6) | (11, 5) | (12, 4) | (13, 3) | (14, 2) | (15, 1) |
| Scan Index | 152 | 153 | 154 | 155 | 156 | 157 | 158 | 159 |
| Position(y, x) | (0, 17) | (1, 16) | (2, 15) | (3, 14) | (4, 13) | (5, 12) | (6, 11) | (7, 10) |
| Scan Index | 160 | 161 | 162 | 163 | 164 | 165 | 166 | 167 |
| Position(y, x) | (8, 9) | (9, 8) | (10, 7) | (11, 6) | (12, 5) | (13, 4) | (14, 3) | (15, 2) |
| Scan Index | 168 | 169 | 170 | 171 | 172 | 173 | 174 | 175 |
| Position(y, x) | (0, 18) | (1, 17) | (2, 16) | (3, 15) | (4, 14) | (5, 13) | (6, 12) | (7, 11) |
| Scan Index | 176 | 177 | 178 | 179 | 180 | 181 | 182 | 183 |
| Position(y, x) | (8, 10) | (9, 9) | (10, 8) | (11, 7) | (12, 6) | (13, 5) | (14, 4) | (15, 3) |
| Scan Index | 184 | 185 | 186 | 187 | 188 | 189 | 190 | 191 |
| Position(y, x) | (0, 19) | (1, 18) | (2, 17) | (3, 16) | (4, 15) | (5, 14) | (6, 13) | (7, 12) |
| Scan Index | 192 | 193 | 194 | 195 | 196 | 197 | 198 | 199 |
| Position(y, x) | (8, 11) | (9, 10) | (10, 9) | (11, 8) | (12, 7) | (13, 6) | (14, 5) | (15, 4) |
| Scan Index | 200 | 201 | 202 | 203 | 204 | 205 | 206 | 207 |
| Position(y, x) | (0, 20) | (1, 19) | (2, 18) | (3, 17) | (4, 16) | (5, 15) | (6, 14) | (7, 13) |
| Scan Index | 208 | 209 | 210 | 211 | 212 | 213 | 214 | 215 |
| Position(y, x) | (8, 12) | (9, 11) | (10, 10) | (11, 9) | (12, 8) | (13, 7) | (14, 6) | (15, 5) |
| Scan Index | 216 | 217 | 218 | 219 | 220 | 221 | 222 | 223 |
| Position(y, x) | (0, 21) | (1, 20) | (2, 19) | (3, 18) | (4, 17) | (5, 16) | (6, 15) | (7, 14) |
| Scan Index | 224 | 225 | 226 | 227 | 228 | 229 | 230 | 231 |
| Position(y, x) | (8, 13) | (9, 12) | (10, 11) | (11, 10) | (12, 9) | (13, 8) | (14, 7) | (15, 6) |
| Scan Index | 232 | 233 | 234 | 235 | 236 | 237 | 238 | 239 |
| Position(y, x) | (0, 22) | (1, 21) | (2, 20) | (3, 19) | (4, 18) | (5, 17) | (6, 16) | (7, 15) |
| Scan Index | 240 | 241 | 242 | 243 | 244 | 245 | 246 | 247 |
| Position(y, x) | (8, 14) | (9, 13) | (10, 12) | (11, 11) | (12, 10) | (13, 9) | (14, 8) | (15, 7) |
| Scan Index | 248 | 249 | 250 | 251 | 252 | 253 | 254 | 255 |
| Position(y, x) | (0, 23) | (1, 22) | (2, 21) | (3, 20) | (4, 19) | (5, 18) | (6, 17) | (7, 16) |
| Scan Index | 256 | 257 | 258 | 259 | 260 | 261 | 262 | 263 |
| Position(y, x) | (8, 15) | (9, 14) | (10, 13) | (11, 12) | (12, 11) | (13, 10) | (14, 9) | (15, 8) |
| Scan Index | 264 | 265 | 266 | 267 | 268 | 269 | 270 | 271 |
| Position(y, x) | (0, 24) | (1, 23) | (2, 22) | (3, 21) | (4, 20) | (5, 19) | (6, 18) | (7, 17) |
| Scan Index | 272 | 273 | 274 | 275 | 276 | 277 | 278 | 279 |
| Position(y, x) | (8, 16) | (9, 15) | (10, 14) | (11, 13) | (12, 12) | (13, 11) | (14, 10) | (15, 9) |
| Scan Index | 280 | 281 | 282 | 283 | 284 | 285 | 286 | 287 |
| Position(y, x) | (0, 25) | (1, 24) | (2, 23) | (3, 22) | (4, 21) | (5, 20) | (6, 19) | (7, 18) |
| Scan Index | 288 | 289 | 290 | 291 | 292 | 293 | 294 | 295 |
| Position(y, x) | (8, 17) | (9, 16) | (10, 15) | (11, 14) | (12, 13) | (13, 12) | (14, 11) | (15, 10) |
| Scan Index | 296 | 297 | 298 | 299 | 300 | 301 | 302 | 303 |
| Position(y, x) | (0, 26) | (1, 25) | (2, 24) | (3, 23) | (4, 22) | (5, 21) | (6, 20) | (7, 19) |
| Scan Index | 304 | 305 | 306 | 307 | 308 | 309 | 310 | 311 |
| Position(y, x) | (8, 18) | (9, 17) | (10, 16) | (11, 15) | (12, 14) | (13, 13) | (14, 12) | (15, 11) |
| Scan Index | 312 | 313 | 314 | 315 | 316 | 317 | 318 | 319 |
| Position(y, x) | (0, 27) | (1, 26) | (2, 25) | (3, 24) | (4, 23) | (5, 22) | (6, 21) | (7, 20) |
| Scan Index | 320 | 321 | 322 | 323 | 324 | 325 | 326 | 327 |
| Position(y, x) | (8, 19) | (9, 18) | (10, 17) | (11, 16) | (12, 15) | (13, 14) | (14, 13) | (15, 12) |
| Scan Index | 328 | 329 | 330 | 331 | 332 | 333 | 334 | 335 |
| Position(y, x) | (0, 28) | (1, 27) | (2, 26) | (3, 25) | (4, 24) | (5, 23) | (6, 22) | (7, 21) |
| Scan Index | 336 | 337 | 338 | 339 | 340 | 341 | 342 | 343 |
| Position(y, x) | (8, 20) | (9, 19) | (10, 18) | (11, 17) | (12, 16) | (13, 15) | (14, 14) | (15, 13) |
| Scan Index | 344 | 345 | 346 | 347 | 348 | 349 | 350 | 351 |
| Position(y, x) | (0, 29) | (1, 28) | (2, 27) | (3, 26) | (4, 25) | (5, 24) | (6, 23) | (7, 22) |
| Scan Index | 352 | 353 | 354 | 355 | 356 | 357 | 358 | 359 |
| Position(y, x) | (8, 21) | (9, 20) | (10, 19) | (11, 18) | (12, 17) | (13, 16) | (14, 15) | (15, 14) |
| Scan Index | 360 | 361 | 362 | 363 | 364 | 365 | 366 | 367 |
| Position(y, x) | (0, 30) | (1, 29) | (2, 28) | (3, 27) | (4, 26) | (5, 25) | (6, 24) | (7, 23) |
| Scan Index | 368 | 369 | 370 | 371 | 372 | 373 | 374 | 375 |
| Position(y, x) | (8, 22) | (9, 21) | (10, 20) | (11, 19) | (12, 18) | (13, 17) | (14, 16) | (15, 15) |
| Scan Index | 376 | 377 | 378 | 379 | 380 | 381 | 382 | 383 |
| Position(y, x) | (0, 31) | (1, 30) | (2, 29) | (3, 28) | (4, 27) | (5, 26) | (6, 25) | (7, 24) |
| Scan Index | 384 | 385 | 386 | 387 | 388 | 389 | 390 | 391 |
| Position(y, x) | (8, 23) | (9, 22) | (10, 21) | (11, 20) | (12, 19) | (13, 18) | (14, 17) | (15, 16) |
| Scan Index | 392 | 393 | 394 | 395 | 396 | 397 | 398 | 399 |
| Position(y, x) | (1, 31) | (2, 30) | (3, 29) | (4, 28) | (5, 27) | (6, 26) | (7, 25) | (8, 24) |
| Scan Index | 400 | 401 | 402 | 403 | 404 | 405 | 406 | 407 |
| Position(y, x) | (9, 23) | (10, 22) | (11, 21) | (12, 20) | (13, 19) | (14, 18) | (15, 17) | (2, 31) |
| Scan Index | 408 | 409 | 410 | 411 | 412 | 413 | 414 | 415 |
| Position(y, x) | (3, 30) | (4, 29) | (5, 28) | (6, 27) | (7, 26) | (8, 25) | (9, 24) | (10, 23) |
| Scan Index | 416 | 417 | 418 | 419 | 420 | 421 | 422 | 423 |
| Position(y, x) | (11, 22) | (12, 21) | (13, 20) | (14, 19) | (15, 18) | (3, 31) | (4, 30) | (5, 29) |
| Scan Index | 424 | 425 | 426 | 427 | 428 | 429 | 430 | 431 |
| Position(y, x) | (6, 28) | (7, 27) | (8, 26) | (9, 25) | (10, 24) | (11, 23) | (12, 22) | (13, 21) |
| Scan Index | 432 | 433 | 434 | 435 | 436 | 437 | 438 | 439 |
| Position(y, x) | (14, 20) | (15, 19) | (4, 31) | (5, 30) | (6, 29) | (7, 28) | (8, 27) | (9, 26) |
| Scan Index | 440 | 441 | 442 | 443 | 444 | 445 | 446 | 447 |
| Position(y, x) | (10, 25) | (11, 24) | (12, 23) | (13, 22) | (14, 21) | (15, 20) | (5, 31) | (6, 30) |
| Scan Index | 448 | 449 | 450 | 451 | 452 | 453 | 454 | 455 |
| Position(y, x) | (7, 29) | (8, 28) | (9, 27) | (10, 26) | (11, 25) | (12, 24) | (13, 23) | (14, 22) |
| Scan Index | 456 | 457 | 458 | 459 | 460 | 461 | 462 | 463 |
| Position(y, x) | (15, 21) | (6, 31) | (7, 30) | (8, 29) | (9, 28) | (10, 27) | (11, 26) | (12, 25) |
| Scan Index | 464 | 465 | 466 | 467 | 468 | 469 | 470 | 471 |
| Position(y, x) | (13, 24) | (14, 23) | (15, 22) | (7, 31) | (8, 30) | (9, 29) | (10, 28) | (11, 27) |
| Scan Index | 472 | 473 | 474 | 475 | 476 | 477 | 478 | 479 |
| Position(y, x) | (12, 26) | (13, 25) | (14, 24) | (15, 23) | (8, 31) | (9, 30) | (10, 29) | (11, 28) |
| Scan Index | 480 | 481 | 482 | 483 | 484 | 485 | 486 | 487 |
| Position(y, x) | (12, 27) | (13, 26) | (14, 25) | (15, 24) | (9, 31) | (10, 30) | (11, 29) | (12, 28) |
| Scan Index | 488 | 489 | 490 | 491 | 492 | 493 | 494 | 495 |
| Position(y, x) | (13, 27) | (14, 26) | (15, 25) | (10, 31) | (11, 30) | (12, 29) | (13, 28) | (14, 27) |
| Scan Index | 496 | 497 | 498 | 499 | 500 | 501 | 502 | 503 |
| Position(y, x) | (15, 26) | (11, 31) | (12, 30) | (13, 29) | (14, 28) | (15, 27) | (12, 31) | (13, 30) |
| Scan Index | 504 | 505 | 506 | 507 | 508 | 509 | 510 | 511 |
| Position(y, x) | (14, 29) | (15, 28) | (13, 31) | (14, 30) | (15, 29) | (14, 31) | (15, 30) | (15, 31) |

Reverse Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (15, 31) | (15, 30) | (14, 31) | (15, 29) | (14, 30) | (13, 31) | (15, 28) | (14, 29) |
| Scan Index | 8 | 9 | 10 | 11 | 12 | 13 | 14 | 15 |
| Position(y, x) | (13, 30) | (12, 31) | (15, 27) | (14, 28) | (13, 29) | (12, 30) | (11, 31) | (15, 26) |
| Scan Index | 16 | 17 | 18 | 19 | 20 | 21 | 22 | 23 |
| Position(y, x) | (14, 27) | (13, 28) | (12, 29) | (11, 30) | (10, 31) | (15, 25) | (14, 26) | (13, 27) |
| Scan Index | 24 | 25 | 26 | 27 | 28 | 29 | 30 | 31 |
| Position(y, x) | (12, 28) | (11, 29) | (10, 30) | (9, 31) | (15, 24) | (14, 25) | (13, 26) | (12, 27) |
| Scan Index | 32 | 33 | 34 | 35 | 36 | 37 | 38 | 39 |
| Position(y, x) | (11, 28) | (10, 29) | (9, 30) | (8, 31) | (15, 23) | (14, 24) | (13, 25) | (12, 26) |
| Scan Index | 40 | 41 | 42 | 43 | 44 | 45 | 46 | 47 |
| Position(y, x) | (11, 27) | (10, 28) | (9, 29) | (8, 30) | (7, 31) | (15, 22) | (14, 23) | (13, 24) |
| Scan Index | 48 | 49 | 50 | 51 | 52 | 53 | 54 | 55 |
| Position(y, x) | (12, 25) | (11, 26) | (10, 27) | (9, 28) | (8, 29) | (7, 30) | (6, 31) | (15, 21) |
| Scan Index | 56 | 57 | 58 | 59 | 60 | 61 | 62 | 63 |
| Position(y, x) | (14, 22) | (13, 23) | (12, 24) | (11, 25) | (10, 26) | (9, 27) | (8, 28) | (7, 29) |
| Scan Index | 64 | 65 | 66 | 67 | 68 | 69 | 70 | 71 |
| Position(y, x) | (6, 30) | (5, 31) | (15, 20) | (14, 21) | (13, 22) | (12, 23) | (11, 24) | (10, 25) |
| Scan Index | 72 | 73 | 74 | 75 | 76 | 77 | 78 | 79 |
| Position(y, x) | (9, 26) | (8, 27) | (7, 28) | (6, 29) | (5, 30) | (4, 31) | (15, 19) | (14, 20) |
| Scan Index | 80 | 81 | 82 | 83 | 84 | 85 | 86 | 87 |
| Position(y, x) | (13, 21) | (12, 22) | (11, 23) | (10, 24) | (9, 25) | (8, 26) | (7, 27) | (6, 28) |
| Scan Index | 88 | 89 | 90 | 91 | 92 | 93 | 94 | 95 |
| Position(y, x) | (5, 29) | (4, 30) | (3, 31) | (15, 18) | (14, 19) | (13, 20) | (12, 21) | (11, 22) |
| Scan Index | 96 | 97 | 98 | 99 | 100 | 101 | 102 | 103 |
| Position(y, x) | (10, 23) | (9, 24) | (8, 25) | (7, 26) | (6, 27) | (5, 28) | (4, 29) | (3, 30) |
| Scan Index | 104 | 105 | 106 | 107 | 108 | 109 | 110 | 111 |
| Position(y, x) | (2, 31) | (15, 17) | (14, 18) | (13, 19) | (12, 20) | (11, 21) | (10, 22) | (9, 23) |
| Scan Index | 112 | 113 | 114 | 115 | 116 | 117 | 118 | 119 |
| Position(y, x) | (8, 24) | (7, 25) | (6, 26) | (5, 27) | (4, 28) | (3, 29) | (2, 30) | (1, 31) |
| Scan Index | 120 | 121 | 122 | 123 | 124 | 125 | 126 | 127 |
| Position(y, x) | (15, 16) | (14, 17) | (13, 18) | (12, 19) | (11, 20) | (10, 21) | (9, 22) | (8, 23) |
| Scan Index | 128 | 129 | 130 | 131 | 132 | 133 | 134 | 135 |
| Position(y, x) | (7, 24) | (6, 25) | (5, 26) | (4, 27) | (3, 28) | (2, 29) | (1, 30) | (0, 31) |
| Scan Index | 136 | 137 | 138 | 139 | 140 | 141 | 142 | 143 |
| Position(y, x) | (15, 15) | (14, 16) | (13, 17) | (12, 18) | (11, 19) | (10, 20) | (9, 21) | (8, 22) |
| Scan Index | 144 | 145 | 146 | 147 | 148 | 149 | 150 | 151 |
| Position(y, x) | (7, 23) | (6, 24) | (5, 25) | (4, 26) | (3, 27) | (2, 28) | (1, 29) | (0, 30) |
| Scan Index | 152 | 153 | 154 | 155 | 156 | 157 | 158 | 159 |
| Position(y, x) | (15, 14) | (14, 15) | (13, 16) | (12, 17) | (11, 18) | (10, 19) | (9, 20) | (8, 21) |
| Scan Index | 160 | 161 | 162 | 163 | 164 | 165 | 166 | 167 |
| Position(y, x) | (7, 22) | (6, 23) | (5, 24) | (4, 25) | (3, 26) | (2, 27) | (1, 28) | (0, 29) |
| Scan Index | 168 | 169 | 170 | 171 | 172 | 173 | 174 | 175 |
| Position(y, x) | (15, 13) | (14, 14) | (13, 15) | (12, 16) | (11, 17) | (10, 18) | (9, 19) | (8, 20) |
| Scan Index | 176 | 177 | 178 | 179 | 180 | 181 | 182 | 183 |
| Position(y, x) | (7, 21) | (6, 22) | (5, 23) | (4, 24) | (3, 25) | (2, 26) | (1, 27) | (0, 28) |
| Scan Index | 184 | 185 | 186 | 187 | 188 | 189 | 190 | 191 |
| Position(y, x) | (15, 12) | (14, 13) | (13, 14) | (12, 15) | (11, 16) | (10, 17) | (9, 18) | (8, 19) |
| Scan Index | 192 | 193 | 194 | 195 | 196 | 197 | 198 | 199 |
| Position(y, x) | (7, 20) | (6, 21) | (5, 22) | (4, 23) | (3, 24) | (2, 25) | (1, 26) | (0, 27) |
| Scan Index | 200 | 201 | 202 | 203 | 204 | 205 | 206 | 207 |
| Position(y, x) | (15, 11) | (14, 12) | (13, 13) | (12, 14) | (11, 15) | (10, 16) | (9, 17) | (8, 18) |
| Scan Index | 208 | 209 | 210 | 211 | 212 | 213 | 214 | 215 |
| Position(y, x) | (7, 19) | (6, 20) | (5, 21) | (4, 22) | (3, 23) | (2, 24) | (1, 25) | (0, 26) |
| Scan Index | 216 | 217 | 218 | 219 | 220 | 221 | 222 | 223 |
| Position(y, x) | (15, 10) | (14, 11) | (13, 12) | (12, 13) | (11, 14) | (10, 15) | (9, 16) | (8, 17) |
| Scan Index | 224 | 225 | 226 | 227 | 228 | 229 | 230 | 231 |
| Position(y, x) | (7, 18) | (6, 19) | (5, 20) | (4, 21) | (3, 22) | (2, 23) | (1, 24) | (0, 25) |
| Scan Index | 232 | 233 | 234 | 235 | 236 | 237 | 238 | 239 |
| Position(y, x) | (15, 9) | (14, 10) | (13, 11) | (12, 12) | (11, 13) | (10, 14) | (9, 15) | (8, 16) |
| Scan Index | 240 | 241 | 242 | 243 | 244 | 245 | 246 | 247 |
| Position(y, x) | (7, 17) | (6, 18) | (5, 19) | (4, 20) | (3, 21) | (2, 22) | (1, 23) | (0, 24) |
| Scan Index | 248 | 249 | 250 | 251 | 252 | 253 | 254 | 255 |
| Position(y, x) | (15, 8) | (14, 9) | (13, 10) | (12, 11) | (11, 12) | (10, 13) | (9, 14) | (8, 15) |
| Scan Index | 256 | 257 | 258 | 259 | 260 | 261 | 262 | 263 |
| Position(y, x) | (7, 16) | (6, 17) | (5, 18) | (4, 19) | (3, 20) | (2, 21) | (1, 22) | (0, 23) |
| Scan Index | 264 | 265 | 266 | 267 | 268 | 269 | 270 | 271 |
| Position(y, x) | (15, 7) | (14, 8) | (13, 9) | (12, 10) | (11, 11) | (10, 12) | (9, 13) | (8, 14) |
| Scan Index | 272 | 273 | 274 | 275 | 276 | 277 | 278 | 279 |
| Position(y, x) | (7, 15) | (6, 16) | (5, 17) | (4, 18) | (3, 19) | (2, 20) | (1, 21) | (0, 22) |
| Scan Index | 280 | 281 | 282 | 283 | 284 | 285 | 286 | 287 |
| Position(y, x) | (15, 6) | (14, 7) | (13, 8) | (12, 9) | (11, 10) | (10, 11) | (9, 12) | (8, 13) |
| Scan Index | 288 | 289 | 290 | 291 | 292 | 293 | 294 | 295 |
| Position(y, x) | (7, 14) | (6, 15) | (5, 16) | (4, 17) | (3, 18) | (2, 19) | (1, 20) | (0, 21) |
| Scan Index | 296 | 297 | 298 | 299 | 300 | 301 | 302 | 303 |
| Position(y, x) | (15, 5) | (14, 6) | (13, 7) | (12, 8) | (11, 9) | (10, 10) | (9, 11) | (8, 12) |
| Scan Index | 304 | 305 | 306 | 307 | 308 | 309 | 310 | 311 |
| Position(y, x) | (7, 13) | (6, 14) | (5, 15) | (4, 16) | (3, 17) | (2, 18) | (1, 19) | (0, 20) |
| Scan Index | 312 | 313 | 314 | 315 | 316 | 317 | 318 | 319 |
| Position(y, x) | (15, 4) | (14, 5) | (13, 6) | (12, 7) | (11, 8) | (10, 9) | (9, 10) | (8, 11) |
| Scan Index | 320 | 321 | 322 | 323 | 324 | 325 | 326 | 327 |
| Position(y, x) | (7, 12) | (6, 13) | (5, 14) | (4, 15) | (3, 16) | (2, 17) | (1, 18) | (0, 19) |
| Scan Index | 328 | 329 | 330 | 331 | 332 | 333 | 334 | 335 |
| Position(y, x) | (15, 3) | (14, 4) | (13, 5) | (12, 6) | (11, 7) | (10, 8) | (9, 9) | (8, 10) |
| Scan Index | 336 | 337 | 338 | 339 | 340 | 341 | 342 | 343 |
| Position(y, x) | (7, 11) | (6, 12) | (5, 13) | (4, 14) | (3, 15) | (2, 16) | (1, 17) | (0, 18) |
| Scan Index | 344 | 345 | 346 | 347 | 348 | 349 | 350 | 351 |
| Position(y, x) | (15, 2) | (14, 3) | (13, 4) | (12, 5) | (11, 6) | (10, 7) | (9, 8) | (8, 9) |
| Scan Index | 352 | 353 | 354 | 355 | 356 | 357 | 358 | 359 |
| Position(y, x) | (7, 10) | (6, 11) | (5, 12) | (4, 13) | (3, 14) | (2, 15) | (1, 16) | (0, 17) |
| Scan Index | 360 | 361 | 362 | 363 | 364 | 365 | 366 | 367 |
| Position(y, x) | (15, 1) | (14, 2) | (13, 3) | (12, 4) | (11, 5) | (10, 6) | (9, 7) | (8, 8) |
| Scan Index | 368 | 369 | 370 | 371 | 372 | 373 | 374 | 375 |
| Position(y, x) | (7, 9) | (6, 10) | (5, 11) | (4, 12) | (3, 13) | (2, 14) | (1, 15) | (0, 16) |
| Scan Index | 376 | 377 | 378 | 379 | 380 | 381 | 382 | 383 |
| Position(y, x) | (15, 0) | (14, 1) | (13, 2) | (12, 3) | (11, 4) | (10, 5) | (9, 6) | (8, 7) |
| Scan Index | 384 | 385 | 386 | 387 | 388 | 389 | 390 | 391 |
| Position(y, x) | (7, 8) | (6, 9) | (5, 10) | (4, 11) | (3, 12) | (2, 13) | (1, 14) | (0, 15) |
| Scan Index | 392 | 393 | 394 | 395 | 396 | 397 | 398 | 399 |
| Position(y, x) | (14, 0) | (13, 1) | (12, 2) | (11, 3) | (10, 4) | (9, 5) | (8, 6) | (7, 7) |
| Scan Index | 400 | 401 | 402 | 403 | 404 | 405 | 406 | 407 |
| Position(y, x) | (6, 8) | (5, 9) | (4, 10) | (3, 11) | (2, 12) | (1, 13) | (0, 14) | (13, 0) |
| Scan Index | 408 | 409 | 410 | 411 | 412 | 413 | 414 | 415 |
| Position(y, x) | (12, 1) | (11, 2) | (10, 3) | (9, 4) | (8, 5) | (7, 6) | (6, 7) | (5, 8) |
| Scan Index | 416 | 417 | 418 | 419 | 420 | 421 | 422 | 423 |
| Position(y, x) | (4, 9) | (3, 10) | (2, 11) | (1, 12) | (0, 13) | (12, 0) | (11, 1) | (10, 2) |
| Scan Index | 424 | 425 | 426 | 427 | 428 | 429 | 430 | 431 |
| Position(y, x) | (9, 3) | (8, 4) | (7, 5) | (6, 6) | (5, 7) | (4, 8) | (3, 9) | (2, 10) |
| Scan Index | 432 | 433 | 434 | 435 | 436 | 437 | 438 | 439 |
| Position(y, x) | (1, 11) | (0, 12) | (11, 0) | (10, 1) | (9, 2) | (8, 3) | (7, 4) | (6, 5) |
| Scan Index | 440 | 441 | 442 | 443 | 444 | 445 | 446 | 447 |
| Position(y, x) | (5, 6) | (4, 7) | (3, 8) | (2, 9) | (1, 10) | (0, 11) | (10, 0) | (9, 1) |
| Scan Index | 448 | 449 | 450 | 451 | 452 | 453 | 454 | 455 |
| Position(y, x) | (8, 2) | (7, 3) | (6, 4) | (5, 5) | (4, 6) | (3, 7) | (2, 8) | (1, 9) |
| Scan Index | 456 | 457 | 458 | 459 | 460 | 461 | 462 | 463 |
| Position(y, x) | (0, 10) | (9, 0) | (8, 1) | (7, 2) | (6, 3) | (5, 4) | (4, 5) | (3, 6) |
| Scan Index | 464 | 465 | 466 | 467 | 468 | 469 | 470 | 471 |
| Position(y, x) | (2, 7) | (1, 8) | (0, 9) | (8, 0) | (7, 1) | (6, 2) | (5, 3) | (4, 4) |
| Scan Index | 472 | 473 | 474 | 475 | 476 | 477 | 478 | 479 |
| Position(y, x) | (3, 5) | (2, 6) | (1, 7) | (0, 8) | (7, 0) | (6, 1) | (5, 2) | (4, 3) |
| Scan Index | 480 | 481 | 482 | 483 | 484 | 485 | 486 | 487 |
| Position(y, x) | (3, 4) | (2, 5) | (1, 6) | (0, 7) | (6, 0) | (5, 1) | (4, 2) | (3, 3) |
| Scan Index | 488 | 489 | 490 | 491 | 492 | 493 | 494 | 495 |
| Position(y, x) | (2, 4) | (1, 5) | (0, 6) | (5, 0) | (4, 1) | (3, 2) | (2, 3) | (1, 4) |
| Scan Index | 496 | 497 | 498 | 499 | 500 | 501 | 502 | 503 |
| Position(y, x) | (0, 5) | (4, 0) | (3, 1) | (2, 2) | (1, 3) | (0, 4) | (3, 0) | (2, 1) |
| Scan Index | 504 | 505 | 506 | 507 | 508 | 509 | 510 | 511 |
| Position(y, x) | (1, 2) | (0, 3) | (2, 0) | (1, 1) | (0, 2) | (1, 0) | (0, 1) | (0, 0) |

Reverse Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (15, 31) | (14, 31) | (15, 30) | (13, 31) | (14, 30) | (15, 29) | (12, 31) | (13, 30) |
| Scan Index | 8 | 9 | 10 | 11 | 12 | 13 | 14 | 15 |
| Position(y, x) | (14, 29) | (15, 28) | (11, 31) | (12, 30) | (13, 29) | (14, 28) | (15, 27) | (10, 31) |
| Scan Index | 16 | 17 | 18 | 19 | 20 | 21 | 22 | 23 |
| Position(y, x) | (11, 30) | (12, 29) | (13, 28) | (14, 27) | (15, 26) | (9, 31) | (10, 30) | (11, 29) |
| Scan Index | 24 | 25 | 26 | 27 | 28 | 29 | 30 | 31 |
| Position(y, x) | (12, 28) | (13, 27) | (14, 26) | (15, 25) | (8, 31) | (9, 30) | (10, 29) | (11, 28) |
| Scan Index | 32 | 33 | 34 | 35 | 36 | 37 | 38 | 39 |
| Position(y, x) | (12, 27) | (13, 26) | (14, 25) | (15, 24) | (7, 31) | (8, 30) | (9, 29) | (10, 28) |
| Scan Index | 40 | 41 | 42 | 43 | 44 | 45 | 46 | 47 |
| Position(y, x) | (11, 27) | (12, 26) | (13, 25) | (14, 24) | (15, 23) | (6, 31) | (7, 30) | (8, 29) |
| Scan Index | 48 | 49 | 50 | 51 | 52 | 53 | 54 | 55 |
| Position(y, x) | (9, 28) | (10, 27) | (11, 26) | (12, 25) | (13, 24) | (14, 23) | (15, 22) | (5, 31) |
| Scan Index | 56 | 57 | 58 | 59 | 60 | 61 | 62 | 63 |
| Position(y, x) | (6, 30) | (7, 29) | (8, 28) | (9, 27) | (10, 26) | (11, 25) | (12, 24) | (13, 23) |
| Scan Index | 64 | 65 | 66 | 67 | 68 | 69 | 70 | 71 |
| Position(y, x) | (14, 22) | (15, 21) | (4, 31) | (5, 30) | (6, 29) | (7, 28) | (8, 27) | (9, 26) |
| Scan Index | 72 | 73 | 74 | 75 | 76 | 77 | 78 | 79 |
| Position(y, x) | (10, 25) | (11, 24) | (12, 23) | (13, 22) | (14, 21) | (15, 20) | (3, 31) | (4, 30) |
| Scan Index | 80 | 81 | 82 | 83 | 84 | 85 | 86 | 87 |
| Position(y, x) | (5, 29) | (6, 28) | (7, 27) | (8, 26) | (9, 25) | (10, 24) | (11, 23) | (12, 22) |
| Scan Index | 88 | 89 | 90 | 91 | 92 | 93 | 94 | 95 |
| Position(y, x) | (13, 21) | (14, 20) | (15, 19) | (2, 31) | (3, 30) | (4, 29) | (5, 28) | (6, 27) |
| Scan Index | 96 | 97 | 98 | 99 | 100 | 101 | 102 | 103 |
| Position(y, x) | (7, 26) | (8, 25) | (9, 24) | (10, 23) | (11, 22) | (12, 21) | (13, 20) | (14, 19) |
| Scan Index | 104 | 105 | 106 | 107 | 108 | 109 | 110 | 111 |
| Position(y, x) | (15, 18) | (1, 31) | (2, 30) | (3, 29) | (4, 28) | (5, 27) | (6, 26) | (7, 25) |
| Scan Index | 112 | 113 | 114 | 115 | 116 | 117 | 118 | 119 |
| Position(y, x) | (8, 24) | (9, 23) | (10, 22) | (11, 21) | (12, 20) | (13, 19) | (14, 18) | (15, 17) |
| Scan Index | 120 | 121 | 122 | 123 | 124 | 125 | 126 | 127 |
| Position(y, x) | (0, 31) | (1, 30) | (2, 29) | (3, 28) | (4, 27) | (5, 26) | (6, 25) | (7, 24) |
| Scan Index | 128 | 129 | 130 | 131 | 132 | 133 | 134 | 135 |
| Position(y, x) | (8, 23) | (9, 22) | (10, 21) | (11, 20) | (12, 19) | (13, 18) | (14, 17) | (15, 16) |
| Scan Index | 136 | 137 | 138 | 139 | 140 | 141 | 142 | 143 |
| Position(y, x) | (0, 30) | (1, 29) | (2, 28) | (3, 27) | (4, 26) | (5, 25) | (6, 24) | (7, 23) |
| Scan Index | 144 | 145 | 146 | 147 | 148 | 149 | 150 | 151 |
| Position(y, x) | (8, 22) | (9, 21) | (10, 20) | (11, 19) | (12, 18) | (13, 17) | (14, 16) | (15, 15) |
| Scan Index | 152 | 153 | 154 | 155 | 156 | 157 | 158 | 159 |
| Position(y, x) | (0, 29) | (1, 28) | (2, 27) | (3, 26) | (4, 25) | (5, 24) | (6, 23) | (7, 22) |
| Scan Index | 160 | 161 | 162 | 163 | 164 | 165 | 166 | 167 |
| Position(y, x) | (8, 21) | (9, 20) | (10, 19) | (11, 18) | (12, 17) | (13, 16) | (14, 15) | (15, 14) |
| Scan Index | 168 | 169 | 170 | 171 | 172 | 173 | 174 | 175 |
| Position(y, x) | (0, 28) | (1, 27) | (2, 26) | (3, 25) | (4, 24) | (5, 23) | (6, 22) | (7, 21) |
| Scan Index | 176 | 177 | 178 | 179 | 180 | 181 | 182 | 183 |
| Position(y, x) | (8, 20) | (9, 19) | (10, 18) | (11, 17) | (12, 16) | (13, 15) | (14, 14) | (15, 13) |
| Scan Index | 184 | 185 | 186 | 187 | 188 | 189 | 190 | 191 |
| Position(y, x) | (0, 27) | (1, 26) | (2, 25) | (3, 24) | (4, 23) | (5, 22) | (6, 21) | (7, 20) |
| Scan Index | 192 | 193 | 194 | 195 | 196 | 197 | 198 | 199 |
| Position(y, x) | (8, 19) | (9, 18) | (10, 17) | (11, 16) | (12, 15) | (13, 14) | (14, 13) | (15, 12) |
| Scan Index | 200 | 201 | 202 | 203 | 204 | 205 | 206 | 207 |
| Position(y, x) | (0, 26) | (1, 25) | (2, 24) | (3, 23) | (4, 22) | (5, 21) | (6, 20) | (7, 19) |
| Scan Index | 208 | 209 | 210 | 211 | 212 | 213 | 214 | 215 |
| Position(y, x) | (8, 18) | (9, 17) | (10, 16) | (11, 15) | (12, 14) | (13, 13) | (14, 12) | (15, 11) |
| Scan Index | 216 | 217 | 218 | 219 | 220 | 221 | 222 | 223 |
| Position(y, x) | (0, 25) | (1, 24) | (2, 23) | (3, 22) | (4, 21) | (5, 20) | (6, 19) | (7, 18) |
| Scan Index | 224 | 225 | 226 | 227 | 228 | 229 | 230 | 231 |
| Position(y, x) | (8, 17) | (9, 16) | (10, 15) | (11, 14) | (12, 13) | (13, 12) | (14, 11) | (15, 10) |
| Scan Index | 232 | 233 | 234 | 235 | 236 | 237 | 238 | 239 |
| Position(y, x) | (0, 24) | (1, 23) | (2, 22) | (3, 21) | (4, 20) | (5, 19) | (6, 18) | (7, 17) |
| Scan Index | 240 | 241 | 242 | 243 | 244 | 245 | 246 | 247 |
| Position(y, x) | (8, 16) | (9, 15) | (10, 14) | (11, 13) | (12, 12) | (13, 11) | (14, 10) | (15, 9) |
| Scan Index | 248 | 249 | 250 | 251 | 252 | 253 | 254 | 255 |
| Position(y, x) | (0, 23) | (1, 22) | (2, 21) | (3, 20) | (4, 19) | (5, 18) | (6, 17) | (7, 16) |
| Scan Index | 256 | 257 | 258 | 259 | 260 | 261 | 262 | 263 |
| Position(y, x) | (8, 15) | (9, 14) | (10, 13) | (11, 12) | (12, 11) | (13, 10) | (14, 9) | (15, 8) |
| Scan Index | 264 | 265 | 266 | 267 | 268 | 269 | 270 | 271 |
| Position(y, x) | (0, 22) | (1, 21) | (2, 20) | (3, 19) | (4, 18) | (5, 17) | (6, 16) | (7, 15) |
| Scan Index | 272 | 273 | 274 | 275 | 276 | 277 | 278 | 279 |
| Position(y, x) | (8, 14) | (9, 13) | (10, 12) | (11, 11) | (12, 10) | (13, 9) | (14, 8) | (15, 7) |
| Scan Index | 280 | 281 | 282 | 283 | 284 | 285 | 286 | 287 |
| Position(y, x) | (0, 21) | (1, 20) | (2, 19) | (3, 18) | (4, 17) | (5, 16) | (6, 15) | (7, 14) |
| Scan Index | 288 | 289 | 290 | 291 | 292 | 293 | 294 | 295 |
| Position(y, x) | (8, 13) | (9, 12) | (10, 11) | (11, 10) | (12, 9) | (13, 8) | (14, 7) | (15, 6) |
| Scan Index | 296 | 297 | 298 | 299 | 300 | 301 | 302 | 303 |
| Position(y, x) | (0, 20) | (1, 19) | (2, 18) | (3, 17) | (4, 16) | (5, 15) | (6, 14) | (7, 13) |
| Scan Index | 304 | 305 | 306 | 307 | 308 | 309 | 310 | 311 |
| Position(y, x) | (8, 12) | (9, 11) | (10, 10) | (11, 9) | (12, 8) | (13, 7) | (14, 6) | (15, 5) |
| Scan Index | 312 | 313 | 314 | 315 | 316 | 317 | 318 | 319 |
| Position(y, x) | (0, 19) | (1, 18) | (2, 17) | (3, 16) | (4, 15) | (5, 14) | (6, 13) | (7, 12) |
| Scan Index | 320 | 321 | 322 | 323 | 324 | 325 | 326 | 327 |
| Position(y, x) | (8, 11) | (9, 10) | (10, 9) | (11, 8) | (12, 7) | (13, 6) | (14, 5) | (15, 4) |
| Scan Index | 328 | 329 | 330 | 331 | 332 | 333 | 334 | 335 |
| Position(y, x) | (0, 18) | (1, 17) | (2, 16) | (3, 15) | (4, 14) | (5, 13) | (6, 12) | (7, 11) |
| Scan Index | 336 | 337 | 338 | 339 | 340 | 341 | 342 | 343 |
| Position(y, x) | (8, 10) | (9, 9) | (10, 8) | (11, 7) | (12, 6) | (13, 5) | (14, 4) | (15, 3) |
| Scan Index | 344 | 345 | 346 | 347 | 348 | 349 | 350 | 351 |
| Position(y, x) | (0, 17) | (1, 16) | (2, 15) | (3, 14) | (4, 13) | (5, 12) | (6, 11) | (7, 10) |
| Scan Index | 352 | 353 | 354 | 355 | 356 | 357 | 358 | 359 |
| Position(y, x) | (8, 9) | (9, 8) | (10, 7) | (11, 6) | (12, 5) | (13, 4) | (14, 3) | (15, 2) |
| Scan Index | 360 | 361 | 362 | 363 | 364 | 365 | 366 | 367 |
| Position(y, x) | (0, 16) | (1, 15) | (2, 14) | (3, 13) | (4, 12) | (5, 11) | (6, 10) | (7, 9) |
| Scan Index | 368 | 369 | 370 | 371 | 372 | 373 | 374 | 375 |
| Position(y, x) | (8, 8) | (9, 7) | (10, 6) | (11, 5) | (12, 4) | (13, 3) | (14, 2) | (15, 1) |
| Scan Index | 376 | 377 | 378 | 379 | 380 | 381 | 382 | 383 |
| Position(y, x) | (0, 15) | (1, 14) | (2, 13) | (3, 12) | (4, 11) | (5, 10) | (6, 9) | (7, 8) |
| Scan Index | 384 | 385 | 386 | 387 | 388 | 389 | 390 | 391 |
| Position(y, x) | (8, 7) | (9, 6) | (10, 5) | (11, 4) | (12, 3) | (13, 2) | (14, 1) | (15, 0) |
| Scan Index | 392 | 393 | 394 | 395 | 396 | 397 | 398 | 399 |
| Position(y, x) | (0, 14) | (1, 13) | (2, 12) | (3, 11) | (4, 10) | (5, 9) | (6, 8) | (7, 7) |
| Scan Index | 400 | 401 | 402 | 403 | 404 | 405 | 406 | 407 |
| Position(y, x) | (8, 6) | (9, 5) | (10, 4) | (11, 3) | (12, 2) | (13, 1) | (14, 0) | (0, 13) |
| Scan Index | 408 | 409 | 410 | 411 | 412 | 413 | 414 | 415 |
| Position(y, x) | (1, 12) | (2, 11) | (3, 10) | (4, 9) | (5, 8) | (6, 7) | (7, 6) | (8, 5) |
| Scan Index | 416 | 417 | 418 | 419 | 420 | 421 | 422 | 423 |
| Position(y, x) | (9, 4) | (10, 3) | (11, 2) | (12, 1) | (13, 0) | (0, 12) | (1, 11) | (2, 10) |
| Scan Index | 424 | 425 | 426 | 427 | 428 | 429 | 430 | 431 |
| Position(y, x) | (3, 9) | (4, 8) | (5, 7) | (6, 6) | (7, 5) | (8, 4) | (9, 3) | (10, 2) |
| Scan Index | 432 | 433 | 434 | 435 | 436 | 437 | 438 | 439 |
| Position(y, x) | (11, 1) | (12, 0) | (0, 11) | (1, 10) | (2, 9) | (3, 8) | (4, 7) | (5, 6) |
| Scan Index | 440 | 441 | 442 | 443 | 444 | 445 | 446 | 447 |
| Position(y, x) | (6, 5) | (7, 4) | (8, 3) | (9, 2) | (10, 1) | (11, 0) | (0, 10) | (1, 9) |
| Scan Index | 448 | 449 | 450 | 451 | 452 | 453 | 454 | 455 |
| Position(y, x) | (2, 8) | (3, 7) | (4, 6) | (5, 5) | (6, 4) | (7, 3) | (8, 2) | (9, 1) |
| Scan Index | 456 | 457 | 458 | 459 | 460 | 461 | 462 | 463 |
| Position(y, x) | (10, 0) | (0, 9) | (1, 8) | (2, 7) | (3, 6) | (4, 5) | (5, 4) | (6, 3) |
| Scan Index | 464 | 465 | 466 | 467 | 468 | 469 | 470 | 471 |
| Position(y, x) | (7, 2) | (8, 1) | (9, 0) | (0, 8) | (1, 7) | (2, 6) | (3, 5) | (4, 4) |
| Scan Index | 472 | 473 | 474 | 475 | 476 | 477 | 478 | 479 |
| Position(y, x) | (5, 3) | (6, 2) | (7, 1) | (8, 0) | (0, 7) | (1, 6) | (2, 5) | (3, 4) |
| Scan Index | 480 | 481 | 482 | 483 | 484 | 485 | 486 | 487 |
| Position(y, x) | (4, 3) | (5, 2) | (6, 1) | (7, 0) | (0, 6) | (1, 5) | (2, 4) | (3, 3) |
| Scan Index | 488 | 489 | 490 | 491 | 492 | 493 | 494 | 495 |
| Position(y, x) | (4, 2) | (5, 1) | (6, 0) | (0, 5) | (1, 4) | (2, 3) | (3, 2) | (4, 1) |
| Scan Index | 496 | 497 | 498 | 499 | 500 | 501 | 502 | 503 |
| Position(y, x) | (5, 0) | (0, 4) | (1, 3) | (2, 2) | (3, 1) | (4, 0) | (0, 3) | (1, 2) |
| Scan Index | 504 | 505 | 506 | 507 | 508 | 509 | 510 | 511 |
| Position(y, x) | (2, 1) | (3, 0) | (0, 2) | (1, 1) | (2, 0) | (0, 1) | (1, 0) | (0, 0) |

Example for Whole 16×32 Wavefront Scan Pattern

TABLE 12
Whole 16 × 32 wavefront scan pattern
Forward Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (0, 0) | (1, 0) | (0, 1) | (2, 0) | (1, 1) | (0, 2) | (3, 0) | (2, 1) |
| Scan Index | 8 | 9 | 10 | 11 | 12 | 13 | 14 | 15 |
| Position(y, x) | (1, 2) | (0, 3) | (4, 0) | (3, 1) | (2, 2) | (1, 3) | (0, 4) | (5, 0) |
| Scan Index | 16 | 17 | 18 | 19 | 20 | 21 | 22 | 23 |
| Position(y, x) | (4, 1) | (3, 2) | (2, 3) | (1, 4) | (0, 5) | (6, 0) | (5, 1) | (4, 2) |
| Scan Index | 24 | 25 | 26 | 27 | 28 | 29 | 30 | 31 |
| Position(y, x) | (3, 3) | (2, 4) | (1, 5) | (0, 6) | (7, 0) | (6, 1) | (5, 2) | (4, 3) |
| Scan Index | 32 | 33 | 34 | 35 | 36 | 37 | 38 | 39 |
| Position(y, x) | (3, 4) | (2, 5) | (1, 6) | (0, 7) | (8, 0) | (7, 1) | (6, 2) | (5, 3) |
| Scan Index | 40 | 41 | 42 | 43 | 44 | 45 | 46 | 47 |
| Position(y, x) | (4, 4) | (3, 5) | (2, 6) | (1, 7) | (0, 8) | (9, 0) | (8, 1) | (7, 2) |
| Scan Index | 48 | 49 | 50 | 51 | 52 | 53 | 54 | 55 |
| Position(y, x) | (6, 3) | (5, 4) | (4, 5) | (3, 6) | (2, 7) | (1, 8) | (0, 9) | (10, 0) |
| Scan Index | 56 | 57 | 58 | 59 | 60 | 61 | 62 | 63 |
| Position(y, x) | (9, 1) | (8, 2) | (7, 3) | (6, 4) | (5, 5) | (4, 6) | (3, 7) | (2, 8) |
| Scan Index | 64 | 65 | 66 | 67 | 68 | 69 | 70 | 71 |
| Position(y, x) | (1, 9) | (0, 10) | (11, 0) | (10, 1) | (9, 2) | (8, 3) | (7, 4) | (6, 5) |
| Scan Index | 72 | 73 | 74 | 75 | 76 | 77 | 78 | 79 |
| Position(y, x) | (5, 6) | (4, 7) | (3, 8) | (2, 9) | (1, 10) | (0, 11) | (12, 0) | (11, 1) |
| Scan Index | 80 | 81 | 82 | 83 | 84 | 85 | 86 | 87 |
| Position(y, x) | (10, 2) | (9, 3) | (8, 4) | (7, 5) | (6, 6) | (5, 7) | (4, 8) | (3, 9) |
| Scan Index | 88 | 89 | 90 | 91 | 92 | 93 | 94 | 95 |
| Position(y, x) | (2, 10) | (1, 11) | (0, 12) | (13, 0) | (12, 1) | (11, 2) | (10, 3) | (9, 4) |
| Scan Index | 96 | 97 | 98 | 99 | 100 | 101 | 102 | 103 |
| Position(y, x) | (8, 5) | (7, 6) | (6, 7) | (5, 8) | (4, 9) | (3, 10) | (2, 11) | (1, 12) |
| Scan Index | 104 | 105 | 106 | 107 | 108 | 109 | 110 | 111 |
| Position(y, x) | (0, 13) | (14, 0) | (13, 1) | (12, 2) | (11, 3) | (10, 4) | (9, 5) | (8, 6) |
| Scan Index | 112 | 113 | 114 | 115 | 116 | 117 | 118 | 119 |
| Position(y, x) | (7, 7) | (6, 8) | (5, 9) | (4, 10) | (3, 11) | (2, 12) | (1, 13) | (0, 14) |
| Scan Index | 120 | 121 | 122 | 123 | 124 | 125 | 126 | 127 |
| Position(y, x) | (15, 0) | (14, 1) | (13, 2) | (12, 3) | (11, 4) | (10, 5) | (9, 6) | (8, 7) |
| Scan Index | 128 | 129 | 130 | 131 | 132 | 133 | 134 | 135 |
| Position(y, x) | (7, 8) | (6, 9) | (5, 10) | (4, 11) | (3, 12) | (2, 13) | (1, 14) | (0, 15) |
| Scan Index | 136 | 137 | 138 | 139 | 140 | 141 | 142 | 143 |
| Position(y, x) | (16, 0) | (15, 1) | (14, 2) | (13, 3) | (12, 4) | (11, 5) | (10, 6) | (9, 7) |
| Scan Index | 144 | 145 | 146 | 147 | 148 | 149 | 150 | 151 |
| Position(y, x) | (8, 8) | (7, 9) | (6, 10) | (5, 11) | (4, 12) | (3, 13) | (2, 14) | (1, 15) |
| Scan Index | 152 | 153 | 154 | 155 | 156 | 157 | 158 | 159 |
| Position(y, x) | (17, 0) | (16, 1) | (15, 2) | (14, 3) | (13, 4) | (12, 5) | (11, 6) | (10, 7) |
| Scan Index | 160 | 161 | 162 | 163 | 164 | 165 | 166 | 167 |
| Position(y, x) | (9, 8) | (8, 9) | (7, 10) | (6, 11) | (5, 12) | (4, 13) | (3, 14) | (2, 15) |
| Scan Index | 168 | 169 | 170 | 171 | 172 | 173 | 174 | 175 |
| Position(y, x) | (18, 0) | (17, 1) | (16, 2) | (15, 3) | (14, 4) | (13, 5) | (12, 6) | (11, 7) |
| Scan Index | 176 | 177 | 178 | 179 | 180 | 181 | 182 | 183 |
| Position(y, x) | (10, 8) | (9, 9) | (8, 10) | (7, 11) | (6, 12) | (5, 13) | (4, 14) | (3, 15) |
| Scan Index | 184 | 185 | 186 | 187 | 188 | 189 | 190 | 191 |
| Position(y, x) | (19, 0) | (18, 1) | (17, 2) | (16, 3) | (15, 4) | (14, 5) | (13, 6) | (12, 7) |
| Scan Index | 192 | 193 | 194 | 195 | 196 | 197 | 198 | 199 |
| Position(y, x) | (11, 8) | (10, 9) | (9, 10) | (8, 11) | (7, 12) | (6, 13) | (5, 14) | (4, 15) |
| Scan Index | 200 | 201 | 202 | 203 | 204 | 205 | 206 | 207 |
| Position(y, x) | (20, 0) | (19, 1) | (18, 2) | (17, 3) | (16, 4) | (15, 5) | (14, 6) | (13, 7) |
| Scan Index | 208 | 209 | 210 | 211 | 212 | 213 | 214 | 215 |
| Position(y, x) | (12, 8) | (11, 9) | (10, 10) | (9, 11) | (8, 12) | (7, 13) | (6, 14) | (5, 15) |
| Scan Index | 216 | 217 | 218 | 219 | 220 | 221 | 222 | 223 |
| Position(y, x) | (21, 0) | (20, 1) | (19, 2) | (18, 3) | (17, 4) | (16, 5) | (15, 6) | (14, 7) |
| Scan Index | 224 | 225 | 226 | 227 | 228 | 229 | 230 | 231 |
| Position(y, x) | (13, 8) | (12, 9) | (11, 10) | (10, 11) | (9, 12) | (8, 13) | (7, 14) | (6, 15) |
| Scan Index | 232 | 233 | 234 | 235 | 236 | 237 | 238 | 239 |
| Position(y, x) | (22, 0) | (21, 1) | (20, 2) | (19, 3) | (18, 4) | (17, 5) | (16, 6) | (15, 7) |
| Scan Index | 240 | 241 | 242 | 243 | 244 | 245 | 246 | 247 |
| Position(y, x) | (14, 8) | (13, 9) | (12, 10) | (11, 11) | (10, 12) | (9, 13) | (8, 14) | (7, 15) |
| Scan Index | 248 | 249 | 250 | 251 | 252 | 253 | 254 | 255 |
| Position(y, x) | (23, 0) | (22, 1) | (21, 2) | (20, 3) | (19, 4) | (18, 5) | (17, 6) | (16, 7) |
| Scan Index | 256 | 257 | 258 | 259 | 260 | 261 | 262 | 263 |
| Position(y, x) | (15, 8) | (14, 9) | (13, 10) | (12, 11) | (11, 12) | (10, 13) | (9, 14) | (8, 15) |
| Scan Index | 264 | 265 | 266 | 267 | 268 | 269 | 270 | 271 |
| Position(y, x) | (24, 0) | (23, 1) | (22, 2) | (21, 3) | (20, 4) | (19, 5) | (18, 6) | (17, 7) |
| Scan Index | 272 | 273 | 274 | 275 | 276 | 277 | 278 | 279 |
| Position(y, x) | (16, 8) | (15, 9) | (14, 10) | (13, 11) | (12, 12) | (11, 13) | (10, 14) | (9, 15) |
| Scan Index | 280 | 281 | 282 | 283 | 284 | 285 | 286 | 287 |
| Position(y, x) | (25, 0) | (24, 1) | (23, 2) | (22, 3) | (21, 4) | (20, 5) | (19, 6) | (18, 7) |
| Scan Index | 288 | 289 | 290 | 291 | 292 | 293 | 294 | 295 |
| Position(y, x) | (17, 8) | (16, 9) | (15, 10) | (14, 11) | (13, 12) | (12, 13) | (11, 14) | (10, 15) |
| Scan Index | 296 | 297 | 298 | 299 | 300 | 301 | 302 | 303 |
| Position(y, x) | (26, 0) | (25, 1) | (24, 2) | (23, 3) | (22, 4) | (21, 5) | (20, 6) | (19, 7) |
| Scan Index | 304 | 305 | 306 | 307 | 308 | 309 | 310 | 311 |
| Position(y, x) | (18, 8) | (17, 9) | (16, 10) | (15, 11) | (14, 12) | (13, 13) | (12, 14) | (11, 15) |
| Scan Index | 312 | 313 | 314 | 315 | 316 | 317 | 318 | 319 |
| Position(y, x) | (27, 0) | (26, 1) | (25, 2) | (24, 3) | (23, 4) | (22, 5) | (21, 6) | (20, 7) |
| Scan Index | 320 | 321 | 322 | 323 | 324 | 325 | 326 | 327 |
| Position(y, x) | (19, 8) | (18, 9) | (17, 10) | (16, 11) | (15, 12) | (14, 13) | (13, 14) | (12, 15) |
| Scan Index | 328 | 329 | 330 | 331 | 332 | 333 | 334 | 335 |
| Position(y, x) | (28, 0) | (27, 1) | (26, 2) | (25, 3) | (24, 4) | (23, 5) | (22, 6) | (21, 7) |
| Scan Index | 336 | 337 | 338 | 339 | 340 | 341 | 342 | 343 |
| Position(y, x) | (20, 8) | (19, 9) | (18, 10) | (17, 11) | (16, 12) | (15, 13) | (14, 14) | (13, 15) |
| Scan Index | 344 | 345 | 346 | 347 | 348 | 349 | 350 | 351 |
| Position(y, x) | (29, 0) | (28, 1) | (27, 2) | (26, 3) | (25, 4) | (24, 5) | (23, 6) | (22, 7) |
| Scan Index | 352 | 353 | 354 | 355 | 356 | 357 | 358 | 359 |
| Position(y, x) | (21, 8) | (20, 9) | (19, 10) | (18, 11) | (17, 12) | (16, 13) | (15, 14) | (14, 15) |
| Scan Index | 360 | 361 | 362 | 363 | 364 | 365 | 366 | 367 |
| Position(y, x) | (30, 0) | (29, 1) | (28, 2) | (27, 3) | (26, 4) | (25, 5) | (24, 6) | (23, 7) |
| Scan Index | 368 | 369 | 370 | 371 | 372 | 373 | 374 | 375 |
| Position(y, x) | (22, 8) | (21, 9) | (20, 10) | (19, 11) | (18, 12) | (17, 13) | (16, 14) | (15, 15) |
| Scan Index | 376 | 377 | 378 | 379 | 380 | 381 | 382 | 383 |
| Position(y, x) | (31, 0) | (30, 1) | (29, 2) | (28, 3) | (27, 4) | (26, 5) | (25, 6) | (24, 7) |
| Scan Index | 384 | 385 | 386 | 387 | 388 | 389 | 390 | 391 |
| Position(y, x) | (23, 8) | (22, 9) | (21, 10) | (20, 11) | (19, 12) | (18, 13) | (17, 14) | (16, 15) |
| Scan Index | 392 | 393 | 394 | 395 | 396 | 397 | 398 | 399 |
| Position(y, x) | (31, 1) | (30, 2) | (29, 3) | (28, 4) | (27, 5) | (26, 6) | (25, 7) | (24, 8) |
| Scan Index | 400 | 401 | 402 | 403 | 404 | 405 | 406 | 407 |
| Position(y, x) | (23, 9) | (22, 10) | (21, 11) | (20, 12) | (19, 13) | (18, 14) | (17, 15) | (31, 2) |
| Scan Index | 408 | 409 | 410 | 411 | 412 | 413 | 414 | 415 |
| Position(y, x) | (30, 3) | (29, 4) | (28, 5) | (27, 6) | (26, 7) | (25, 8) | (24, 9) | (23, 10) |
| Scan Index | 416 | 417 | 418 | 419 | 420 | 421 | 422 | 423 |
| Position(y, x) | (22, 11) | (21, 12) | (20, 13) | (19, 14) | (18, 15) | (31, 3) | (30, 4) | (29, 5) |
| Scan Index | 424 | 425 | 426 | 427 | 428 | 429 | 430 | 431 |
| Position(y, x) | (28, 6) | (27, 7) | (26, 8) | (25, 9) | (24, 10) | (23, 11) | (22, 12) | (21, 13) |
| Scan Index | 432 | 433 | 434 | 435 | 436 | 437 | 438 | 439 |
| Position(y, x) | (20, 14) | (19, 15) | (31, 4) | (30, 5) | (29, 6) | (28, 7) | (27, 8) | (26, 9) |
| Scan Index | 440 | 441 | 442 | 443 | 444 | 445 | 446 | 447 |
| Position(y, x) | (25, 10) | (24, 11) | (23, 12) | (22, 13) | (21, 14) | (20, 15) | (31, 5) | (30, 6) |
| Scan Index | 448 | 449 | 450 | 451 | 452 | 453 | 454 | 455 |
| Position(y, x) | (29, 7) | (28, 8) | (27, 9) | (26, 10) | (25, 11) | (24, 12) | (23, 13) | (22, 14) |
| Scan Index | 456 | 457 | 458 | 459 | 460 | 461 | 462 | 463 |
| Position(y, x) | (21, 15) | (31, 6) | (30, 7) | (29, 8) | (28, 9) | (27, 10) | (26, 11) | (25, 12) |
| Scan Index | 464 | 465 | 466 | 467 | 468 | 469 | 470 | 471 |
| Position(y, x) | (24, 13) | (23, 14) | (22, 15) | (31, 7) | (30, 8) | (29, 9) | (28, 10) | (27, 11) |
| Scan Index | 472 | 473 | 474 | 475 | 476 | 477 | 478 | 479 |
| Position(y, x) | (26, 12) | (25, 13) | (24, 14) | (23, 15) | (31, 8) | (30, 9) | (29, 10) | (28, 11) |
| Scan Index | 480 | 481 | 482 | 483 | 484 | 485 | 486 | 487 |
| Position(y, x) | (27, 12) | (26, 13) | (25, 14) | (24, 15) | (31, 9) | (30, 10) | (29, 11) | (28, 12) |
| Scan Index | 488 | 489 | 490 | 491 | 492 | 493 | 494 | 495 |
| Position(y, x) | (27, 13) | (26, 14) | (25, 15) | (31, 10) | (30, 11) | (29, 12) | (28, 13) | (27, 14) |
| Scan Index | 496 | 497 | 498 | 499 | 500 | 501 | 502 | 503 |
| Position(y, x) | (26, 15) | (31, 11) | (30, 12) | (29, 13) | (28, 14) | (27, 15) | (31, 12) | (30, 13) |
| Scan Index | 504 | 505 | 506 | 507 | 508 | 509 | 510 | 511 |
| Position(y, x) | (29, 14) | (28, 15) | (31, 13) | (30, 14) | (29, 15) | (31, 14) | (30, 15) | (31, 15) |

Forward Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (0, 0) | (0, 1) | (1, 0) | (0, 2) | (1, 1) | (2, 0) | (0, 3) | (1, 2) |
| Scan Index | 8 | 9 | 10 | 11 | 12 | 13 | 14 | 15 |
| Position(y, x) | (2, 1) | (3, 0) | (0, 4) | (1, 3) | (2, 2) | (3, 1) | (4, 0) | (0, 5) |
| Scan Index | 16 | 17 | 18 | 19 | 20 | 21 | 22 | 23 |
| Position(y, x) | (1, 4) | (2, 3) | (3, 2) | (4, 1) | (5, 0) | (0, 6) | (1, 5) | (2, 4) |
| Scan Index | 24 | 25 | 26 | 27 | 28 | 29 | 30 | 31 |
| Position(y, x) | (3, 3) | (4, 2) | (5, 1) | (6, 0) | (0, 7) | (1, 6) | (2, 5) | (3, 4) |
| Scan Index | 32 | 33 | 34 | 35 | 36 | 37 | 38 | 39 |
| Position(y, x) | (4, 3) | (5, 2) | (6, 1) | (7, 0) | (0, 8) | (1, 7) | (2, 6) | (3, 5) |
| Scan Index | 40 | 41 | 42 | 43 | 44 | 45 | 46 | 47 |
| Position(y, x) | (4, 4) | (5, 3) | (6, 2) | (7, 1) | (8, 0) | (0, 9) | (1, 8) | (2, 7) |
| Scan Index | 48 | 49 | 50 | 51 | 52 | 53 | 54 | 55 |
| Position(y, x) | (3, 6) | (4, 5) | (5, 4) | (6, 3) | (7, 2) | (8, 1) | (9, 0) | (0, 10) |
| Scan Index | 56 | 57 | 58 | 59 | 60 | 61 | 62 | 63 |
| Position(y, x) | (1, 9) | (2, 8) | (3, 7) | (4, 6) | (5, 5) | (6, 4) | (7, 3) | (8, 2) |
| Scan Index | 64 | 65 | 66 | 67 | 68 | 69 | 70 | 71 |
| Position(y, x) | (9, 1) | (10, 0) | (0, 11) | (1, 10) | (2, 9) | (3, 8) | (4, 7) | (5, 6) |
| Scan Index | 72 | 73 | 74 | 75 | 76 | 77 | 78 | 79 |
| Position(y, x) | (6, 5) | (7, 4) | (8, 3) | (9, 2) | (10, 1) | (11, 0) | (0, 12) | (1, 11) |
| Scan Index | 80 | 81 | 82 | 83 | 84 | 85 | 86 | 87 |
| Position(y, x) | (2, 10) | (3, 9) | (4, 8) | (5, 7) | (6, 6) | (7, 5) | (8, 4) | (9, 3) |
| Scan Index | 88 | 89 | 90 | 91 | 92 | 93 | 94 | 95 |
| Position(y, x) | (10, 2) | (11, 1) | (12, 0) | (0, 13) | (1, 12) | (2, 11) | (3, 10) | (4, 9) |
| Scan Index | 96 | 97 | 98 | 99 | 100 | 101 | 102 | 103 |
| Position(y, x) | (5, 8) | (6, 7) | (7, 6) | (8, 5) | (9, 4) | (10, 3) | (11, 2) | (12, 1) |
| Scan Index | 104 | 105 | 106 | 107 | 108 | 109 | 110 | 111 |
| Position(y, x) | (13, 0) | (0, 14) | (1, 13) | (2, 12) | (3, 11) | (4, 10) | (5, 9) | (6, 8) |
| Scan Index | 112 | 113 | 114 | 115 | 116 | 117 | 118 | 119 |
| Position(y, x) | (7, 7) | (8, 6) | (9, 5) | (10, 4) | (11, 3) | (12, 2) | (13, 1) | (14, 0) |
| Scan Index | 120 | 121 | 122 | 123 | 124 | 125 | 126 | 127 |
| Position(y, x) | (0, 15) | (1, 14) | (2, 13) | (3, 12) | (4, 11) | (5, 10) | (6, 9) | (7, 8) |
| Scan Index | 128 | 129 | 130 | 131 | 132 | 133 | 134 | 135 |
| Position(y, x) | (8, 7) | (9, 6) | (10, 5) | (11, 4) | (12, 3) | (13, 2) | (14, 1) | (15, 0) |
| Scan Index | 136 | 137 | 138 | 139 | 140 | 141 | 142 | 143 |
| Position(y, x) | (1, 15) | (2, 14) | (3, 13) | (4, 12) | (5, 11) | (6, 10) | (7, 9) | (8, 8) |
| Scan Index | 144 | 145 | 146 | 147 | 148 | 149 | 150 | 151 |
| Position(y, x) | (9, 7) | (10, 6) | (11, 5) | (12, 4) | (13, 3) | (14, 2) | (15, 1) | (16, 0) |
| Scan Index | 152 | 153 | 154 | 155 | 156 | 157 | 158 | 159 |
| Position(y, x) | (2, 15) | (3, 14) | (4, 13) | (5, 12) | (6, 11) | (7, 10) | (8, 9) | (9, 8) |
| Scan Index | 160 | 161 | 162 | 163 | 164 | 165 | 166 | 167 |
| Position(y, x) | (10, 7) | (11, 6) | (12, 5) | (13, 4) | (14, 3) | (15, 2) | (16, 1) | (17, 0) |
| Scan Index | 168 | 169 | 170 | 171 | 172 | 173 | 174 | 175 |
| Position(y, x) | (3, 15) | (4, 14) | (5, 13) | (6, 12) | (7, 11) | (8, 10) | (9, 9) | (10, 8) |
| Scan Index | 176 | 177 | 178 | 179 | 180 | 181 | 182 | 183 |
| Position(y, x) | (11, 7) | (12, 6) | (13, 5) | (14, 4) | (15, 3) | (16, 2) | (17, 1) | (18, 0) |
| Scan Index | 184 | 185 | 186 | 187 | 188 | 189 | 190 | 191 |
| Position(y, x) | (4, 15) | (5, 14) | (6, 13) | (7, 12) | (8, 11) | (9, 10) | (10, 9) | (11, 8) |
| Scan Index | 192 | 193 | 194 | 195 | 196 | 197 | 198 | 199 |
| Position(y, x) | (12, 7) | (13, 6) | (14, 5) | (15, 4) | (16, 3) | (17, 2) | (18, 1) | (19, 0) |
| Scan Index | 200 | 201 | 202 | 203 | 204 | 205 | 206 | 207 |
| Position(y, x) | (5, 15) | (6, 14) | (7, 13) | (8, 12) | (9, 11) | (10, 10) | (11, 9) | (12, 8) |
| Scan Index | 208 | 209 | 210 | 211 | 212 | 213 | 214 | 215 |
| Position(y, x) | (13, 7) | (14, 6) | (15, 5) | (16, 4) | (17, 3) | (18, 2) | (19, 1) | (20, 0) |
| Scan Index | 216 | 217 | 218 | 219 | 220 | 221 | 222 | 223 |
| Position(y, x) | (6, 15) | (7, 14) | (8, 13) | (9, 12) | (10, 11) | (11, 10) | (12, 9) | (13, 8) |
| Scan Index | 224 | 225 | 226 | 227 | 228 | 229 | 230 | 231 |
| Position(y, x) | (14, 7) | (15, 6) | (16, 5) | (17, 4) | (18, 3) | (19, 2) | (20, 1) | (21, 0) |
| Scan Index | 232 | 233 | 234 | 235 | 236 | 237 | 238 | 239 |
| Position(y, x) | (7, 15) | (8, 14) | (9, 13) | (10, 12) | (11, 11) | (12, 10) | (13, 9) | (14, 8) |
| Scan Index | 240 | 241 | 242 | 243 | 244 | 245 | 246 | 247 |
| Position(y, x) | (15, 7) | (16, 6) | (17, 5) | (18, 4) | (19, 3) | (20, 2) | (21, 1) | (22, 0) |
| Scan Index | 248 | 249 | 250 | 251 | 252 | 253 | 254 | 255 |
| Position(y, x) | (8, 15) | (9, 14) | (10, 13) | (11, 12) | (12, 11) | (13, 10) | (14, 9) | (15, 8) |
| Scan Index | 256 | 257 | 258 | 259 | 260 | 261 | 262 | 263 |
| Position(y, x) | (16, 7) | (17, 6) | (18, 5) | (19, 4) | (20, 3) | (21, 2) | (22, 1) | (23, 0) |
| Scan Index | 264 | 265 | 266 | 267 | 268 | 269 | 270 | 271 |
| Position(y, x) | (9, 15) | (10, 14) | (11, 13) | (12, 12) | (13, 11) | (14, 10) | (15, 9) | (16, 8) |
| Scan Index | 272 | 273 | 274 | 275 | 276 | 277 | 278 | 279 |
| Position(y, x) | (17, 7) | (18, 6) | (19, 5) | (20, 4) | (21, 3) | (22, 2) | (23, 1) | (24, 0) |
| Scan Index | 280 | 281 | 282 | 283 | 284 | 285 | 286 | 287 |
| Position(y, x) | (10, 15) | (11, 14) | (12, 13) | (13, 12) | (14, 11) | (15, 10) | (16, 9) | (17, 8) |
| Scan Index | 288 | 289 | 290 | 291 | 292 | 293 | 294 | 295 |
| Position(y, x) | (18, 7) | (19, 6) | (20, 5) | (21, 4) | (22, 3) | (23, 2) | (24, 1) | (25, 0) |
| Scan Index | 296 | 297 | 298 | 299 | 300 | 301 | 302 | 303 |
| Position(y, x) | (11, 15) | (12, 14) | (13, 13) | (14, 12) | (15, 11) | (16, 10) | (17, 9) | (18, 8) |
| Scan Index | 304 | 305 | 306 | 307 | 308 | 309 | 310 | 311 |
| Position(y, x) | (19, 7) | (20, 6) | (21, 5) | (22, 4) | (23, 3) | (24, 2) | (25, 1) | (26, 0) |
| Scan Index | 312 | 313 | 314 | 315 | 316 | 317 | 318 | 319 |
| Position(y, x) | (12, 15) | (13, 14) | (14, 13) | (15, 12) | (16, 11) | (17, 10) | (18, 9) | (19, 8) |
| Scan Index | 320 | 321 | 322 | 323 | 324 | 325 | 326 | 327 |
| Position(y, x) | (20, 7) | (21, 6) | (22, 5) | (23, 4) | (24, 3) | (25, 2) | (26, 1) | (27, 0) |
| Scan Index | 328 | 329 | 330 | 331 | 332 | 333 | 334 | 335 |
| Position(y, x) | (13, 15) | (14, 14) | (15, 13) | (16, 12) | (17, 11) | (18, 10) | (19, 9) | (20, 8) |
| Scan Index | 336 | 337 | 338 | 339 | 340 | 341 | 342 | 343 |
| Position(y, x) | (21, 7) | (22, 6) | (23, 5) | (24, 4) | (25, 3) | (26, 2) | (27, 1) | (28, 0) |
| Scan Index | 344 | 345 | 346 | 347 | 348 | 349 | 350 | 351 |
| Position(y, x) | (14, 15) | (15, 14) | (16, 13) | (17, 12) | (18, 11) | (19, 10) | (20, 9) | (21, 8) |
| Scan Index | 352 | 353 | 354 | 355 | 356 | 357 | 358 | 359 |
| Position(y, x) | (22, 7) | (23, 6) | (24, 5) | (25, 4) | (26, 3) | (27, 2) | (28, 1) | (29, 0) |
| Scan Index | 360 | 361 | 362 | 363 | 364 | 365 | 366 | 367 |
| Position(y, x) | (15, 15) | (16, 14) | (17, 13) | (18, 12) | (19, 11) | (20, 10) | (21, 9) | (22, 8) |
| Scan Index | 368 | 369 | 370 | 371 | 372 | 373 | 374 | 375 |
| Position(y, x) | (23, 7) | (24, 6) | (25, 5) | (26, 4) | (27, 3) | (28, 2) | (29, 1) | (30, 0) |
| Scan Index | 376 | 377 | 378 | 379 | 380 | 381 | 382 | 383 |
| Position(y, x) | (16, 15) | (17, 14) | (18, 13) | (19, 12) | (20, 11) | (21, 10) | (22, 9) | (23, 8) |
| Scan Index | 384 | 385 | 386 | 387 | 388 | 389 | 390 | 391 |
| Position(y, x) | (24, 7) | (25, 6) | (26, 5) | (27, 4) | (28, 3) | (29, 2) | (30, 1) | (31, 0) |
| Scan Index | 392 | 393 | 394 | 395 | 396 | 397 | 398 | 399 |
| Position(y, x) | (17, 15) | (18, 14) | (19, 13) | (20, 12) | (21, 11) | (22, 10) | (23, 9) | (24, 8) |
| Scan Index | 400 | 401 | 402 | 403 | 404 | 405 | 406 | 407 |
| Position(y, x) | (25, 7) | (26, 6) | (27, 5) | (28, 4) | (29, 3) | (30, 2) | (31, 1) | (18, 15) |
| Scan Index | 408 | 409 | 410 | 411 | 412 | 413 | 414 | 415 |
| Position(y, x) | (19, 14) | (20, 13) | (21, 12) | (22, 11) | (23, 10) | (24, 9) | (25, 8) | (26, 7) |
| Scan Index | 416 | 417 | 418 | 419 | 420 | 421 | 422 | 423 |
| Position(y, x) | (27, 6) | (28, 5) | (29, 4) | (30, 3) | (31, 2) | (19, 15) | (20, 14) | (21, 13) |
| Scan Index | 424 | 425 | 426 | 427 | 428 | 429 | 430 | 431 |
| Position(y, x) | (22, 12) | (23, 11) | (24, 10) | (25, 9) | (26, 8) | (27, 7) | (28, 6) | (29, 5) |
| Scan Index | 432 | 433 | 434 | 435 | 436 | 437 | 438 | 439 |
| Position(y, x) | (30, 4) | (31, 3) | (20, 15) | (21, 14) | (22, 13) | (23, 12) | (24, 11) | (25, 10) |
| Scan Index | 440 | 441 | 442 | 443 | 444 | 445 | 446 | 447 |
| Position(y, x) | (26, 9) | (27, 8) | (28, 7) | (29, 6) | (30, 5) | (31, 4) | (21, 15) | (22, 14) |
| Scan Index | 448 | 449 | 450 | 451 | 452 | 453 | 454 | 455 |
| Position(y, x) | (23, 13) | (24, 12) | (25, 11) | (26, 10) | (27, 9) | (28, 8) | (29, 7) | (30, 6) |
| Scan Index | 456 | 457 | 458 | 459 | 460 | 461 | 462 | 463 |
| Position(y, x) | (31, 5) | (22, 15) | (23, 14) | (24, 13) | (25, 12) | (26, 11) | (27, 10) | (28, 9) |
| Scan Index | 464 | 465 | 466 | 467 | 468 | 469 | 470 | 471 |
| Position(y, x) | (29, 8) | (30, 7) | (31, 6) | (23, 15) | (24, 14) | (25, 13) | (26, 12) | (27, 11) |
| Scan Index | 472 | 473 | 474 | 475 | 476 | 477 | 478 | 479 |
| Position(y, x) | (28, 10) | (29, 9) | (30, 8) | (31, 7) | (24, 15) | (25, 14) | (26, 13) | (27, 12) |
| Scan Index | 480 | 481 | 482 | 483 | 484 | 485 | 486 | 487 |
| Position(y, x) | (28, 11) | (29, 10) | (30, 9) | (31, 8) | (25, 15) | (26, 14) | (27, 13) | (28, 12) |
| Scan Index | 488 | 489 | 490 | 491 | 492 | 493 | 494 | 495 |
| Position(y, x) | (29, 11) | (30, 10) | (31, 9) | (26, 15) | (27, 14) | (28, 13) | (29, 12) | (30, 11) |
| Scan Index | 496 | 497 | 498 | 499 | 500 | 501 | 502 | 503 |
| Position(y, x) | (31, 10) | (27, 15) | (28, 14) | (29, 13) | (30, 12) | (31, 11) | (28, 15) | (29, 14) |
| Scan Index | 504 | 505 | 506 | 507 | 508 | 509 | 510 | 511 |
| Position(y, x) | (30, 13) | (31, 12) | (29, 15) | (30, 14) | (31, 13) | (30, 15) | (31, 14) | (31, 15) |

Reverse Scan from Bottom-Left to Top-Right

| | | | | | | | | |
|---|---|---|---|---|---|---|---|---|
| Scan Index | 0 | 1 | 2 | 3 | 4 | 5 | 6 | 7 |
| Position(y, x) | (31, 15) | (31, 14) | (30, 15) | (31, 13) | (30, 14) | (29, 15) | (31, 12) | (30, 13) |
| Scan Index | 8 | 9 | 10 | 11 | 12 | 13 | 14 | 15 |
| Position(y, x) | (29, 14) | (28, 15) | (31, 11) | (30, 12) | (29, 13) | (28, 14) | (27, 15) | (31, 10) |
| Scan Index | 16 | 17 | 18 | 19 | 20 | 21 | 22 | 23 |
| Position(y, x) | (30, 11) | (29, 12) | (28, 13) | (27, 14) | (26, 15) | (31, 9) | (30, 10) | (29, 11) |
| Scan Index | 24 | 25 | 26 | 27 | 28 | 29 | 30 | 31 |
| Position(y, x) | (28, 12) | (27, 13) | (26, 14) | (25, 15) | (31, 8) | (30, 9) | (29, 10) | (28, 11) |
| Scan Index | 32 | 33 | 34 | 35 | 36 | 37 | 38 | 39 |
| Position(y, x) | (27, 12) | (26, 13) | (25, 14) | (24, 15) | (31, 7) | (30, 8) | (29, 9) | (28, 10) |
| Scan Index | 40 | 41 | 42 | 43 | 44 | 45 | 46 | 47 |
| Position(y, x) | (27, 11) | (26, 12) | (25, 13) | (24, 14) | (23, 15) | (31, 6) | (30, 7) | (29, 8) |
| Scan Index | 48 | 49 | 50 | 51 | 52 | 53 | 54 | 55 |
| Position(y, x) | (28, 9) | (27, 10) | (26, 11) | (25, 12) | (24, 13) | (23, 14) | (22, 15) | (31, 5) |
| Scan Index | 56 | 57 | 58 | 59 | 60 | 61 | 62 | 63 |
| Position(y, x) | (30, 6) | (29, 7) | (28, 8) | (27, 9) | (26, 10) | (25, 11) | (24, 12) | (23, 13) |
| Scan Index | 64 | 65 | 66 | 67 | 68 | 69 | 70 | 71 |
| Position(y, x) | (22, 14) | (21, 15) | (31, 4) | (30, 5) | (29, 6) | (28, 7) | (27, 8) | (26, 9) |
| Scan Index | 72 | 73 | 74 | 75 | 76 | 77 | 78 | 79 |
| Position(y, x) | (25, 10) | (24, 11) | (23, 12) | (22, 13) | (21, 14) | (20, 15) | (31, 3) | (30, 4) |
| Scan Index | 80 | 81 | 82 | 83 | 84 | 85 | 86 | 87 |
| Position(y, x) | (29, 5) | (28, 6) | (27, 7) | (26, 8) | (25, 9) | (24, 10) | (23, 11) | (22, 12) |
| Scan Index | 88 | 89 | 90 | 91 | 92 | 93 | 94 | 95 |
| Position(y, x) | (21, 13) | (20, 14) | (19, 15) | (31, 2) | (30, 3) | (29, 4) | (28, 5) | (27, 6) |
| Scan Index | 96 | 97 | 98 | 99 | 100 | 101 | 102 | 103 |
| Position(y, x) | (26, 7) | (25, 8) | (24, 9) | (23, 10) | (22, 11) | (21, 12) | (20, 13) | (19, 14) |
| Scan Index | 104 | 105 | 106 | 107 | 108 | 109 | 110 | 111 |
| Position(y, x) | (18, 15) | (31, 1) | (30, 2) | (29, 3) | (28, 4) | (27, 5) | (26, 6) | (25, 7) |
| Scan Index | 112 | 113 | 114 | 115 | 116 | 117 | 118 | 119 |
| Position(y, x) | (24, 8) | (23, 9) | (22, 10) | (21, 11) | (20, 12) | (19, 13) | (18, 14) | (17, 15) |
| Scan Index | 120 | 121 | 122 | 123 | 124 | 125 | 126 | 127 |
| Position(y, x) | (31, 0) | (30, 1) | (29, 2) | (28, 3) | (27, 4) | (26, 5) | (25, 6) | (24, 7) |
| Scan Index | 128 | 129 | 130 | 131 | 132 | 133 | 134 | 135 |
| Position(y, x) | (23, 8) | (22, 9) | (21, 10) | (20, 11) | (19, 12) | (18, 13) | (17, 14) | (16, 15) |
| Scan Index | 136 | 137 | 138 | 139 | 140 | 141 | 142 | 143 |
| Position(y, x) | (30, 0) | (29, 1) | (28, 2) | (27, 3) | (26, 4) | (25, 5) | (24, 6) | (23, 7) |
| Scan Index | 144 | 145 | 146 | 147 | 148 | 149 | 150 | 151 |
| Position(y, x) | (22, 8) | (21, 9) | (20, 10) | (19, 11) | (18, 12) | (17, 13) | (16, 14) | (15, 15) |
| Scan Index | 152 | 153 | 154 | 155 | 156 | 157 | 158 | 159 |
| Position(y, x) | (29, 0) | (28, 1) | (27, 2) | (26, 3) | (25, 4) | (24, 5) | (23, 6) | (22, 7) |
| Scan Index | 160 | 161 | 162 | 163 | 164 | 165 | 166 | 167 |
| Position(y, x) | (21, 8) | (20, 9) | (19, 10) | (18, 11) | (17, 12) | (16, 13) | (15, 14) | (14, 15) |
| Scan Index | 168 | 169 | 170 | 171 | 172 | 173 | 174 | 175 |
| Position(y, x) | (28, 0) | (27, 1) | (26, 2) | (25, 3) | (24, 4) | (23, 5) | (22, 6) | (21, 7) |
| Scan Index | 176 | 177 | 178 | 179 | 180 | 181 | 182 | 183 |
| Position(y, x) | (20, 8) | (19, 9) | (18, 10) | (17, 11) | (16, 12) | (15, 13) | (14, 14) | (13, 15) |
| Scan Index | 184 | 185 | 186 | 187 | 188 | 189 | 190 | 191 |
| Position(y, x) | (27, 0) | (26, 1) | (25, 2) | (24, 3) | (23, 4) | (22, 5) | (21, 6) | (20, 7) |
| Scan Index | 192 | 193 | 194 | 195 | 196 | 197 | 198 | 199 |
| Position(y, x) | (19, 8) | (18, 9) | (17, 10) | (16, 11) | (15, 12) | (14, 13) | (13, 14) | (12, 15) |
| Scan Index | 200 | 201 | 202 | 203 | 204 | 205 | 206 | 207 |
| Position(y, x) | (26, 0) | (25, 1) | (24, 2) | (23, 3) | (22, 4) | (21, 5) | (20, 6) | (19, 7) |
| Scan Index | 208 | 209 | 210 | 211 | 212 | 213 | 214 | 215 |
| Position(y, x) | (18, 8) | (17, 9) | (16, 10) | (15, 11) | (14, 12) | (13, 13) | (12, 14) | (11, 15) |
| Scan Index | 216 | 217 | 218 | 219 | 220 | 221 | 222 | 223 |
| Position(y, x) | (25, 0) | (24, 1) | (23, 2) | (22, 3) | (21, 4) | (20, 5) | (19, 6) | (18, 7) |
| Scan Index | 224 | 225 | 226 | 227 | 228 | 229 | 230 | 231 |
| Position(y, x) | (17, 8) | (16, 9) | (15, 10) | (14, 11) | (13, 12) | (12, 13) | (11, 14) | (10, 15) |
| Scan Index | 232 | 233 | 234 | 235 | 236 | 237 | 238 | 239 |
| Position(y, x) | (24, 0) | (23, 1) | (22, 2) | (21, 3) | (20, 4) | (19, 5) | (18, 6) | (17, 7) |
| Scan Index | 240 | 241 | 242 | 243 | 244 | 245 | 246 | 247 |
| Position(y, x) | (16, 8) | (15, 9) | (14, 10) | (13, 11) | (12, 12) | (11, 13) | (10, 14) | (9, 15) |
| Scan Index | 248 | 249 | 250 | 251 | 252 | 253 | 254 | 255 |
| Position(y, x) | (23, 0) | (22, 1) | (21, 2) | (20, 3) | (19, 4) | (18, 5) | (17, 6) | (16, 7) |
| Scan Index | 256 | 257 | 258 | 259 | 260 | 261 | 262 | 263 |
| Position(y, x) | (15, 8) | (14, 9) | (13, 10) | (12, 11) | (11, 12) | (10, 13) | (9, 14) | (8, 15) |
| Scan Index | 264 | 265 | 266 | 267 | 268 | 269 | 270 | 271 |
| Position(y, x) | (22, 0) | (21, 1) | (20, 2) | (19, 3) | (18, 4) | (17, 5) | (16, 6) | (15, 7) |
| Scan Index | 272 | 273 | 274 | 275 | 276 | 277 | 278 | 279 |
| Position(y, x) | (14, 8) | (13, 9) | (12, 10) | (11, 11) | (10, 12) | (9, 13) | (8, 14) | (7, 15) |
| Scan Index | 280 | 281 | 282 | 283 | 284 | 285 | 286 | 287 |
| Position(y, x) | (21, 0) | (20, 1) | (19, 2) | (18, 3) | (17, 4) | (16, 5) | (15, 6) | (14, 7) |
| Scan Index | 288 | 289 | 290 | 291 | 292 | 293 | 294 | 295 |
| Position(y, x) | (13, 8) | (12, 9) | (11, 10) | (10, 11) | (9, 12) | (8, 13) | (7, 14) | (6, 15) |
| Scan Index | 296 | 297 | 298 | 299 | 300 | 301 | 302 | 303 |
| Position(y, x) | (20, 0) | (19, 1) | (18, 2) | (17, 3) | (16, 4) | (15, 5) | (14, 6) | (13, 7) |
| Scan Index | 304 | 305 | 306 | 307 | 308 | 309 | 310 | 311 |
| Position(y, x) | (12, 8) | (11, 9) | (10, 10) | (9, 11) | (8, 12) | (7, 13) | (6, 14) | (5, 15) |
| Scan Index | 312 | 313 | 314 | 315 | 316 | 317 | 318 | 319 |
| Position(y, x) | (19, 0) | (18, 1) | (17, 2) | (16, 3) | (15, 4) | (14, 5) | (13, 6) | (12, 7) |
| Scan Index | 320 | 321 | 322 | 323 | 324 | 325 | 326 | 327 |
| Position(y, x) | (11, 8) | (10, 9) | (9, 10) | (8, 11) | (7, 12) | (6, 13) | (5, 14) | (4, 15) |
| Scan Index | 328 | 329 | 330 | 331 | 332 | 333 | 334 | 335 |
| Position(y, x) | (18, 0) | (17, 1) | (16, 2) | (15, 3) | (14, 4) | (13, 5) | (12, 6) | (11, 7) |
| Scan Index | 336 | 337 | 338 | 339 | 340 | 341 | 342 | 343 |
| Position(y, x) | (10, 8) | (9, 9) | (8, 10) | (7, 11) | (6, 12) | (5, 13) | (4, 14) | (3, 15) |
| Scan Index | 344 | 345 | 346 | 347 | 348 | 349 | 350 | 351 |
| Position(y, x) | (17, 0) | (16, 1) | (15, 2) | (14, 3) | (13, 4) | (12, 5) | (11, 6) | (10, 7) |
| Scan Index | 352 | 353 | 354 | 355 | 356 | 357 | 358 | 359 |
| Position(y, x) | (9, 8) | (8, 9) | (7, 10) | (6, 11) | (5, 12) | (4, 13) | (3, 14) | (2, 15) |
| Scan Index | 360 | 361 | 362 | 363 | 364 | 365 | 366 | 367 |
| Position(y, x) | (16, 0) | (15, 1) | (14, 2) | (13, 3) | (12, 4) | (11, 5) | (10, 6) | (9, 7) |
| Scan Index | 368 | 369 | 370 | 371 | 372 | 373 | 374 | 375 |
| Position(y, x) | (8, 8) | (7, 9) | (6, 10) | (5, 11) | (4, 12) | (3, 13) | (2, 14) | (1, 15) |
| Scan Index | 376 | 377 | 378 | 379 | 380 | 381 | 382 | 383 |
| Position(y, x) | (15, 0) | (14, 1) | (13, 2) | (12, 3) | (11, 4) | (10, 5) | (9, 6) | (8, 7) |
| Scan Index | 384 | 385 | 386 | 387 | 388 | 389 | 390 | 391 |
| Position(y, x) | (7, 8) | (6, 9) | (5, 10) | (4, 11) | (3, 12) | (2, 13) | (1, 14) | (0, 15) |
| Scan Index | 392 | 393 | 394 | 395 | 396 | 397 | 398 | 399 |
| Position(y, x) | (14, 0) | (13, 1) | (12, 2) | (11, 3) | (10, 4) | (9, 5) | (8, 6) | (7, 7) |
| Scan Index | 400 | 401 | 402 | 403 | 404 | 405 | 406 | 407 |
| Position(y, x) | (6, 8) | (5, 9) | (4, 10) | (3, 11) | (2, 12) | (1, 13) | (0, 14) | (13, 0) |
| Scan Index | 408 | 409 | 410 | 411 | 412 | 413 | 414 | 415 |
| Position(y, x) | (12, 1) | (11, 2) | (10, 3) | (9, 4) | (8, 5) | (7, 6) | (6, 7) | (5, 8) |
| Scan Index | 416 | 417 | 418 | 419 | 420 | 421 | 422 | 423 |
| Position(y, x) | (4, 9) | (3, 10) | (2, 11) | (1, 12) | (0, 13) | (12, 0) | (11, 1) | (10, 2) |
| Scan Index | 424 | 425 | 426 | 427 | 428 | 429 | 430 | 431 |
| Position(y, x) | (9, 3) | (8, 4) | (7, 5) | (6, 6) | (5, 7) | (4, 8) | (3, 9) | (2, 10) |
| Scan Index | 432 | 433 | 434 | 435 | 436 | 437 | 438 | 439 |
| Position(y, x) | (1, 11) | (0, 12) | (11, 0) | (10, 1) | (9, 2) | (8, 3) | (7, 4) | (6, 5) |
| Scan Index | 440 | 441 | 442 | 443 | 444 | 445 | 446 | 447 |
| Position(y, x) | (5, 6) | (4, 7) | (3, 8) | (2, 9) | (1, 10) | (0, 11) | (10, 0) | (9, 1) |
| Scan Index | 448 | 449 | 450 | 451 | 452 | 453 | 454 | 455 |
| Position(y, x) | (8, 2) | (7, 3) | (6, 4) | (5, 5) | (4, 6) | (3, 7) | (2, 8) | (1, 9) |
| Scan Index | 456 | 457 | 458 | 459 | 460 | 461 | 462 | 463 |
| Position(y, x) | (0, 10) | (9, 0) | (8, 1) | (7, 2) | (6, 3) | (5, 4) | (4, 5) | (3, 6) |
| Scan Index | 464 | 465 | 466 | 467 | 468 | 469 | 470 | 471 |
| Position(y, x) | (2, 7) | (1, 8) | (0, 9) | (8, 0) | (7, 1) | (6, 2) | (5, 3) | (4, 4) |
| Scan Index | 472 | 473 | 474 | 475 | 476 | 477 | 478 | 479 |
| Position(y, x) | (3, 5) | (2, 6) | (1, 7) | (0, 8) | (7, 0) | (6, 1) | (5, 2) | (4, 3) |
| Scan Index | 480 | 481 | 482 | 483 | 484 | 485 | 486 | 487 |
| Position(y, x) | (3, 4) | (2, 5) | (1, 6) | (0, 7) | (6, 0) | (5, 1) | (4, 2) | (3, 3) |
| Scan Index | 488 | 489 | 490 | 491 | 492 | 493 | 494 | 495 |
| Position(y, x) | (2, 4) | (1, 5) | (0, 6) | (5, 0) | (4, 1) | (3, 2) | (2, 3) | (1, 4) |
| Scan Index | 496 | 497 | 498 | 499 | 500 | 501 | 502 | 503 |
| Position(y, x) | (0, 5) | (4, 0) | (3, 1) | (2, 2) | (1, 3) | (0, 4) | (3, 0) | (2, 1) |
| Scan Index | 504 | 505 | 506 | 507 | 508 | 509 | 510 | 511 |
| Position(y, x) | (1, 2) | (0, 3) | (2, 0) | (1, 1) | (0, 2) | (1, 0) | (0, 1) | (0, 0) |

Reverse Scan from Top-Right to Bottom-Left

| | | | | | | | | |
|---|---|---|---|---|---|---|---|---|
| Scan Index | 0 | 1 | 2 | 3 | 4 | 5 | 6 | 7 |
| Position(y, x) | (31, 15) | (30, 15) | (31, 14) | (29, 15) | (30, 14) | (31, 13) | (28, 15) | (29, 14) |
| Scan Index | 8 | 9 | 10 | 11 | 12 | 13 | 14 | 15 |
| Position(y, x) | (30, 13) | (31, 12) | (27, 15) | (28, 14) | (29, 13) | (30, 12) | (31, 11) | (26, 15) |
| Scan Index | 16 | 17 | 18 | 19 | 20 | 21 | 22 | 23 |
| Position(y, x) | (27, 14) | (28, 13) | (29, 12) | (30, 11) | (31, 10) | (25, 15) | (26, 14) | (27, 13) |
| Scan Index | 24 | 25 | 26 | 27 | 28 | 29 | 30 | 31 |
| Position(y, x) | (28, 12) | (29, 11) | (30, 10) | (31, 9) | (24, 15) | (25, 14) | (26, 13) | (27, 12) |
| Scan Index | 32 | 33 | 34 | 35 | 36 | 37 | 38 | 39 |
| Position(y, x) | (28, 11) | (29, 10) | (30, 9) | (31, 8) | (23, 15) | (24, 14) | (25, 13) | (26, 12) |
| Scan Index | 40 | 41 | 42 | 43 | 44 | 45 | 46 | 47 |
| Position(y, x) | (27, 11) | (28, 10) | (29, 9) | (30, 8) | (31, 7) | (22, 15) | (23, 14) | (24, 13) |
| Scan Index | 48 | 49 | 50 | 51 | 52 | 53 | 54 | 55 |
| Position(y, x) | (25, 12) | (26, 11) | (27, 10) | (28, 9) | (29, 8) | (30, 7) | (31, 6) | (21, 15) |
| Scan Index | 56 | 57 | 58 | 59 | 60 | 61 | 62 | 63 |
| Position(y, x) | (22, 14) | (23, 13) | (24, 12) | (25, 11) | (26, 10) | (27, 9) | (28, 8) | (29, 7) |
| Scan Index | 64 | 65 | 66 | 67 | 68 | 69 | 70 | 71 |
| Position(y, x) | (30, 6) | (31, 5) | (20, 15) | (21, 14) | (22, 13) | (23, 12) | (24, 11) | (25, 10) |
| Scan Index | 72 | 73 | 74 | 75 | 76 | 77 | 78 | 79 |
| Position(y, x) | (26, 9) | (27, 8) | (28, 7) | (29, 6) | (30, 5) | (31, 4) | (19, 15) | (20, 14) |
| Scan Index | 80 | 81 | 82 | 83 | 84 | 85 | 86 | 87 |
| Position(y, x) | (21, 13) | (22, 12) | (23, 11) | (24, 10) | (25, 9) | (26, 8) | (27, 7) | (28, 6) |
| Scan Index | 88 | 89 | 90 | 91 | 92 | 93 | 94 | 95 |
| Position(y, x) | (29, 5) | (30, 4) | (31, 3) | (18, 15) | (19, 14) | (20, 13) | (21, 12) | (22, 11) |
| Scan Index | 96 | 97 | 98 | 99 | 100 | 101 | 102 | 103 |
| Position(y, x) | (23, 10) | (24, 9) | (25, 8) | (26, 7) | (27, 6) | (28, 5) | (29, 4) | (30, 3) |
| Scan Index | 104 | 105 | 106 | 107 | 108 | 109 | 110 | 111 |
| Position(y, x) | (31, 2) | (17, 15) | (18, 14) | (19, 13) | (20, 12) | (21, 11) | (22, 10) | (23, 9) |
| Scan Index | 112 | 113 | 114 | 115 | 116 | 117 | 118 | 119 |
| Position(y, x) | (24, 8) | (25, 7) | (26, 6) | (27, 5) | (28, 4) | (29, 3) | (30, 2) | (31, 1) |
| Scan Index | 120 | 121 | 122 | 123 | 124 | 125 | 126 | 127 |
| Position(y, x) | (16, 15) | (17, 14) | (18, 13) | (19, 12) | (20, 11) | (21, 10) | (22, 9) | (23, 8) |
| Scan Index | 128 | 129 | 130 | 131 | 132 | 133 | 134 | 135 |
| Position(y, x) | (24, 7) | (25, 6) | (26, 5) | (27, 4) | (28, 3) | (29, 2) | (30, 1) | (31, 0) |
| Scan Index | 136 | 137 | 138 | 139 | 140 | 141 | 142 | 143 |
| Position(y, x) | (15, 15) | (16, 14) | (17, 13) | (18, 12) | (19, 11) | (20, 10) | (21, 9) | (22, 8) |
| Scan Index | 144 | 145 | 146 | 147 | 148 | 149 | 150 | 151 |
| Position(y, x) | (23, 7) | (24, 6) | (25, 5) | (26, 4) | (27, 3) | (28, 2) | (29, 1) | (30, 0) |
| Scan Index | 152 | 153 | 154 | 155 | 156 | 157 | 158 | 159 |
| Position(y, x) | (14, 15) | (15, 14) | (16, 13) | (17, 12) | (18, 11) | (19, 10) | (20, 9) | (21, 8) |
| Scan Index | 160 | 161 | 162 | 163 | 164 | 165 | 166 | 167 |
| Position(y, x) | (22, 7) | (23, 6) | (24, 5) | (25, 4) | (26, 3) | (27, 2) | (28, 1) | (29, 0) |
| Scan Index | 168 | 169 | 170 | 171 | 172 | 173 | 174 | 175 |
| Position(y, x) | (13, 15) | (14, 14) | (15, 13) | (16, 12) | (17, 11) | (18, 10) | (19, 9) | (20, 8) |
| Scan Index | 176 | 177 | 178 | 179 | 180 | 181 | 182 | 183 |
| Position(y, x) | (21, 7) | (22, 6) | (23, 5) | (24, 4) | (25, 3) | (26, 2) | (27, 1) | (28, 0) |
| Scan Index | 184 | 185 | 186 | 187 | 188 | 189 | 190 | 191 |
| Position(y, x) | (12, 15) | (13, 14) | (14, 13) | (15, 12) | (16, 11) | (17, 10) | (18, 9) | (19, 8) |
| Scan Index | 192 | 193 | 194 | 195 | 196 | 197 | 198 | 199 |
| Position(y, x) | (20, 7) | (21, 6) | (22, 5) | (23, 4) | (24, 3) | (25, 2) | (26, 1) | (27, 0) |
| Scan Index | 200 | 201 | 202 | 203 | 204 | 205 | 206 | 207 |
| Position(y, x) | (11, 15) | (12, 14) | (13, 13) | (14, 12) | (15, 11) | (16, 10) | (17, 9) | (18, 8) |
| Scan Index | 208 | 209 | 210 | 211 | 212 | 213 | 214 | 215 |
| Position(y, x) | (19, 7) | (20, 6) | (21, 5) | (22, 4) | (23, 3) | (24, 2) | (25, 1) | (26, 0) |
| Scan Index | 216 | 217 | 218 | 219 | 220 | 221 | 222 | 223 |
| Position(y, x) | (10, 15) | (11, 14) | (12, 13) | (13, 12) | (14, 11) | (15, 10) | (16, 9) | (17, 8) |
| Scan Index | 224 | 225 | 226 | 227 | 228 | 229 | 230 | 231 |
| Position(y, x) | (18, 7) | (19, 6) | (20, 5) | (21, 4) | (22, 3) | (23, 2) | (24, 1) | (25, 0) |
| Scan Index | 232 | 233 | 234 | 235 | 236 | 237 | 238 | 239 |
| Position(y, x) | (9, 15) | (10, 14) | (11, 13) | (12, 12) | (13, 11) | (14, 10) | (15, 9) | (16, 8) |
| Scan Index | 240 | 241 | 242 | 243 | 244 | 245 | 246 | 247 |
| Position(y, x) | (17, 7) | (18, 6) | (19, 5) | (20, 4) | (21, 3) | (22, 2) | (23, 1) | (24, 0) |
| Scan Index | 248 | 249 | 250 | 251 | 252 | 253 | 254 | 255 |
| Position(y, x) | (8, 15) | (9, 14) | (10, 13) | (11, 12) | (12, 11) | (13, 10) | (14, 9) | (15, 8) |
| Scan Index | 256 | 257 | 258 | 259 | 260 | 261 | 262 | 263 |
| Position(y, x) | (16, 7) | (17, 6) | (18, 5) | (19, 4) | (20, 3) | (21, 2) | (22, 1) | (23, 0) |
| Scan Index | 264 | 265 | 266 | 267 | 268 | 269 | 270 | 271 |
| Position(y, x) | (7, 15) | (8, 14) | (9, 13) | (10, 12) | (11, 11) | (12, 10) | (13, 9) | (14, 8) |
| Scan Index | 272 | 273 | 274 | 275 | 276 | 277 | 278 | 279 |
| Position(y, x) | (15, 7) | (16, 6) | (17, 5) | (18, 4) | (19, 3) | (20, 2) | (21, 1) | (22, 0) |
| Scan Index | 280 | 281 | 282 | 283 | 284 | 285 | 286 | 287 |
| Position(y, x) | (6, 15) | (7, 14) | (8, 13) | (9, 12) | (10, 11) | (11, 10) | (12, 9) | (13, 8) |
| Scan Index | 288 | 289 | 290 | 291 | 292 | 293 | 294 | 295 |
| Position(y, x) | (14, 7) | (15, 6) | (16, 5) | (17, 4) | (18, 3) | (19, 2) | (20, 1) | (21, 0) |
| Scan Index | 296 | 297 | 298 | 299 | 300 | 301 | 302 | 303 |
| Position(y, x) | (5, 15) | (6, 14) | (7, 13) | (8, 12) | (9, 11) | (10, 10) | (11, 9) | (12, 8) |
| Scan Index | 304 | 305 | 306 | 307 | 308 | 309 | 310 | 311 |
| Position(y, x) | (13, 7) | (14, 6) | (15, 5) | (16, 4) | (17, 3) | (18, 2) | (19, 1) | (20, 0) |
| Scan Index | 312 | 313 | 314 | 315 | 316 | 317 | 318 | 319 |
| Position(y, x) | (4, 15) | (5, 14) | (6, 13) | (7, 12) | (8, 11) | (9, 10) | (10, 9) | (11, 8) |
| Scan Index | 320 | 321 | 322 | 323 | 324 | 325 | 326 | 327 |
| Position(y, x) | (12, 7) | (13, 6) | (14, 5) | (15, 4) | (16, 3) | (17, 2) | (18, 1) | (19, 0) |
| Scan Index | 328 | 329 | 330 | 331 | 332 | 333 | 334 | 335 |
| Position(y, x) | (3, 15) | (4, 14) | (5, 13) | (6, 12) | (7, 11) | (8, 10) | (9, 9) | (10, 8) |
| Scan Index | 336 | 337 | 338 | 339 | 340 | 341 | 342 | 343 |
| Position(y, x) | (11, 7) | (12, 6) | (13, 5) | (14, 4) | (15, 3) | (16, 2) | (17, 1) | (18, 0) |
| Scan Index | 344 | 345 | 346 | 347 | 348 | 349 | 350 | 351 |
| Position(y, x) | (2, 15) | (3, 14) | (4, 13) | (5, 12) | (6, 11) | (7, 10) | (8, 9) | (9, 8) |
| Scan Index | 352 | 353 | 354 | 355 | 356 | 357 | 358 | 359 |
| Position(y, x) | (10, 7) | (11, 6) | (12, 5) | (13, 4) | (14, 3) | (15, 2) | (16, 1) | (17, 0) |
| Scan Index | 360 | 361 | 362 | 363 | 364 | 365 | 366 | 367 |
| Position(y, x) | (1, 15) | (2, 14) | (3, 13) | (4, 12) | (5, 11) | (6, 10) | (7, 9) | (8, 8) |
| Scan Index | 368 | 369 | 370 | 371 | 372 | 373 | 374 | 375 |
| Position(y, x) | (9, 7) | (10, 6) | (11, 5) | (12, 4) | (13, 3) | (14, 2) | (15, 1) | (16, 0) |
| Scan Index | 376 | 377 | 378 | 379 | 380 | 381 | 382 | 383 |
| Position(y, x) | (0, 15) | (1, 14) | (2, 13) | (3, 12) | (4, 11) | (5, 10) | (6, 9) | (7, 8) |
| Scan Index | 384 | 385 | 386 | 387 | 388 | 389 | 390 | 391 |
| Position(y, x) | (8, 7) | (9, 6) | (10, 5) | (11, 4) | (12, 3) | (13, 2) | (14, 1) | (15, 0) |
| Scan Index | 392 | 393 | 394 | 395 | 396 | 397 | 398 | 399 |
| Position(y, x) | (0, 14) | (1, 13) | (2, 12) | (3, 11) | (4, 10) | (5, 9) | (6, 8) | (7, 7) |
| Scan Index | 400 | 401 | 402 | 403 | 404 | 405 | 406 | 407 |
| Position(y, x) | (8, 6) | (9, 5) | (10, 4) | (11, 3) | (12, 2) | (13, 1) | (14, 0) | (0, 13) |
| Scan Index | 408 | 409 | 410 | 411 | 412 | 413 | 414 | 415 |
| Position(y, x) | (1, 12) | (2, 11) | (3, 10) | (4, 9) | (5, 8) | (6, 7) | (7, 6) | (8, 5) |
| Scan Index | 416 | 417 | 418 | 419 | 420 | 421 | 422 | 423 |
| Position(y, x) | (9, 4) | (10, 3) | (11, 2) | (12, 1) | (13, 0) | (0, 12) | (1, 11) | (2, 10) |
| Scan Index | 424 | 425 | 426 | 427 | 428 | 429 | 430 | 431 |
| Position(y, x) | (3, 9) | (4, 8) | (5, 7) | (6, 6) | (7, 5) | (8, 4) | (9, 3) | (10, 2) |
| Scan Index | 432 | 433 | 434 | 435 | 436 | 437 | 438 | 439 |
| Position(y, x) | (11, 1) | (12, 0) | (0, 11) | (1, 10) | (2, 9) | (3, 8) | (4, 7) | (5, 6) |
| Scan Index | 440 | 441 | 442 | 443 | 444 | 445 | 446 | 447 |
| Position(y, x) | (6, 5) | (7, 4) | (8, 3) | (9, 2) | (10, 1) | (11, 0) | (0, 10) | (1, 9) |
| Scan Index | 448 | 449 | 450 | 451 | 452 | 453 | 454 | 455 |
| Position(y, x) | (2, 8) | (3, 7) | (4, 6) | (5, 5) | (6, 4) | (7, 3) | (8, 2) | (9, 1) |
| Scan Index | 456 | 457 | 458 | 459 | 460 | 461 | 462 | 463 |
| Position(y, x) | (10, 0) | (0, 9) | (1, 8) | (2, 7) | (3, 6) | (4, 5) | (5, 4) | (6, 3) |
| Scan Index | 464 | 465 | 466 | 467 | 468 | 469 | 470 | 471 |
| Position(y, x) | (7, 2) | (8, 1) | (9, 0) | (0, 8) | (1, 7) | (2, 6) | (3, 5) | (4, 4) |
| Scan Index | 472 | 473 | 474 | 475 | 476 | 477 | 478 | 479 |
| Position(y, x) | (5, 3) | (6, 2) | (7, 1) | (8, 0) | (0, 7) | (1, 6) | (2, 5) | (3, 4) |
| Scan Index | 480 | 481 | 482 | 483 | 484 | 485 | 486 | 487 |
| Position(y, x) | (4, 3) | (5, 2) | (6, 1) | (7, 0) | (0, 6) | (1, 5) | (2, 4) | (3, 3) |
| Scan Index | 488 | 489 | 490 | 491 | 492 | 493 | 494 | 495 |
| Position(y, x) | (4, 2) | (5, 1) | (6, 0) | (0, 5) | (1, 4) | (2, 3) | (3, 2) | (4, 1) |
| Scan Index | 496 | 497 | 498 | 499 | 500 | 501 | 502 | 503 |
| Position(y, x) | (5, 0) | (0, 4) | (1, 3) | (2, 2) | (3, 1) | (4, 0) | (0, 3) | (1, 2) |
| Scan Index | 504 | 505 | 506 | 507 | 508 | 509 | 510 | 511 |
| Position(y, x) | (2, 1) | (3, 0) | (0, 2) | (1, 1) | (2, 0) | (0, 1) | (1, 0) | (0, 0) |

As such, the techniques of this disclosure may enable video encoder 20 and/or video decoder 30 to perform wavefront scanning for a rectangular block more efficiently than when using other methods. In this manner, there may be a relative time savings corresponding to parallel processing capabilities when using the techniques of this disclosure.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). An apparatus including video encoder 20 and/or video decoder 30 may comprise an integrated circuit, a microprocessor, and/or a wireless communication device, such as a cellular telephone.

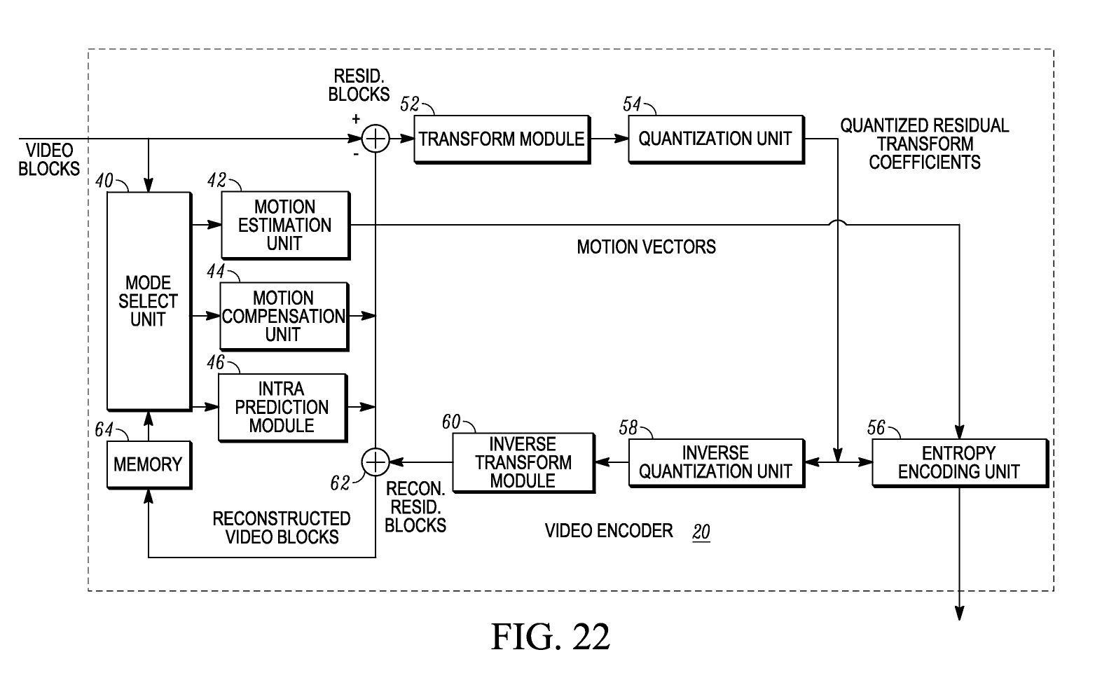

FIG. 22 is a block diagram that illustrates an example of a video encoder 20 that may implement techniques for efficiently performing scanning of a rectangular block of video data, consistent with the techniques of this disclosure. Video encoder 20 may perform intra- and inter-coding of blocks within video frames, including macroblocks, CUs, and partitions or sub-partitions thereof. Intra-coding relies on spatial prediction to reduce or remove spatial redundancy in video within a given video frame. Inter-coding relies on temporal prediction to reduce or remove temporal redundancy in video within adjacent frames of a video sequence. Intra-mode (I-mode) may refer to any of several spatial based compression modes, and inter-modes, such as uni-directional prediction (P-mode) or bi-directional prediction (B-mode), may refer to any of several temporal-based compression modes.

As shown in FIG. 22, video encoder 20 receives a current block of video data within a video frame to be encoded. In the example of FIG. 22, video encoder 20 includes motion compensation unit 44, motion estimation unit 42, memory 64, summer 50, transform module 52, quantization unit 54, and entropy encoding unit 56. For video block reconstruction, video encoder 20 also includes inverse quantization unit 58, inverse transform module 60, and summer 62. A deblocking filter or adaptive loop filter (not shown in FIG. 22) may also be included to filter block boundaries to remove blockiness artifacts from reconstructed video, e.g., for smoothing block boundaries and minimizing the coding distortion between the input and output pictures. If desired, the deblocking filter would typically filter the output of summer 62.

During the encoding process, video encoder 20 receives a video frame or slice to be coded. The frame or slice may be divided into multiple video blocks. Motion estimation unit 42 and motion compensation unit 44 may perform inter-predictive coding of a given received video block relative to one or more blocks in one or more reference frames to provide temporal compression. Intra-prediction module 46 may perform intra-predictive coding of a given received video block relative to one or more neighboring blocks in the same frame or slice as the block to be coded to provide spatial compression.

Mode select unit 40 may select one of the coding modes, e.g., one mode or multiple intra- or inter-coding modes, based on coding results (e.g., resulting coding rate and level of distortion), and based on a frame or slice type for the frame or slice including the given received block being coded, and provide the resulting intra- or inter-coded block to summer 50 to generate residual block data and to summer 62 to reconstruct the encoded block for use in a reference frame or reference slice. In general, intra-prediction involves predicting a current block relative to neighboring, previously coded blocks, while inter-prediction involves motion estimation and motion compensation to temporally predict the current block. In some embodiments, if the reconstructed pictures are reference pictures, they will be stored in a reference buffer (not shown) or memory 64 for future temporal prediction.

Motion estimation unit 42 and motion compensation unit 44 represent the inter-prediction elements of video encoder 20. Motion estimation unit 42 and motion compensation unit 44 may be highly integrated, but are illustrated separately for conceptual purposes. Motion estimation is the process of generating motion vectors, which estimate motion for video blocks. A motion vector, for example, may indicate the displacement of a predictive block within a predictive reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. A motion vector may also indicate displacement of a partition of a block. Motion compensation may involve fetching or generating the predictive block based on the motion vector determined by motion estimation. Again, motion estimation unit 42 and motion compensation unit 44 may be functionally integrated, in some examples.

Motion estimation unit 42 may calculate a motion vector for a video block of an inter-coded frame by comparing the video block to video blocks of a reference frame in memory 64. Motion compensation unit 44 may also interpolate sub-integer pixels of the reference frame, e.g., an I-frame, B-frame or a P-frame, for the purposes of this comparison.

Motion estimation unit 42 may compare blocks of one or more reference frames from memory 64 to a block to be encoded of a current frame, e.g., a P-frame or a B-frame. In some embodiments, P and B-frames may be consolidated into a general B picture that can be used as a reference picture or frame. When the reference frames in memory 64 include values for sub-integer pixels, a motion vector calculated by motion estimation unit 42 may refer to a sub-integer pixel location of a reference frame. Motion estimation unit 42 and/or motion compensation unit 44 may also be configured to calculate values for sub-integer pixel positions of reference frames stored in memory 64 if no values for sub-integer pixel positions are stored in memory 64. Motion estimation unit 42 may send the calculated motion vector to entropy encoding unit 56 and motion compensation unit 44. The reference frame block identified by a motion vector may be referred to as an inter-predictive block, or, more generally, a predictive block. Motion compensation unit 44 may calculate prediction data based on the predictive block.

Intra-prediction module 46 may intra-predict a current block, as an alternative to the inter-prediction performed by motion estimation unit 42 and motion compensation unit 44, as described above. In particular, intra-prediction module 46 may determine an intra-prediction mode to use to encode a current block. In some examples, intra-prediction module 46 may encode a current block using various intra-prediction modes, e.g., during separate encoding passes, and intra-prediction module 46 (or mode select unit 40, in some examples) may select an appropriate intra-prediction mode to use from the tested modes. For example, intra-prediction module 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction module 46 may calculate ratios from the distortions and rates for the various encoded blocks to determine which intra-prediction mode exhibits the best rate-distortion value for the block.

After predicting a current block, e.g., using intra-prediction or inter-prediction, video encoder 20 may form a residual video block by subtracting the prediction data calculated by motion compensation unit 44 or intra-prediction module 46 from the original video block being coded. Summer 50 represents the component or components that may perform this subtraction operation. Transform module 52 may apply a transform, such as a discrete cosine transform (DCT) or a conceptually similar transform, to the residual block, producing a video block comprising residual transform coefficient values. Transform module 52 may perform other transforms, such as those defined by the H.264 standard, which are conceptually similar to DCT. Wavelet transforms, integer transforms, sub-band transforms or other types of transforms could also be used. In any case, transform module 52 may apply the transform to the residual block, producing a block of residual transform coefficients. The transform may convert the residual information from a pixel domain to a transform domain, such as a frequency domain. Quantization unit 54 may quantize the residual transform coefficients to further reduce bit rate. The quantization process may reduce the bit depth associated with some or all of the coefficients. The degree of quantization may be modified by adjusting a quantization parameter.

Following quantization, entropy encoding unit 56 may entropy encode the quantized transform coefficients, which may include CAVLC, CABAC, PIPE, or another entropy coding technique. Following the entropy coding by entropy encoding unit 56, the encoded video may be transmitted to another device or archived for later transmission or retrieval.

In some cases, entropy encoding unit 56 or another unit of video encoder 20 may be configured to perform other coding functions, in addition to entropy coding quantized transform coefficients as described above. For example, entropy encoding unit 56 may construct header information for the block (e.g., macroblock, CU, or LCU), or video frame containing the block, with appropriate syntax elements for transmission in the encoded video bitstream. This disclosure describes techniques that may enable performing scanning of rectangular block information more efficiently than when using other methods.

For example, entropy encoding unit 56 of video encoder 20 may be configured to encode certain blocks of video data (e.g., one or more macroblocks, or TUs of a CU). In accordance with the techniques of this disclosure, as one example, entropy encoding unit 56 may be configured to encode a significance map for a current TU using a particular scan type and a particular context model selection scheme. Further detail on entropy encoding can be found in U.S. patent application Ser. No. 13/550,493, entitled “CONTEXT MODELING TECHNIQUES FOR TRANSFORM COEFFICIENT LEVEL CODING”, filed on Jul. 16, 2012, and incorporated herein by reference.

Inverse quantization unit 58 and inverse transform module 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in memory 64. The reconstructed video block may be used by motion estimation unit 42 and motion compensation unit 44 as a reference block to inter-code a block in a subsequent video frame.

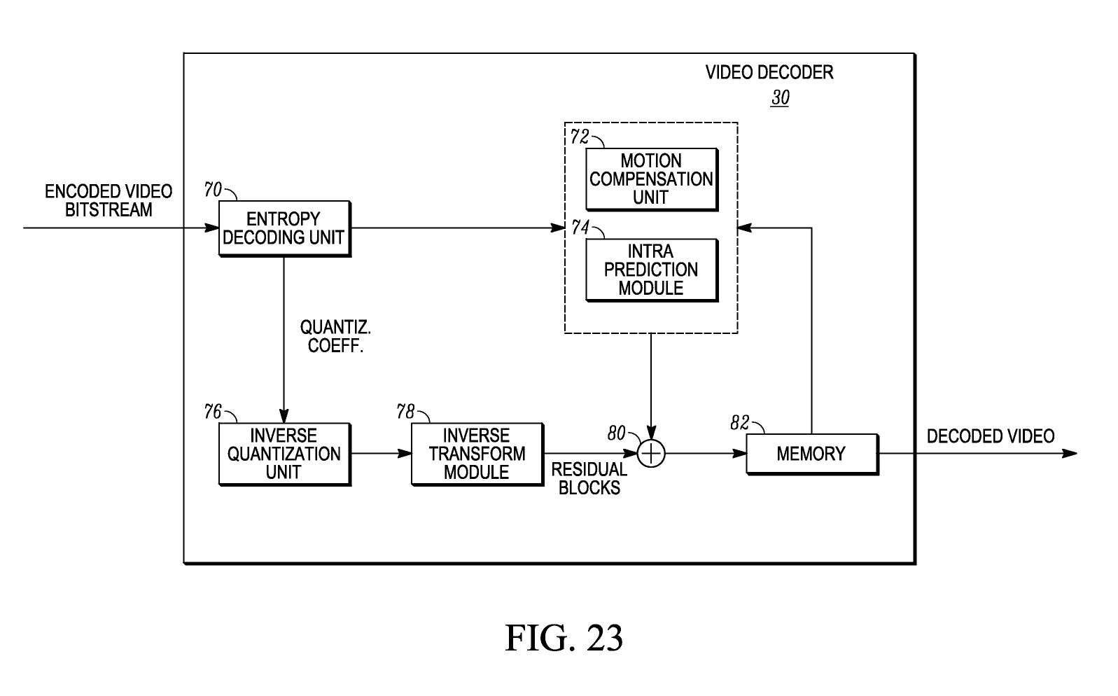

FIG. 23 is a block diagram that illustrates an example of a video decoder 30 that may implement techniques for efficiently decoding encoded scanning information for a rectangular block of video data, consistent with the techniques of this disclosure. In the example of FIG. 23, video decoder 30 includes an entropy decoding unit 70, motion compensation unit 72, intra-prediction module 74, inverse quantization unit 76, inverse transform module 78, memory 82 and summer 80. Video decoder 30 may, in some examples, perform a decoding pass generally reciprocal to the encoding pass described with respect to video encoder 20 (FIG. 22). Motion compensation unit 72 may generate prediction data based on motion vectors received from entropy decoding unit 70.

For example, video decoder 30 may be configured to receive encoded video data (e.g., one or more macroblocks, or TUs of a CU) from video encoder 20. Entropy decoding unit 70 may be configured to decode a significance map for a current TU using a particular scan type and a particular context model selection scheme. Further detail on entropy decoding can be found in U.S. patent application Ser. No. 13/550,493, entitled “CONTEXT MODELING TECHNIQUES FOR TRANSFORM COEFFICIENT LEVEL CODING”, filed on Jul. 16, 2012, and previously incorporated by reference.

As such, the techniques of this disclosure may enable entropy decoding unit 70 to decode the scanning information for a rectangular block more efficiently than when using other methods. In this manner, there may be a relative time savings corresponding to parallel processing when using the techniques of this disclosure.

Motion compensation unit 72 may use motion vectors received in the bitstream to identify a prediction block in reference frames in memory 82. Intra-prediction module 74 may use intra-prediction modes received in the bitstream to form a prediction block from spatially adjacent blocks.

Intra-prediction module 74 may use an indication of an intra-prediction mode for the encoded block to intra-predict the encoded block, e.g., using pixels of neighboring, previously decoded blocks. For examples in which the block is inter-prediction mode encoded, motion compensation unit 72 may receive information defining a motion vector, in order to retrieve motion compensated prediction data for the encoded block. In any case, motion compensation unit 72 or intra-prediction module 74 may provide information defining a prediction block to summer 80.

Inverse quantization unit 76 inverse quantizes, e.g., de-quantizes, the quantized block coefficients provided in the bitstream and decoded by entropy decoding unit 70. The inverse quantization process may include a conventional process, e.g., as defined by the H.264 decoding standard or as performed by the HEVC Test Model. The inverse quantization process may also include use of a quantization parameter QP_{Y} calculated by video encoder 20 for each block to determine a degree of quantization and, likewise, a degree of inverse quantization that may be applied.

Inverse transform module 78 applies an inverse transform, e.g., an inverse DCT, an inverse integer transform, or a conceptually similar inverse transform process, to the transform coefficients in order to produce residual blocks in the pixel domain. Motion compensation unit 72 produces motion compensated blocks, possibly performing interpolation based on interpolation filters. Identifiers for interpolation filters to be used for motion estimation with sub-pixel precision may be included in the syntax elements. Motion compensation unit 72 may use interpolation filters as used by video encoder 20 during encoding of the video block to calculate interpolated values for sub-integer pixels of a reference block. Motion compensation unit 72 may determine the interpolation filters used by video encoder 20 according to received syntax information and use the interpolation filters to produce predictive blocks.

Motion compensation unit 72 uses some of the syntax information for the encoded block to determine sizes of blocks used to encode frame(s) of the encoded video sequence, partition information that describes how each block of a frame or slice of the encoded video sequence is partitioned, modes indicating how each partition is encoded, one or more reference frames (and reference frame lists) for each inter-encoded block or partition, and other information to decode the encoded video sequence. Intra-prediction module 74 may also use the syntax information for the encoded block to intra-predict the encoded block, e.g., using pixels of neighboring, previously decoded blocks, as described above.

Summer 80 sums the residual blocks with the corresponding prediction blocks generated by motion compensation unit 72 or intra-prediction module 74 to form decoded blocks. If desired, a deblocking filter may also be applied to filter the decoded blocks in order to remove blockiness artifacts. The decoded video blocks are then stored in memory 82, which provides reference blocks for subsequent motion compensation and also produces decoded video for presentation on a display device (such as display device 32 of FIG. 22).

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments and that the scope of the present invention is accordingly limited by nothing other than the appended claims.

We claim:

1. A method for coding a digital video sequence having a plurality of pictures, the method comprising the steps of:
(a) dividing at least one of said plurality of pictures into blocks,
(b) performing a rectangular transform on at least one of said blocks to produce one or more transform coefficients,
(c) performing quantization on the one or more transform coefficients, and
(d) encoding the one or more transform coefficients, one at a time, along a coding scan order, to generate a compressed bitstream,
wherein the coding scan order comprises a forward wavefront scan order or a reverse wavefront scan order, and
wherein the quantization results in producing quantized transform coefficients.

2. The method of claim 1, further comprising:
dividing the blocks of step (a) into smaller sub-blocks.

3. The method of claim 1, wherein the forward wavefront scan order is configured to begin scanning at a first non-zero transform coefficient or a DC coefficient.

4. The method of claim 1, wherein the reverse wavefront scan order is configured to begin scanning at a last non-zero transform coefficient.

5. The method of claim 1, wherein the rectangular transform is applied on blocks smaller than 128×128 pixels.

6. The method of claim 1, wherein the one or more transform coefficients are presented in a transform block, such that there are multiple lines of transform coefficients, further comprising:
encoding at least two lines of transform coefficients in parallel.

7. The method of claim 6, wherein the encoding is performed in a single direction.

8. The method of claim 1, wherein the method is implemented on a computer having a processor and a memory coupled to said processor, wherein at least some of steps (a) through (d) are performed using said processor.

9. An apparatus for coding a digital video sequence having a plurality of pictures, the apparatus comprising a video coder configured to:
divide at least one of said plurality of pictures into blocks,
perform a rectangular transform on at least one of said blocks to produce one or more transform coefficients,
perform quantization on the one or more transform coefficients, and
encode the one or more transform coefficients, one at a time, along a coding scan order, to generate a compressed bitstream,
wherein the coding scan order comprises a forward wavefront scan order or a reverse wavefront scan order, and
wherein the quantization results in producing quantized transform coefficients.

10. The apparatus of claim 9, wherein the apparatus comprises at least one of:
an integrated circuit;
a microprocessor; and
a wireless communication device that includes the video coder.

11. The apparatus of claim 9, wherein the one or more transform coefficients are presented in a transform block, such that there are multiple lines of transform coefficients, further comprising two or more microprocessors configured to operate in parallel for encoding at least two lines of transform coefficients at the same time.

12. The apparatus of claim 9, wherein the forward wavefront scan order is configured to begin scanning at a first non-zero transform coefficient or a DC coefficient.

13. The apparatus of claim 9, wherein the reverse wavefront scan order is configured to begin scanning at a last non-zero transform coefficient.

14. A method for processing a compressed bitstream, the method comprising:
(a) receiving a compressed bitstream, and
(b) processing the compressed bitstream to generate one or more transform coefficients of a rectangular transform,
wherein the one or more transform coefficients are generated, one at a time, along a coding scan order of the rectangular transform, and
wherein the coding scan order comprises a forward wavefront scan order or a reverse wavefront scan order.

15. The method of claim 14, further comprising:
(c) performing dequantization on the one or more transform coefficients.

16. The method of claim 14, further comprising:
(d) performing an inverse rectangular transform on the one or more transform coefficients.

17. An apparatus for processing a compressed bitstream, the apparatus comprising a video decoder configured to:
receive a compressed bitstream, and
process the compressed bitstream to generate one or more transform coefficients of a rectangular transform,
wherein the one or more transform coefficients are generated, one at a time, along a coding scan order of the rectangular transform, and
wherein the coding scan order comprises a forward wavefront scan order or a reverse wavefront scan order.

18. The apparatus of claim 17, wherein the apparatus comprises at least one of:
an integrated circuit;
a microprocessor; and
a wireless communication device that includes the video decoder.

19. The apparatus of claim 17, wherein the forward wavefront scan order is configured to begin scanning at a first non-zero transform coefficient or a DC coefficient.

20. The apparatus of claim 17, wherein the reverse wavefront scan order is configured to begin scanning at a last non-zero transform coefficient.
